(19) United States
(12) Patent Application Publication
(10) Pub. No.: US 2026/0252512 A1
(43) Pub. Date: Aug. 27, 2026

(54) Collective Operation Resilience for Chiplet-Based UALink Networks

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/649,939

(22) Filed: Apr. 16, 2026

Related U.S. Application Data
(60) Provisional application No. 64/038,992, filed on Apr. 14, 2026.
(60) Provisional application No. 64/031,378, filed on Apr. 6, 2026.
(60) Provisional application No. 64/030,256, filed on Apr. 5, 2026.
(60) Provisional application No. 64/013,582, filed on Mar. 22, 2026.
(60) Provisional application No. 63/991,122, filed on Feb. 25, 2026.
(60) Provisional application No. 63/931,124, filed on Dec. 4, 2025.
(60) Provisional application No. 63/906,709, filed on Oct. 28, 2025.
(60) Provisional application No. 63/895,053, filed on Oct. 7, 2025.
(60) Provisional application No. 63/874,393, filed on Sep. 2, 2025.
(60) Provisional application No. 63/856,653, filed on Aug. 3, 2025.
(60) Provisional application No. 63/826,342, filed on Jun. 18, 2025.
(60) Provisional application No. 63/811,859, filed on May 25, 2025.

(51) Int. Cl. G06F 13/36

(52) U.S. Cl. CPC G06F 13/36; G06F 2213/40

(57) ABSTRACT

Implementations for collective operation resilience in a chiplet-based accelerator interconnect. In some implementations, a system for a UALink-based network comprises a chiplet die with stations coupled to an accelerator die via a die-to-die interface, switches with group tables identifying groups of accelerators for collective operations, and a centralized controller. Upon detection of a station fault on the chiplet die, the centralized controller identifies group table entries on the switches that reference accelerators coupled to the faulted station and updates the entries to exclude those accelerators, enabling collective operations to continue with reduced membership. In some implementations, an accelerator die coupled to chiplet dies redistributes transaction layer flits from a faulted chiplet die to operational chiplet dies, and the centralized controller updates forwarding entries on switches to reflect the changed connectivity.

### CROSS-REFERENCE TO RELATED APPLICATIONS

This Application claims priority to: U.S. Provisional Patent Application No. 64/038,992, filed Apr 14, 2026 that is herein incorporated by reference in its entirety; U.S. Provisional Patent Application No. 64/031,378, filed Apr 6, 2026; U.S. Provisional Patent Application No. 64/030,256, filed Apr 5, 2026; U.S. Provisional Patent Application No. 64/013,582, filed Mar 22, 2026; U.S. Provisional Patent Application No. 63/991,122, filed Feb 25, 2026; U.S. Provisional Patent Application No. 63/931,124, filed Dec 4, 2025; U.S. Provisional Patent Application No. 63/906,709, filed Oct 28, 2025; U.S. Provisional Patent Application No. 63/895,053, filed Oct 7, 2025; U.S. Provisional Patent Application No. 63/874,393, filed Sep 2, 2025; U.S. Provisional Patent Application No. 63/856,653, filed Aug 3, 2025; U.S. Provisional Patent Application No. 63/826,342, filed June 18, 2025; and U.S. Provisional Patent Application No. 63/811,859, filed May 25, 2025.

### BACKGROUND

Artificial intelligence (AI) training and inference workloads utilize large clusters of hardware accelerators coupled via high-bandwidth interconnect fabrics. Ultra Accelerator Link (UALink) is an industry-standard interconnect protocol designed to provide high-bandwidth, low-latency communication among accelerators. UALink-based networks may include accelerators coupled to one or more switches, where each switch routes requests and responses between accelerators via ports. Switches in a UALink-based network may maintain group tables that map group identifiers to sets of participating accelerators, enabling in-network collective operations such as all-reduce, broadcast, and reduce, where the switch replicates requests to group members and aggregates responses.

In some system architectures, an accelerator may be implemented as a multi-die system-in-package comprising an accelerator die and one or more chiplet dies. The accelerator die may contain the transaction layer and application logic, while each chiplet die may contain the data link layer, physical layer, and external link interfaces. The accelerator die and the chiplet dies may be coupled via die-to-die interfaces. Each chiplet die may include a plurality of independent stations, where each station provides connectivity to one or more external UALink ports. In such architectures, a fault on a specific station of a chiplet die may affect the connectivity to a subset of the accelerator's external ports, while other stations on the same chiplet die and stations on other chiplet dies may continue to operate.

### SUMMARY

In various implementations, a system for an Ultra Accelerator Link (UALink)-based network comprises a chiplet die with stations coupled to an accelerator die via a die-to-die interface, one or more switches with group tables, and a centralized controller. Upon detection of a fault on a station of the chiplet die, the centralized controller identifies group table entries on the switches that reference accelerators coupled to the faulted station and updates the identified entries to exclude those accelerators. The centralized controller may use a three-phase update protocol, clearing valid indicators, modifying bitmasks, verifying consistency, and reactivating. The chiplet die may transmit a fault notification through the die-to-die interface to a management agent on the accelerator die, which reports to the centralized controller.

In other implementations, a method for recovering from a chiplet station fault in an Ultra Accelerator Link (UALink)-based network comprises detecting a fault on a station, identifying group table entries on switches that reference accelerators coupled to the faulted station, updating the identified entries to exclude those accelerators, and redistributing transaction layer flits from the faulted station to operational stations on the chiplet die or on other chiplet dies coupled to the accelerator die. The centralized controller may pre-compute alternative group table entries for fast failover.

In yet other implementations, a system for an Ultra Accelerator Link (UALink)-based network comprises an accelerator die coupled to chiplet dies, each via a separate die-to-die interface, and a centralized controller. Upon a fault affecting a first chiplet die or a station on the first chiplet die, the accelerator die redistributes transaction layer flits from the affected stations to operational stations on other chiplet dies, and the centralized controller updates forwarding entries on switches to reflect the changed connectivity. The centralized controller may further update group table entries and rebalance traffic across remaining chiplet dies.

### BRIEF DESCRIPTION OF THE DRAWINGS

FIG. 1A illustrates a bypass mechanism where the encryption engine excludes a poisoned data beat from both encryption and authentication tag computation, sets the data beat to a predetermined value, and the transaction layer replaces the data beat with error indication messages;

FIG. 1B illustrates a method for propagating data errors through an encryption pipeline in a UALink-based network;

FIG. 2A illustrates a system comprising a transmitting device and a receiving device each independently exclude a poisoned data beat from their respective encryption and decryption operations;

FIG. 2B illustrates a method for propagating data errors through encryption at both the transmitting and receiving devices;

FIG. 3A illustrates accelerators communicating via transaction layer flits over UALink-based links;

FIG. 3B illustrates a method for encoding transactions in a UALink-based network;

FIG. 4A illustrates an accelerator comprising a circuit that processes incoming responses from transaction layer flits, while distinguishing between responses corresponding to collective operations and responses corresponding to unicast operations;

FIG. 4B illustrates a method for processing responses in a UALink-based network;

FIG. 5A illustrates a switch for a UALink-based network which may perform in-network collective operations;

FIG. 5B illustrates a method for performing a collective operation in a UALink-based network;

FIG. 6A illustrates a switch for a UALink-based network which may operate in two distinct modes depending on the type of request received;

FIG. 6B illustrates a method for processing requests at a switch in a UALink-based network;

FIG. 7A illustrates a switch for a UALink-based network, which may offload entire collective operations from accelerators;

FIG. 7B illustrates a method for offloading a collective operation to a switch in a UALink-based network;

FIG. 8A illustrates a switch for a UALink-based network which may manage queue resources for block collective operations through a lifecycle of allocation, invocation, and deallocation;

FIG. 8B illustrates a method for managing collective operation resources at a switch in a UALink-based network;

FIG. 9A illustrates a method for performing in-network data reduction in a UALink-based network;

FIG. 9B illustrates a method for performing data reduction with format conversion in a UALink-based network;

FIG. 10A illustrates a system for a UALink-based network that includes a centralized controller that integrates collective operation resource allocation into the virtual partition lifecycle;

FIG. 10B illustrates a method for creating a virtual partition with collective operation resources;

FIG. 10C illustrates a system for a UALink-based network that includes a centralized controller that maintains per-virtual-partition resource accounting for in-network collective operation resources and enforces per-virtual-partition quotas;

FIG. 11A illustrates a system for a UALink-based network comprising a centralized controller that programs group table entries across a plurality of switches;

FIG. 11B illustrates a method for programming consistent group table entries across switches in a UALink-based network;

FIG. 12A illustrates a system for a UALink-based network comprising a centralized controller that automatically maintains group table entries in response to topology changes in the network;

FIG. 12B illustrates a method for maintaining group table consistency in response to topology changes in a UALink-based network;

FIG. 13A illustrates a switch supporting both collective operations and unicast operations;

FIG. 13B illustrates a method for selectively processing encrypted transactions at a switch in an accelerator network;

FIG. 14A illustrates a system that may provide a mechanism for trusted software on a host processor to selectively elevate the switch into the trusted computing base for collective operations of a specific virtual partition;

FIG. 14B illustrates a method for selectively elevating a switch into a trusted computing base;

FIG. 15A illustrates an accelerator network architecture where accelerators are coupled to switches via encrypted links, and encryption keys may be derived from master keys using a key derivation function (KDF) that takes a context value as input;

FIG. 15B illustrates a method for deriving directionally unique encryption keys, which may construct separate context values for each direction of a link between an accelerator and a switch;

FIG. 16A illustrates a system wherein both accelerator-to-accelerator and accelerator-to-switch links are encrypted, and key management operations may need to target specific device types;

FIG. 16B illustrates a method for managing encryption keys in an accelerator network;

FIG. 17A illustrates a switch that participates in encrypted collective operations for multiple tenants;

FIG. 17B illustrates a method for managing encryption keys at a security manager of a switch;

FIG. 17C illustrates a method for attestation and configuration verification at a security manager of a switch;

FIG. 18A illustrates a system for a UALink-based network comprising chiplet-based accelerators performing in-network collective operations via switches with group tables;

FIG. 18B illustrates a method for recovering from a chiplet station fault;

FIG. 18C illustrates a system for a UALink-based network, comprising an accelerator die coupled to a plurality of chiplet dies, each providing connectivity to a subset of the UALink network;

FIG. 19A illustrates a system for a UALink-based network, comprising a chiplet die that detects faults and transmits fault notifications to an accelerator die via a die-to-die interface;

FIG. 19B illustrates a method for managing chiplet faults in a UALink-based network; and

FIG. 19C illustrates a system for a UALink-based network, comprising an accelerator die that is coupled to both a chiplet die (via a die-to-die interface) and a host processor (via CXL or PCIe).

### DETAILED DESCRIPTION

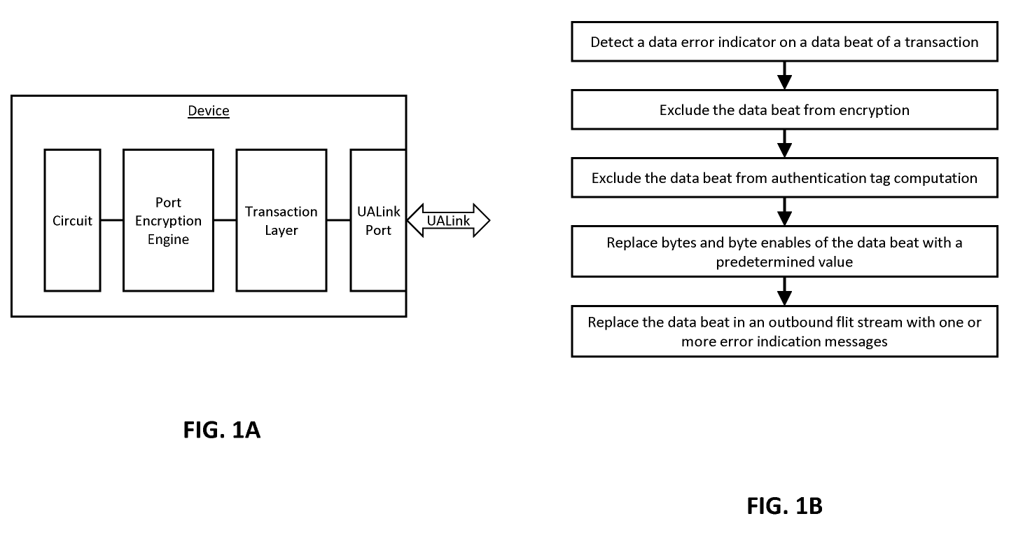

In encrypted interconnects, data errors may occur upstream of the encryption engine due to parity failures, memory errors, or other fault conditions. When a data beat carries an error indicator, the encryption engine faces a choice: encrypt the corrupted data normally and risk a false authentication tag failure at the receiver, or bypass the corrupted data entirely. FIG. 1A illustrates a bypass mechanism where the encryption engine excludes a poisoned data beat from both encryption and authentication tag computation, sets the data beat to a predetermined value, and the transaction layer replaces the data beat with error indication messages. This coordinated bypass may prevent data errors from being misinterpreted as security violations while preserving the authentication tag correctness for non-poisoned portions of the transaction.

In various implementations, a device for an Ultra Accelerator Link (UALink)-based network, the device comprising: a UALink-based port; a circuit coupled to the UALink-based port, the circuit configured to detect a data error indicator on a data beat of a transaction; a port encryption engine configured to, upon detection of the data error indicator: exclude the data beat from encryption, exclude the data beat from authentication tag computation, and set bytes and byte enables of the data beat to a predetermined value; and a transaction layer configured to replace the data beat with one or more error indication messages in an outbound flit stream on the UALink-based port. The device may include an accelerator or a switch in the UALink-based network. The circuit may detect the data error indicator on a per-beat basis, where each data beat may be 64 bytes. The port encryption engine may exclude the data beat by advancing past the data beat without consuming keystream bits for encryption and without including the data beat in the Galois field accumulation for authentication tag computation. Setting bytes and byte enables to a predetermined value may replace corrupted data with a known pattern before the data is handed to the transaction layer. The transaction layer may generate error indication messages that encode the data error condition in a format recognizable by a receiving transaction layer.

In some implementations of the device, the predetermined value for bytes and byte enables of the data beat is zero. Setting bytes and byte enables to zero may establish a known data pattern that the receiving device may expect when reconstructing the poisoned data beat on the UPLI interface.

In some implementations of the device, each error indication message comprises a 32-byte Poisoned Data TL Message Half-Flit, and each 64-byte data beat with the data error indicator is replaced with two of the Poisoned Data TL Message Half-Flits. Each 64-byte data beat may be replaced with two 32-byte Poisoned Data TL Message Half-Flits, maintaining the flit stream slot allocation while encoding the error condition. The Poisoned Data TL Message Half-Flit may include a message indicator bit and a message type field.

In some implementations of the device, the data error indicator is evaluated independently for each 64-byte data beat within a multi-beat transaction, wherein one data beat is excluded from encryption and authentication tag computation while other data beats in the same transaction are encrypted and authenticated. In a multi-beat transaction comprising up to four 64-byte data beats, each beat may independently carry or not carry a data error indicator. A transaction may contain a mixture of poisoned and non-poisoned beats, where the poisoned beats are excluded from encryption and authentication tag computation.

In some implementations of the device, the data error indicator comprises at least one of: an OrigDataError indicator on an originator data channel for write data, or a RdRspDataError indicator on a read response data channel for read response data. The OrigDataError indicator may be asserted by an originator when a parity error is detected on write data. The RdRspDataError indicator may be asserted by a completer when a parity error is detected on read response data. Both indicators may trigger the same bypass behavior in the port encryption engine.

In some implementations of the device, the excluding of the data beat from encryption and authentication tag computation prevents the data error from causing an authentication tag mismatch at a receiving device, thereby avoiding teardown of a security session between the device and the receiving device. Without the bypass, a data error would cause the authentication tags at the transmitting and receiving devices to diverge, because the transmitting device would include the poisoned data in the tag computation while the receiving device would compute the tag over different data. The tag mismatch may be indistinguishable from a security violation, potentially triggering session teardown and loss of connectivity between the devices.

In some implementations of the device, the port encryption engine advances at full throughput without stalling when the data beat with the data error indicator is encountered, maintaining line-rate processing for non-poisoned data beats. The bypass mechanism may enable the port encryption engine to advance its pipeline state past the poisoned data beat without waiting for error recovery or retransmission, such that non-poisoned data beats continue to be encrypted at line rate.

In some implementations of the device, when plaintext CRC protection is enabled, a CRC calculation over plaintext content also excludes the data beat with the data error indicator, maintaining consistency between the CRC exclusion and the encryption exclusion. When a CRC is computed over plaintext content for crypto engine fault detection, the CRC may also exclude poisoned data beats, such that both the CRC and the authentication tag reflect non-poisoned data beats. This consistency may prevent a situation where the CRC includes a poisoned beat but the authentication tag does not, or vice versa.

In some implementations of the device, the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and a switch port encryption engine excludes the data beat from re-encryption and re-authentication tag computation. During in-network data reduction, the switch may receive encrypted data from multiple accelerators, decrypt the data, perform a reduction operation, and re-encrypt the result. If any accelerator's contribution has a poisoned beat, the switch may exclude that beat from the reduction arithmetic and propagate the data error indicator into the corresponding beat of the reduced result. The switch port encryption engine may then exclude the poisoned beat from re-encryption and re-authentication tag computation, maintaining the bypass coordination through the full switch pipeline.

In some implementations of the device, the device comprises a switch in the UALink-based network, and when the switch replicates a collective write operation to a plurality of destination accelerators and the data beat has the data error indicator, the switch propagates the data error indicator for the data beat in all replicated requests to the plurality of destination accelerators. During a multicast write operation, the switch may replicate the request and data to each destination accelerator. Propagating the data error indicator in all replicated requests may maintain consistency across the collective, such that all destination accelerators observe the same data error condition for the same data beat.

In some implementations of the device, the port encryption engine implements authenticated encryption using AES-GCM with 256-bit keys. AES-GCM with 256-bit keys may provide authenticated encryption where the keystream is generated from sequential counter blocks encrypted with the key. The bypass mechanism may be compatible with the Galois field accumulation used for authentication tag computation in AES-GCM.

FIG. 1B illustrates a method for propagating data errors through an encryption pipeline in a UALink-based network without causing false authentication failures, by excluding the poisoned data beat from encryption and authentication tag computation.

In various implementations, a method for propagating data errors in an Ultra Accelerator Link (UALink)-based network, comprising: detecting, at a device comprising a port encryption engine coupled to a UALink-based port, a data error indicator on a data beat of a transaction; excluding, by the port encryption engine, the data beat from encryption; excluding, by the port encryption engine, the data beat from authentication tag computation; replacing bytes and byte enables of the data beat with a predetermined value; and replacing the data beat in an outbound flit stream with one or more error indication messages. The method may be performed by an accelerator, a switch, or other entity in the UALink-based network. Detecting the data error indicator may include monitoring a per-beat error signal on a UPLI interface. Excluding the data beat from encryption may include advancing the encryption pipeline past the data beat without consuming keystream bits. Excluding the data beat from authentication tag computation may include omitting the data beat from the Galois field accumulation. Replacing bytes and byte enables with the predetermined value may establish a known pattern for the receiving device. Replacing the data beat with error indication messages may encode the data error condition in the outbound flit stream.

In some implementations of the method, the predetermined value is zero, and each error indication message comprises a 32-byte Poisoned Data TL Message Half-Flit, and each 64-byte data beat with the data error indicator is replaced with two of the Poisoned Data TL Message Half-Flits. Replacing each 64-byte data beat with two 32-byte Poisoned Data TL Message Half-Flits may maintain the flit stream timing while encoding the error condition in a recognizable message format.

In some implementations of the method, the data error indicator is evaluated independently for each 64-byte data beat within a multi-beat transaction, wherein one data beat is excluded from encryption and authentication tag computation while other data beats in the same transaction are encrypted and authenticated. Per-beat evaluation may enable surgical handling where the affected data beat is excluded from encryption, and remaining data beats in the same transaction proceed through the encryption pipeline normally.

In some implementations of the method, the excluding of the data beat from encryption and authentication tag computation prevents the data error from causing an authentication tag mismatch at a receiving device, thereby avoiding teardown of a security session between the device and the receiving device. Without the excluding, a data error may cause the transmitting and receiving devices to compute different authentication tags, which may be indistinguishable from a security violation and may trigger session teardown.

In some implementations of the method, when plaintext CRC protection is enabled, a CRC calculation over plaintext content also excludes the data beat with the data error indicator. Excluding the data beat from the CRC calculation may maintain consistency with the encryption exclusion, such that both the CRC and the authentication tag reflect non-poisoned data beats.

In some implementations of the method, the device comprises a switch in the UALink-based network, and when the switch performs in-network data reduction on decrypted collective data and the data beat has the data error indicator, the switch excludes the data beat from a reduction operation, marks a corresponding beat in a reduced result with a data error indicator, and excludes the data beat from re-encryption and re-authentication tag computation. The switch may coordinate the bypass across decryption, reduction, and re-encryption, such that the poisoned beat is excluded from the entire switch pipeline and propagated as a data error in the reduced result.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

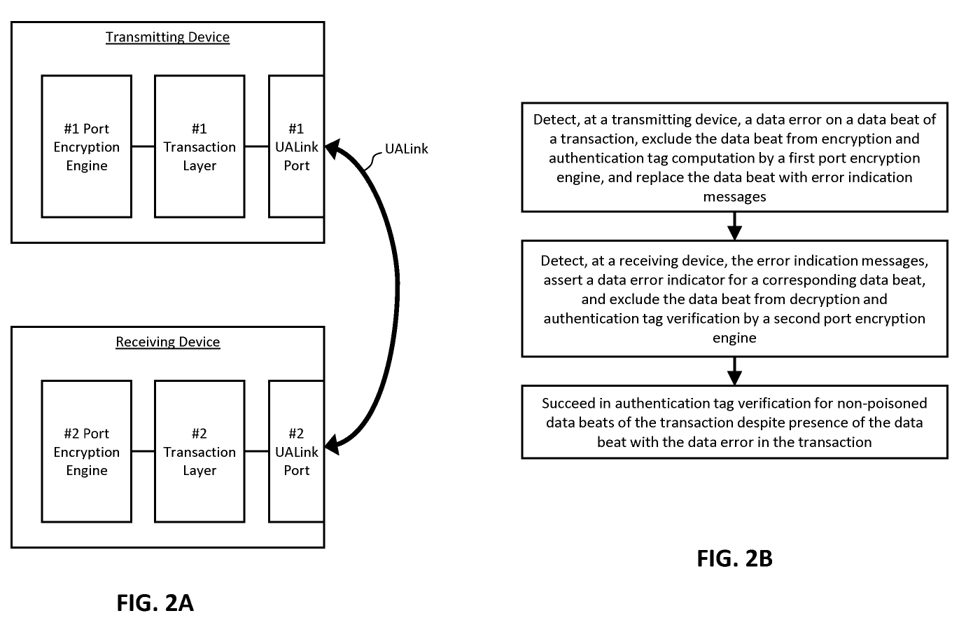

FIG. 2A illustrates a system comprising a transmitting device and a receiving device each independently exclude a poisoned data beat from their respective encryption and decryption operations, including authentication tag computation and verification. Because both devices exclude the same data beat, the authentication tag computed at the transmitting device and the authentication tag verified at the receiving device may agree for the non-poisoned portions of the transaction, despite the presence of the poisoned data beat. The coordination may be achieved through error indication messages that are inserted by the transmitting transaction layer and detected by the receiving transaction layer, signaling which data beats are poisoned.

In various implementations, an interconnect system for an Ultra Accelerator Link (UALink)-based network, comprising: a transmitting device comprising a first port encryption engine, a first transaction layer, and a first UALink-based port; a receiving device comprising a second port encryption engine, a second transaction layer, and a second UALink-based port; the transmitting device coupled to the receiving device via a UALink-based link; wherein at the transmitting device, when a data error is detected on a data beat of a transaction, the first port encryption engine excludes the data beat from encryption and authentication tag computation, and the first transaction layer replaces the data beat with error indication messages; and at the receiving device, the second transaction layer detects the error indication messages, asserts a data error indicator for a corresponding data beat, and the second port encryption engine excludes the data beat from decryption and authentication tag verification; wherein the authentication tag verification succeeds for non-poisoned data beats of the transaction despite the presence of the data beat with the data error in the transaction. The transmitting device and the receiving device may each comprise an accelerator or a switch in the UALink-based network. At the transmitting device, the first port encryption engine may exclude the data beat by skipping the encryption keystream consumption and the Galois field accumulation for that beat. The first transaction layer may replace the data beat with error indication messages in the outbound flit stream. At the receiving device, the second transaction layer may detect the error indication messages and assert a data error indicator on the UPLI interface for the corresponding data beat. The second port encryption engine may then exclude that data beat from decryption and from the Galois field accumulation for authentication tag verification. Because both the first and second port encryption engines exclude the same data beat, the authentication tags may be computed over the same subset of non-poisoned data beats, and the authentication tag verification may succeed for the non-poisoned portions.

In some implementations of the system, at the receiving device, the second transaction layer decodes the error indication messages and sets bytes of a reconstructed 64-byte data beat to zero and byte enables to zero on a UPLI interface. The receiving transaction layer may reconstruct the poisoned data beat by setting bytes and byte enables to zero, establishing a known data pattern on the UPLI interface. The data error indicator asserted alongside the reconstructed beat may signal to the receiving device that the data is corrupted.

In some implementations of the system, the transmitting device or the receiving device logs each data error event, recording at least one of: a transaction tag, source and destination accelerator identifiers, or a beat offset, enabling post-mortem analysis of data error patterns. Logging data error events with transaction-level and beat-level detail may enable identification of recurring error sources, such as a faulty memory bank or a degrading interconnect, through post-mortem pattern analysis.

In some implementations of the system, the error indication messages at the transmitting device and the data error indicator at the receiving device propagate data error semantics analogous to Peripheral Component Interconnect Express (PCIe) and Compute Express Link (CXL) poisoned transaction layer packet handling, enabling consistent error semantics across a system where accelerators connect to hosts via CXL and to peers via the UALink-based network. PCIe and CXL may define a Poison field in transaction layer packets to propagate data errors without triggering protocol-level error recovery. The bypass mechanism in the UALink-based network may provide analogous data error propagation semantics, such that a system comprising both CXL host links and UALink peer links may handle data errors consistently across protocol boundaries.

FIG. 2B illustrates a method for propagating data errors through encryption at both the transmitting and receiving devices, such that the authentication tag verification succeeds for non-poisoned data beats despite the presence of poisoned beats.

In various implementations, a method for coordinating data error propagation through encryption in an Ultra Accelerator Link (UALink)-based network, comprising: at a transmitting device comprising a first port encryption engine, a first transaction layer, and a first UALink-based port, detecting a data error on a data beat of a transaction, excluding the data beat from encryption and authentication tag computation by the first port encryption engine, and replacing the data beat with error indication messages by the first transaction layer; at a receiving device comprising a second port encryption engine, a second transaction layer, and a second UALink-based port, the receiving device coupled to the transmitting device via a UALink-based link, detecting the error indication messages by the second transaction layer, asserting a data error indicator for a corresponding data beat, and excluding the data beat from decryption and authentication tag verification by the second port encryption engine; wherein the authentication tag verification succeeds for non-poisoned data beats of the transaction despite the presence of the data beat with the data error in the transaction. The method may be performed by accelerators, switches, or other entities coupled via the UALink-based link. At the transmitting device, detecting the data error may include monitoring a per-beat error indicator on a UPLI interface. At the receiving device, detecting the error indication messages may include recognizing a message type associated with poisoned data in the inbound flit stream. The coordinated exclusion at both devices may result in authentication tags that are computed over the same subset of non-poisoned data beats, enabling the authentication tag verification to succeed despite the presence of one or more poisoned data beats.

In some implementations of the method, at the receiving device, the second transaction layer decodes the error indication messages and sets bytes of a reconstructed 64-byte data beat to zero and byte enables to zero on a UPLI interface. Setting bytes and byte enables to zero may reconstruct the poisoned data beat with a known value on the UPLI interface, accompanied by the data error indicator.

In some implementations of the method, the data error is detected on a per-beat basis, and data beats without the data error are encrypted, decrypted, and included in authentication tag computation and verification independently of the data beat with the data error. Per-beat independence may enable the encryption and decryption pipelines to process non-poisoned data beats at full throughput without waiting for error resolution on the poisoned data beat.

In some implementations of the method, a non-transitory computer-readable medium comprising instructions which, when executed by a processor, cause the processor to perform the method. In some implementations of the method, an apparatus configured to operate as a switch, wherein the apparatus comprises switching circuitry and is configured to perform the method.

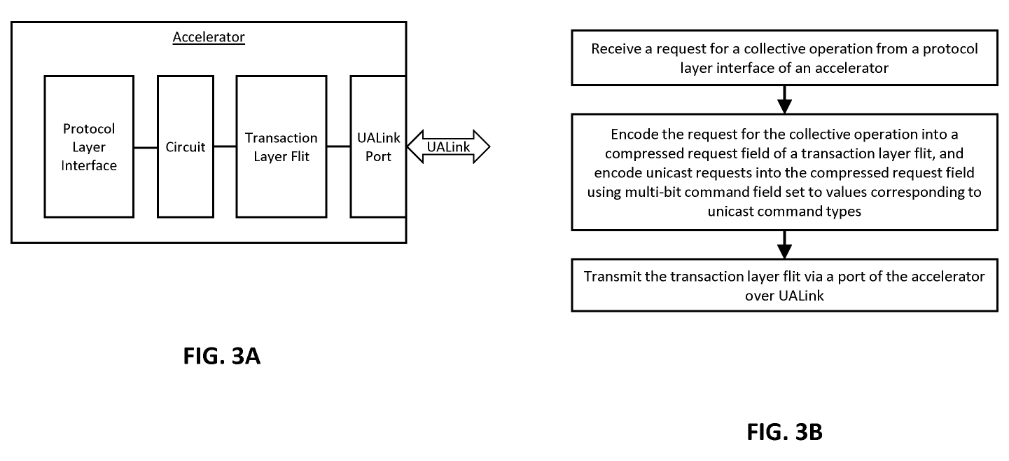

FIG. 3A illustrates accelerators communicating via transaction layer flits over UALink-based links. The transaction layer may encode requests in compressed and uncompressed field formats. A compressed request field may occupy fewer sectors than an uncompressed request field, enabling higher bandwidth utilization within the transaction layer flit. In some implementations, the compressed request field may include a multi-bit command field that encodes both collective operation command types, such as commands targeting a group of accelerators for reduction, multicast, or block collective operations, and unicast command types, such as commands targeting a single destination accelerator for read, write, or atomic operations. By sharing the same compressed field format for both collective and unicast commands, the transaction layer may avoid the bandwidth penalty of requiring collective operations to use the larger uncompressed request format. The accelerator may communicate via a port over a UALink-based link, and a circuit coupled to the port may perform the encoding and decoding of transaction layer flit fields. The collective operation may target a group of accelerators identified by a group identifier carried in a destination identifier field of the compressed request field.

In various implementations, an accelerator for an Ultra Accelerator Link (UALink)-based network, comprising: a port configured to communicate via a UALink-based link; and a circuit coupled to the port, the circuit configured to: receive, from a protocol layer interface of the accelerator, a request for a collective operation targeting a group of accelerators in the UALink-based network; and encode the request for the collective operation into a compressed request field of a transaction layer flit, the compressed request field comprising a multi-bit command field set to a value corresponding to a collective operation command type; wherein the circuit is further configured to encode unicast requests into the compressed request field using the multi-bit command field set to values corresponding to unicast command types. The circuit may receive requests from the protocol layer interface and encode them into fields of the transaction layer flit for transmission over the UALink-based link. The compressed request field may occupy two sectors of a control half-flit within the transaction layer flit, whereas an uncompressed request field may occupy four sectors, enabling the compressed format to carry more requests per flit. The multi-bit command field may encode values for collective operations including reduction, multicast, and block collective operations, in addition to unicast operations including read, write, and full-write operations. The circuit may determine whether a request received from the protocol layer interface is a collective operation or a unicast operation based on the command information provided by the protocol layer interface, and may set the command field value accordingly.

In some implementations of the accelerator, the multi-bit command field comprises 3 bits encoding a plurality of command types comprising: a read command, a read-reduce command, a block-read command, a write-multicast command, a write command, a write-full-multicast command, a write-full command, and a block-write-full command. The 3-bit command field may encode eight command types, utilizing all available encoding positions. The read, write, and write-full commands may correspond to unicast operations directed to a single destination accelerator. The read-reduce, block-read, write-multicast, write-full-multicast, and block-write-full commands may correspond to collective operations directed to a group of accelerators.

In some implementations of the accelerator, a destination identifier field of the compressed request field carries a physical accelerator identifier when the request is a unicast request, and carries a group identifier identifying the group of accelerators when the request is the collective operation request. The destination identifier field may include 10 bits and may serve a dual purpose depending on the command type. For unicast requests, the field may carry a physical accelerator identifier that identifies a single destination accelerator for point-to-point routing. For collective operation requests, the field may carry a group identifier that identifies a set of accelerators participating in the collective operation, enabling a switch to route the request to all members of the group.

In some implementations of the accelerator, the compressed request field for the collective operation request occupies the same number of sectors in a control half-flit of the transaction layer flit as the compressed request field for a unicast request. Both collective and unicast compressed request fields may occupy two sectors of a control half-flit, enabling collective operations to be encoded without additional bandwidth overhead compared to unicast operations.

In some implementations of the accelerator, the circuit comprises an address cache, the address cache indexed by the group identifier for the collective operation request and indexed by the physical accelerator identifier for a unicast request. The address cache may store address region information enabling the circuit to compress the address field in the compressed request field. For collective operations, the address cache may maintain entries indexed by the group identifier, enabling address compression for collective traffic targeting groups of accelerators. For unicast operations, the address cache may be indexed by the physical accelerator identifier of the destination.

In some implementations of the accelerator, a source identifier field of the compressed request field carries a reduction operation type and a data type when the collective operation command type corresponds to a read-reduce command issued from the accelerator to a switch of the UALink-based network, and carries a physical accelerator identifier for other command types. The source identifier field may include 10 bits and may be overloaded for read-reduce commands to carry information specifying the arithmetic or logical operation to be performed and the data type of the operands, enabling the switch to perform the reduction operation without additional signaling. For other command types, the field may carry the physical accelerator identifier of the originating accelerator.

In some implementations of the accelerator, the circuit is further configured to encode, within a single control half-flit of the transaction layer flit, at least one compressed request field for the collective operation and at least one compressed request field for a unicast request. The control half-flit may accommodate multiple compressed request fields subject to sector alignment constraints. By packing both collective and unicast compressed request fields into the same control half-flit, the circuit may optimize bandwidth utilization when both traffic types are pending for transmission.

In some implementations of the accelerator, the accelerator is coupled to a host via a Compute Express Link (CXL) interface, and wherein the circuit is further configured to: receive a CXL.io memory request from the host, and translate the CXL.io memory request into the request for the collective operation encoded in the compressed request field, wherein the CXL.io memory request comprises at least one of a CXL.io Memory Read (MRd) request or a CXL.io Unordered Input/Output Memory Read (UIOMRd) request, and wherein a completion returned to the host comprises a CXL DevLoad (CDL) field. The CXL.io memory request from the host may be translated into a collective operation when the request targets a memory region associated with a collective operation, such as a reduction buffer or a multicast destination range. The CDL field in the completion returned to the host may carry load indication information reflecting the accelerator's or the UALink-based network's current utilization level.

In some implementations of the accelerator, the accelerator is coupled to a host via a Compute Express Link (CXL) interface, and wherein the circuit is further configured to: receive a CXL.mem master-to-subordinate (M2S) request from the host targeting memory associated with the accelerator, and translate the CXL.mem M2S request into the request for the collective operation encoded in the compressed request field, wherein the CXL.mem M2S request comprises at least one of a MemRd opcode or a MemWr opcode, and wherein a subordinate-to-master (S2M) response returned to the host comprises a MetaField and a MetaValue. The CXL.mem M2S request may target memory that is shared among a group of accelerators and may trigger a collective operation to synchronize or aggregate data across the group. The MetaField and MetaValue in the S2M response may convey coherency state information about the data returned to the host.

In some implementations of the accelerator, the accelerator is coupled to a host via a Compute Express Link (CXL) interface, and wherein the circuit is further configured to coordinate a CXL.cache coherency operation with the collective operation, the CXL.cache coherency operation comprising at least one of: obtaining data from the host via a CXL.cache device-to-host (D2H) request comprising at least one of a RdShared opcode, a RdOwn opcode, or a RdCurr opcode, or evicting data to the host via a CXL.cache D2H data message comprising at least one of a DirtyEvict opcode or a CleanEvict opcode. The accelerator may coordinate CXL.cache coherency operations with UALink collective operations to maintain data consistency between the host's cache hierarchy and the data being operated on by the group of accelerators. For example, the accelerator may obtain data from the host cache via a RdShared or RdOwn request before initiating a collective reduction, or may evict modified data back to the host via a DirtyEvict after completing a collective operation.

In some implementations of the accelerator, the accelerator is coupled to a host via a Peripheral Component Interconnect Express (PCIe) interface, and wherein the circuit is further configured to: receive a PCIe Transaction Layer Packet (TLP) from the host comprising a PCIe memory request, and translate the PCIe memory request into the request for the collective operation encoded in the compressed request field, wherein the circuit maps between a Tag field of the PCIe TLP and a tag field of the compressed request field. The PCIe TLP Tag field may have a different width and encoding than the tag field of the compressed request field, and the circuit may maintain a mapping between the two Tag spaces to correlate responses with their originating PCIe requests. The PCIe memory request may be a Memory Read (MRd) or Memory Write (MWr) TLP directed to a memory region associated with a collective operation.

FIG. 3B illustrates a method for encoding transactions in a UALink-based network comprising receiving requests for collective operations from a protocol layer interface and encoding them into compressed request fields of transaction layer flits for transmission over a UALink-based link. The method may identify collective operations using a group identifier carried in the request, and may set a multi-bit command field in the compressed request field to a value corresponding to the specific collective operation command type. The method may further encode unicast requests into the same compressed request field format using unicast command type values, enabling both collective and unicast traffic to share the same bandwidth-efficient compressed encoding.

In various implementations, a method for encoding transactions in an Ultra Accelerator Link (UALink)-based network, comprising: receiving, at a circuit of an accelerator, a request for a collective operation from a protocol layer interface of the accelerator, the request targeting a group of accelerators in the UALink-based network via a group identifier; encoding, by the circuit, the request for the collective operation into a compressed request field of a transaction layer flit, the compressed request field comprising a multi-bit command field set to a value corresponding to a collective operation command type; transmitting the transaction layer flit via a port of the accelerator over a UALink-based link; and wherein the encoding further comprises encoding unicast requests into the compressed request field using the multi-bit command field set to values corresponding to unicast command types. The method may be implemented in hardware, firmware, software, or combinations thereof, and may be performed by various types of devices including an accelerator, a switch, a processor, or a semiconductor device. The group identifier may identify a set of accelerators participating in the collective operation and may be carried in a destination identifier field of the compressed request field. The multi-bit command field may distinguish among multiple types of collective operations, such as reduction, multicast, and block collective operations, as well as multiple types of unicast operations.

In some implementations, the method further comprises managing flow control credits for collective operation requests separately from flow control credits for unicast requests, wherein the circuit allocates dedicated credit resources for the collective operation requests to prevent blocking between collective operation traffic and unicast traffic. The dedicated credit resources may include separate pool credit allocations or separate virtual channel credit reservations for collective and unicast traffic. By preventing one traffic type from consuming all available credits, the method may reduce interference between collective and unicast traffic at the transaction layer.

In some implementations, the method further comprises limiting, by the circuit, a proportion of compressed request fields within a single control half-flit of the transaction layer flit that are encoded with collective operation command types, to allocate bandwidth in the transaction layer flit between collective operation requests and unicast requests. The proportion may be controlled by a policy that reserves a minimum number of sector positions in the control half-flit for unicast requests when both collective and unicast requests are pending, preventing collective traffic from monopolizing the available bandwidth.

In some implementations of the method, the encoding of the collective operation request into the compressed request field is subject to: a transfer size that is a multiple of 64 bytes, a 64-byte-aligned address, and the address hitting in a transaction layer address cache. The compression restrictions may apply equally to collective and unicast compressed requests and may be enforced by the circuit before encoding a request into the compressed format. Requests that do not meet the compression restrictions may be encoded in an uncompressed request field format occupying more sectors in the control half-flit.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

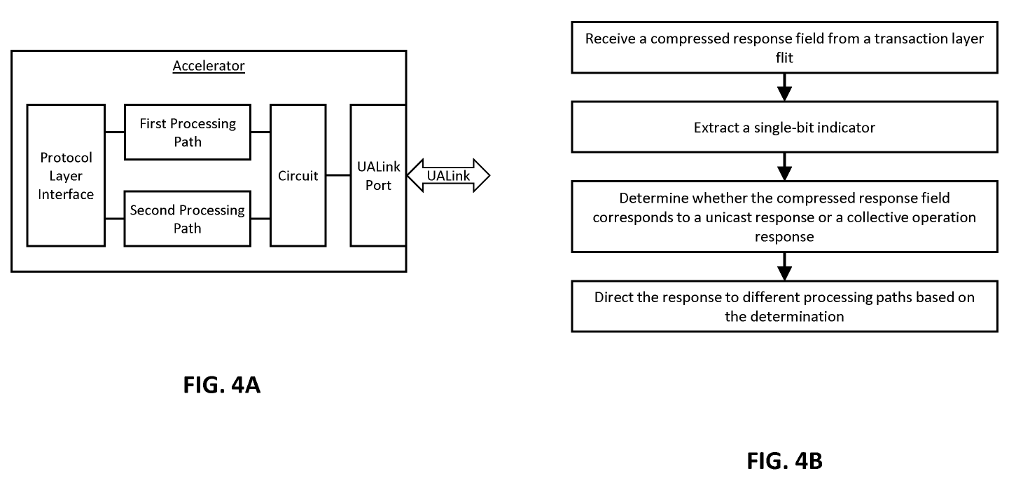

FIG. 4A illustrates an accelerator comprising a circuit that processes incoming responses from transaction layer flits, while distinguishing between responses corresponding to collective operations and responses corresponding to unicast operations. In some implementations, the circuit may extract a single-bit indicator from a compressed response field to determine whether the response corresponds to a collective operation or a unicast operation, without maintaining state information about the original request that generated the response. This stateless approach may be beneficial in switch implementations where maintaining per-transaction state for all in-flight requests across all ports may be prohibitively expensive. By embedding the response type in the response itself, the circuit may route collective and unicast responses to different processing paths, such as different decryption paths, different flow control credit return paths, or different forwarding paths. The compressed response field may occupy a single sector of a control half-flit, and the single-bit indicator may occupy a bit position that was previously unassigned in earlier versions of the compressed response format.

In various implementations, an accelerator for an Ultra Accelerator Link (UALink)-based network, comprising: a port configured to receive transaction layer flits via a UALink-based link; and a circuit coupled to the port, the circuit configured to: receive a compressed response field from a transaction layer flit; extract a single-bit indicator from the compressed response field, the single-bit indicator indicating whether the compressed response field corresponds to a unicast response or a collective operation response; and direct the response to a first processing path when the single-bit indicator indicates a collective operation response, and to a second processing path when the single-bit indicator indicates a unicast response; wherein the directing is based on the single-bit indicator without reference to an original request that generated the response. The circuit may receive compressed response fields from transaction layer flits arriving via the UALink-based link and may inspect the single-bit indicator in each compressed response field to determine the response type. The first processing path for collective operation responses may include operations such as reduction result aggregation, multicast acknowledgment tracking, or collective completion signaling to the protocol layer interface. The second processing path for unicast responses may include standard response delivery to the protocol layer interface. The stateless differentiation may eliminate the need for the circuit to maintain a lookup table or tracker entries mapping outstanding request TAGs to their request types.

In some implementations of the accelerator, the single-bit indicator occupies a bit position that was an unassigned spare bit in a prior version of the compressed response field. The bit position may have been reserved or unassigned in earlier versions of the compressed response format, and may be repurposed to carry the collective/unicast indication without altering the overall size of the compressed response field.

In some implementations of the accelerator, the circuit is further configured to identify block collective responses using dedicated compressed response field types that are distinct from compressed response field types used for unicast responses and non-block collective responses. The dedicated compressed response field types may enable the circuit to identify block collective responses based on the field type value alone, without inspecting the single-bit indicator. Block collective responses may include responses for block-read and block-write-full operations.

In some implementations of the accelerator, the circuit is further configured to: receive an uncompressed response field from the transaction layer flit, the uncompressed response field comprising a multi-bit response type field indicating whether the response corresponds to a unicast request, a collective primitive request, or a block collective request; and map the multi-bit response type field to protocol layer interface signals comprising a read response type information signal and a write response type information signal. The multi-bit response type field may include 2 bits and may be located in bit positions that were previously unassigned in the uncompressed response format. The read response type information signal and the write response type information signal may each comprise 2 bits and may be provided on the protocol layer interface to enable higher-layer logic to identify the response type.

In some implementations of the accelerator, the accelerator, when acting as a completer for a received request, is configured to retain the type of the received request and set the read response type information signal or the write response type information signal in a corresponding response based on the retained type. The accelerator may maintain the type of each received request, such as whether it was a unicast, collective primitive, or block collective request, and may embed the corresponding type information in the response generated for that request. This enables the originating accelerator or an intermediary switch to determine the response type without maintaining its own request-tracking state.

In some implementations of the accelerator, a switch of the UALink-based network is configured to: receive the transaction layer flit on an ingress port of the switch, determine, based on the single-bit indicator, whether to decrypt the response at the ingress port or to bypass decryption, wherein collective operation responses are directed to decryption and unicast responses bypass decryption. The switch may use the single-bit indicator to differentiate between collective operation responses that require authentication and decryption at the ingress port and unicast responses that may bypass decryption. This stateless determination may enable the switch to make per-response security decisions without maintaining per-transaction state.

In some implementations of the accelerator, responses with a successful completion status use the compressed response field, and wherein error responses use an uncompressed response field comprising a multi-bit status field. The multi-bit status field in the uncompressed response field may include 4 bits and may carry detailed error information. Restricting the compressed response format to successful completions may enable the compressed format to omit the status field and use the saved bits for other purposes, such as the single-bit indicator.

In some implementations of the accelerator, the circuit selects between the compressed response field and an uncompressed response field for a collective operation response based on whether the collective operation response meets compression restrictions, the compression restrictions comprising a successful completion status. The circuit may evaluate each outgoing collective operation response against the compression restrictions and may select the compressed response field format when the restrictions are met, or the uncompressed response field format when the restrictions are not met, such as when the response carries an error status.

FIG. 4B illustrates a method for processing responses in a UALink-based network comprising extracting a single-bit indicator from compressed response fields received via a UALink-based link, and directing responses to different processing paths based on the indicator value. The method may enable stateless response differentiation without maintaining tracking state for outstanding requests.

In various implementations, a method for processing responses in an Ultra Accelerator Link (UALink)-based network, comprising: receiving, at a circuit of an accelerator, a compressed response field from a transaction layer flit received via a port of the accelerator over a UALink-based link; extracting, by the circuit, a single-bit indicator from the compressed response field; determining, based on the single-bit indicator, whether the compressed response field corresponds to a unicast response or a collective operation response; and directing the response to different processing paths based on the determining; wherein the determining is performed without reference to an original request that generated the response. The method may be implemented in hardware, firmware, software, or combinations thereof, and may be performed by various types of devices including an accelerator, a switch, a processor, or a semiconductor device. The different processing paths may include separate credit return paths, separate buffering paths, or separate forwarding paths for collective and unicast responses. The stateless determination may enable the method to process responses at line rate without the latency overhead of a state table lookup.

In some implementations, the method further comprises processing, within a single control half-flit of the transaction layer flit, at least one compressed response field corresponding to a collective operation response and at least one compressed response field corresponding to a unicast response, wherein the extracting and the determining are performed independently for each compressed response field in the control half-flit. The control half-flit may contain multiple compressed response fields, each occupying a single sector, and the circuit may process each compressed response field independently by extracting the single-bit indicator from each and directing each response to the appropriate processing path.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

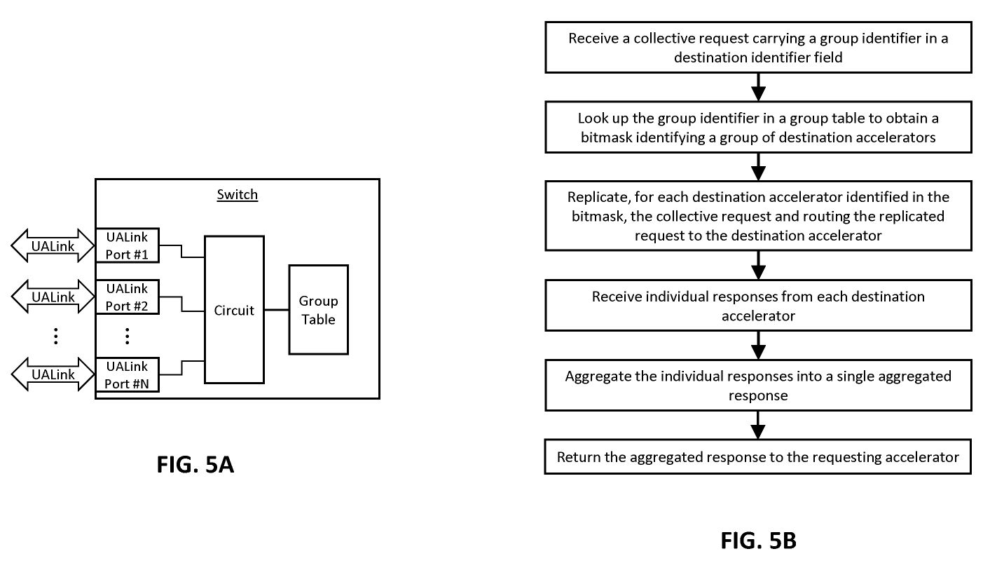

FIG. 5A illustrates a switch for a UALink-based network which may perform in-network collective operations by replicating a single collective request from a requesting accelerator to a group of destination accelerators, and aggregating the individual responses from the group into a single response returned to the requesting accelerator. The switch may maintain a group table with entries that map group identifiers to bitmasks identifying which accelerators belong to each collective group. When a collective request arrives at the switch, the switch may look up the group identifier carried in the request to determine the membership of the target group, replicate the request to each member, and track individual responses until all have been received. The switch may then produce a single aggregated response, including data reduction for read-type collective requests and status reduction for all collective request types. This approach may offload collective coordination from the accelerators to the switch, reducing the number of messages traversing the interconnect and lowering latency for collective operations such as gradient all-reduce during AI training. The circuit performing these operations may be implemented as combinational logic, a state machine, a microcontroller, or a combination thereof.

In various implementations, a switch for an Ultra Accelerator Link (UALink)-based network, comprising: a plurality of UALink-based ports; a group table comprising a plurality of entries, each entry associated with a group identifier and comprising a valid indicator and a bitmask identifying a group of accelerators; and a circuit configured to: receive a collective request from a requesting accelerator on an ingress port of the plurality of UALink-based ports, the collective request carrying the group identifier in a destination identifier field of the collective request; look up the group identifier in the group table to obtain the bitmask; replicate the collective request to each accelerator identified in the bitmask; track responses from each accelerator identified in the bitmask; and return a single aggregated response to the requesting accelerator when all individual responses have been received. The switch may route requests and responses among accelerators in a UALink-based network comprising up to 1024 accelerators. Each UALink-based port may correspond to a UALink link coupling the switch to an accelerator, and each link may include one or more lanes. The group table may be stored in on-chip memory within the switch, such as SRAM or register files, and may be indexed by the group identifier carried in the destination identifier field of the incoming collective request. The bitmask may have a width equal to the radix of the switch, with each bit position corresponding to a physical accelerator identifier. The circuit may replicate the collective request by issuing a separate request to a route table for each physical accelerator identifier whose corresponding bit is set in the bitmask. The route table may map the physical accelerator identifier to an egress port on the switch. The circuit may maintain tracking state for each outstanding replicated request, such as a counter or bitmask of pending responses, and may produce the aggregated response after all individual responses have been received and processed. For read-type collective requests, the aggregation may include data reduction. For write-type and atomic-type collective requests, the aggregation may include status reduction. The circuit may be implemented in hardware, firmware, software, or combinations thereof.

In some implementations of the switch, the destination identifier field carries a physical accelerator identifier for non-collective requests and the group identifier for collective requests, the group identifier indexing the group table to identify the group of accelerators. The destination identifier field may include a 10-bit field carried on the request channel. For non-collective requests, each bit pattern may correspond to a unique physical accelerator in the network. For collective requests, the same bit pattern may serve as an index into the group table, enabling the switch to determine the set of destination accelerators from the bitmask entry rather than from the field value itself.

In some implementations of the switch, the circuit is further configured to: verify that the valid indicator of the looked-up entry is set and that a bit corresponding to the requesting accelerator is set in the bitmask; and when the valid indicator is not set or the bit corresponding to the requesting accelerator is not set, drop the collective request and return a target abort response to the requesting accelerator. The valid indicator check may prevent the switch from processing collective requests that reference uninitialized or deallocated group table entries. The membership check may prevent an accelerator that is not a member of the collective group from issuing requests to that group, providing an access control mechanism at the switch level.

In some implementations of the switch, for each replicated request, the circuit passes an address space identifier, a transaction tag, a number of beats, an address, a command, a length, metadata, and a virtual channel of the collective request unchanged from the collective request to the replicated request, and routes the replicated request to the accelerator via a route table indexed by a physical accelerator identifier corresponding to the accelerator. Passing signals unchanged from the initial collective request to each replicated request may allow the destination accelerators to process the replicated requests identically, as each replicated request may appear to the destination as if it originated directly from the requesting accelerator. The route table may be the same route table used for non-collective unicast requests, indexed by the physical accelerator identifier corresponding to each bit set in the bitmask.

In some implementations of the switch, the circuit is further configured to reduce individual response statuses from the group of accelerators into a single aggregated status, the reduction comprising: returning an okay status when all individual statuses are okay, returning a non-okay status when all non-okay statuses are of a same type, and returning a mixed-response error status when individual non-okay statuses are of different types. The status reduction may allow the requesting accelerator to receive a single status representing the collective outcome of all individual responses. The mixed-response error status may indicate that different destination accelerators returned different types of non-okay responses, which may require software-level error handling to determine the appropriate recovery action.

In some implementations of the switch, when a data error indicator is asserted on a beat of data accompanying the collective request, the circuit marks the beat with the data error indicator in all replicated requests. Propagating the data error indicator to all replicated requests may allow each destination accelerator to independently detect and handle the corrupted beat, rather than silently consuming corrupted data.

In some implementations of the switch, the group table is programmed by a centralized controller via an out-of-band management interface, and the centralized controller dynamically updates group table entries when accelerators are added to or removed from the group of accelerators. The centralized controller may program the group table via a management protocol such as gNMI or Redfish, separate from the data-plane links carrying accelerator traffic. Dynamic updates may enable the centralized controller to reconfigure collective groups at runtime without interrupting collective operations on other groups.

In some implementations of the switch, the group table entries are partitioned by virtual partition, wherein a group identifier used by a first virtual partition references accelerators allocated to the first virtual partition, preventing a collective request from the first virtual partition from accessing accelerators in a second virtual partition. Partitioning the group table by virtual partition may enable multi-tenant deployments where different tenants share the same physical switch without risk of cross-tenant collective operations accessing another tenant's accelerators. In some examples, a virtual partition refers to a virtual pod.

In some implementations of the switch, each entry of the group table corresponds to a group of accelerators hosting a subset of experts in a Mixture-of-Experts AI model, enabling expert-parallel collective communication wherein each expert group has a dedicated group identifier. In a Mixture-of-Experts AI model, different subsets of experts may be distributed across different accelerators. Each expert group may have a dedicated group identifier in the group table, allowing the switch to replicate expert-parallel collective operations to those accelerators hosting the relevant experts, reducing unnecessary traffic to non-participating accelerators.

In some implementations of the switch, for a read-reduce collective request, the circuit sets a source accelerator identifier field on each replicated request to a physical accelerator identifier of the requesting accelerator, obtained from a per-port register programmed by a centralized controller. For read-reduce collective requests, the source identifier field on the replicated requests may identify the requesting accelerator rather than the switch, allowing destination accelerators to use the source identifier for memory protection checks or address translation. The per-port register may be programmed by the centralized controller during group table configuration.

In some implementations of the switch, the group table further comprises hot-standby entries pre-provisioned by the centralized controller, each hot-standby entry comprising a bitmask with a replacement accelerator substituted for a failed accelerator, enabling the circuit to switch from a current group table entry to a hot-standby entry upon detection of an accelerator failure without re-programming the group table. Pre-provisioning hot-standby entries may enable the switch to continue collective operations with minimal disruption when an accelerator fails. The centralized controller may create hot-standby entries that mirror the current group membership but with a replacement accelerator substituted for each accelerator that may fail, and the switch may activate a hot-standby entry upon receiving a failure indication from the centralized controller or from a timeout event.

FIG. 5B illustrates a method for performing a collective operation in a UALink-based network comprising receiving a collective request at a switch, looking up a group identifier in a group table to determine the set of destination accelerators, replicating the collective request to each destination accelerator, receiving and aggregating individual responses, and returning a single aggregated response to the requesting accelerator. The method may be applicable to various types of collective operations, including read-reduce operations where data payloads from destination accelerators are arithmetically combined, multicast write operations where data is distributed to all group members, and multicast atomic operations. The method may be performed by hardware circuitry within the switch, by firmware executing on a processor within the switch, or by a combination thereof.

In various implementations, a method for performing a collective operation in an Ultra Accelerator Link (UALink)-based network, comprising: receiving, at a switch via a UALink-based port, a collective request from a requesting accelerator, the collective request carrying a group identifier in a destination identifier field; looking up the group identifier in a group table at the switch to obtain a bitmask identifying a group of destination accelerators; for each destination accelerator identified in the bitmask, replicating the collective request and routing the replicated request to the destination accelerator; receiving individual responses from each destination accelerator; aggregating the individual responses into a single aggregated response; and returning the aggregated response to the requesting accelerator. The method may be performed by the switch each time a collective request arrives on an ingress port. The group table lookup may be performed in a single clock cycle or across multiple clock cycles depending on the group table implementation. The replication may occur sequentially or in parallel depending on the switch architecture. The aggregation may include both data aggregation (for read-type collectives where response data payloads are combined) and status aggregation (for all collective types where individual response statuses are reduced to a single status). The method may support groups ranging from two accelerators to the full radix of the switch.

In some implementations of the method, the collective request comprises a read-reduce request, and aggregating the individual responses comprises performing a data reduction operation on data payloads received from the destination accelerators and returning a single reduced data payload to the requesting accelerator. The data reduction operation may include an arithmetic or logical operation applied element-wise across the data payloads from all destination accelerators. The switch may accumulate partial results as each response arrives, or may buffer all responses and perform the reduction after all have been received.

In some implementations of the method, the collective request comprises a multicast write request, and replicating comprises sending copies of write data accompanying the collective request to each destination accelerator identified in the bitmask. The multicast write request may carry data on an originator data channel, and the switch may replicate both the request and the accompanying data to each destination accelerator identified in the bitmask.

In some implementations of the method, the read-reduce request is issued by an accelerator executing a data-parallel training workload of an AI model, and the data reduction operation comprises addition of gradient values from the group of destination accelerators. During data-parallel training, each accelerator may compute gradients for its local data partition. The read-reduce collective operation may aggregate these gradients across all participating accelerators using addition, producing a sum or average of gradients that may then be applied to update model parameters.

In some implementations of the method, the switch is a first switch of a plurality of switches in the UALink-based network, and a centralized controller programs consistent group table entries across the plurality of switches to enable multi-switch collective coordination. In a network with multiple switches, a collective group may span accelerators coupled to different switches. The centralized controller may program matching group table entries on each switch such that the same group identifier maps to the correct subset of accelerators reachable from that switch, enabling coordinated multi-switch collective operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

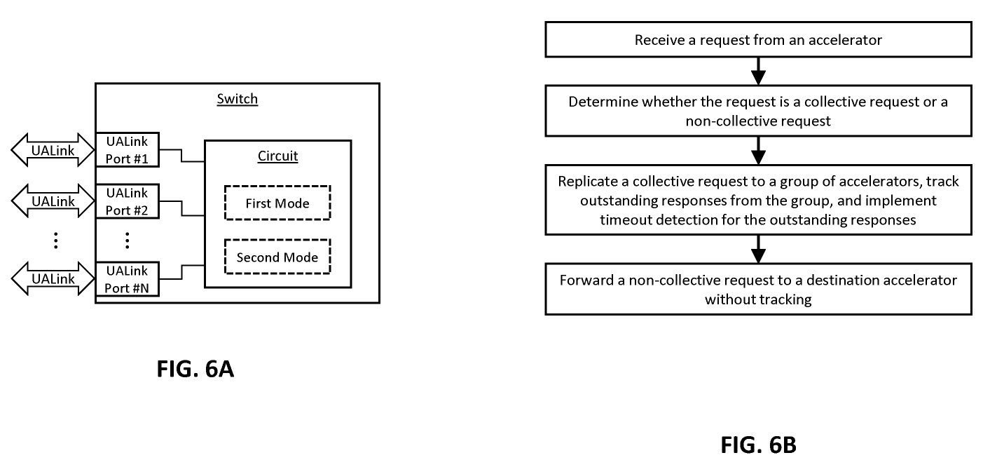

FIG. 6A illustrates a switch for a UALink-based network which may operate in two distinct modes depending on the type of request received. For collective requests that involve multiple destination accelerators, the switch may operate in a stateful mode where it tracks outstanding replicated requests, maintains response state, and implements timeout detection to handle unresponsive accelerators. For non-collective unicast requests that target a single destination accelerator, the switch may operate in a stateless mode where it forwards requests without tracking, consistent with the traditional switch behavior. The switch may determine which mode to use based on the command type field of each incoming request, enabling the same switch to simultaneously serve both collective and unicast traffic with the appropriate level of state management for each. This dual-mode architecture may enable the switch to provide the reliability and coordination needed for collective operations while maintaining the low-overhead forwarding efficiency for unicast traffic.

In various implementations, a switch for an Ultra Accelerator Link (UALink)-based network, comprising: a plurality of UALink-based ports; and a circuit configured to operate in a first mode for collective requests and a second mode for non-collective requests; wherein in the first mode, the circuit is configured to track outstanding replicated requests issued to a group of accelerators and implement timeout detection for the outstanding replicated requests; and wherein in the second mode, the circuit is configured to forward requests without tracking; and wherein the circuit determines the first mode or the second mode based on a command type field of a received request. The circuit may inspect the command type field of each incoming request to determine whether the request corresponds to a collective operation or a unicast operation. Collective operations may include read-reduce, multicast write, multicast full-beat write, and multicast atomic operations. The tracking in the first mode may include maintaining a count or bitmask of pending responses for each outstanding collective request, and the timeout detection may include per-port timers that expire if any replicated request does not receive a response within a configurable time period. In the second mode, the circuit may forward requests based on the destination identifier field and the route table without allocating any tracking resources or starting any timers. The dual-mode behavior may be implemented using shared hardware that is dynamically allocated to either mode based on the incoming request type, or using dedicated hardware paths for each mode.

In some implementations of the switch, in the first mode, the circuit is further configured to: reduce individual response statuses from the group of accelerators into a single aggregated status, comprising returning a mixed-response error status when individual non-okay statuses are of different types; and for a read-reduce collective request, perform a data reduction operation on data payloads received from the group of accelerators. The mixed-response error status may indicate to the requesting accelerator that the destination accelerators returned inconsistent error conditions, which may require software-level diagnosis. The data reduction operation for read-reduce requests may be performed incrementally as each response arrives, accumulating partial results in a buffer within the switch.

In some implementations of the switch, the timeout detection comprises a per-port watch dog timer for each outstanding collective request, and upon timer expiration, the switch enters an isolation mode on the affected port. The isolation mode may cause the switch to stop issuing new requests on the affected port and provide completion timeout responses for all outstanding requests on that port. The per-port isolation may prevent a timeout on one port from affecting collective operations on other ports, containing the failure to the affected accelerator.

In some implementations of the switch, the watch dog timer values for collective requests in the first mode are configured independently of timeout values for non-collective requests, with longer timeouts for collective operations involving larger groups of accelerators. Collective operations involving larger groups may require longer completion times because the switch waits for responses from all group members. Configuring collective timeouts independently from unicast timeouts may allow the switch to use longer timeouts for collectives without delaying failure detection for unicast traffic.

In some implementations of the switch, the circuit is further configured to, in the first mode, process collective requests from a plurality of different groups concurrently, interleaving replicated requests from different groups according to a scheduling policy. The scheduling policy may include round-robin, priority-based, or weighted fair scheduling among concurrent groups. The circuit may maintain separate tracking state for each active group to enable concurrent processing without interference between groups.

In some implementations of the switch, the circuit is further configured to, in the first mode, allocate bandwidth to collective requests from different groups based on a quality-of-service policy, the quality-of-service policy configurable per group or per virtual partition. The quality-of-service policy may allocate a guaranteed minimum bandwidth to each group or virtual partition, with remaining bandwidth distributed proportionally or based on priority levels. The policy may be programmed by the centralized controller as part of the group table configuration.

FIG. 6B illustrates a method for processing requests at a switch in a UALink-based network comprising determining, for each incoming request, whether the request is a collective request or a non-collective request, and processing the request differently based on the determination. For collective requests, the switch may replicate the request, track outstanding responses, and implement timeout detection. For non-collective requests, the switch may forward the request without tracking. This dual-mode processing approach may enable the switch to provide stateful coordination for collective operations while maintaining efficient stateless forwarding for unicast traffic.

In various implementations, a method for processing requests at a switch in an Ultra Accelerator Link (UALink)-based network, comprising: receiving, at the switch via a UALink-based port, a request from an accelerator; determining, based on a command type field of the request, whether the request is a collective request or a non-collective request; when the request is a collective request: replicating the request to a group of accelerators, tracking outstanding responses from the group, and implementing timeout detection for the outstanding responses; and when the request is a non-collective request: forwarding the request to a destination accelerator without tracking. The method may be performed continuously as requests arrive at the switch. The determination may be based on matching the command type field against a set of collective command type encodings. The tracking may include allocating a tracking entry for the collective request, recording the number of expected responses, and updating the tracking entry as responses arrive. The timeout detection may include starting a timer when the collective request is replicated and stopping the timer when all responses have been received. The forwarding for non-collective requests may include looking up the destination identifier in a route table to determine the egress port.

In some implementations of the method, the collective request comprises at least one of: a ReadReduce command, a WriteMulticast command, a WriteFullMulticast command, or an AtomicNRMulticast command. The ReadReduce command may instruct the switch to replicate a read request to all group members and perform data reduction on the returned payloads. The WriteMulticast and WriteFullMulticast commands may instruct the switch to replicate write data to all group members. The AtomicNRMulticast command may instruct the switch to replicate a non-returning atomic operation to all group members.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

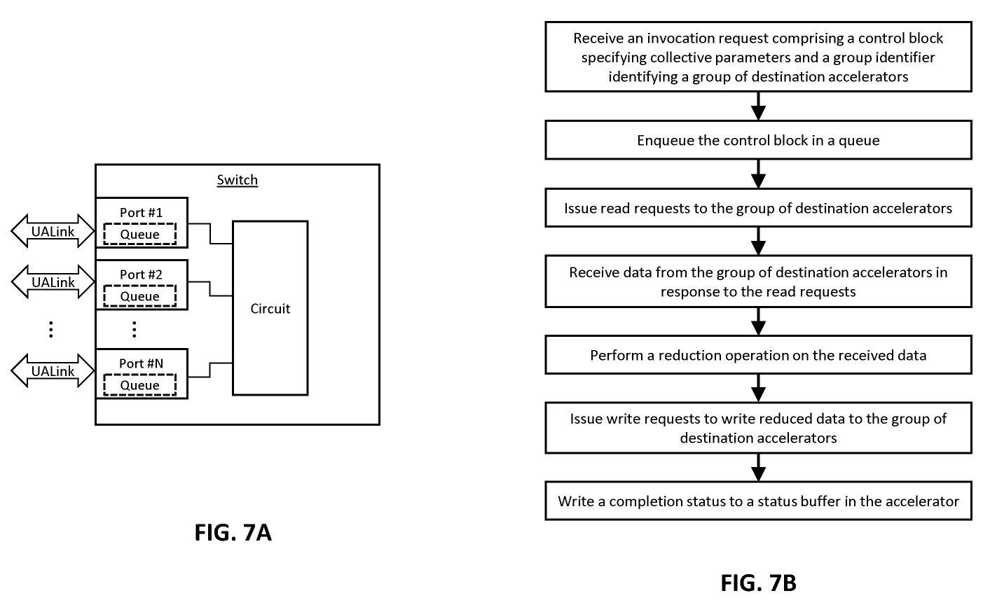

FIG. 7A illustrates a switch for a UALink-based network, which may offload entire collective operations from accelerators by receiving a single invocation request carrying a control block that specifies all parameters for the collective, and then generating the memory access requests needed to complete the operation. The switch may read data from input buffers at a group of destination accelerators, perform a reduction operation on the read data, write the reduced results to output buffers at the destination accelerators, and write a completion status to a status buffer in the requesting accelerator's memory. This autonomous operation may transform the switch from a passive packet relay into an active computation engine capable of processing collective operations such as all-reduce, broadcast, and reduce with a single invocation from the accelerator. The queue at each port may store control blocks for multiple pending collective operations, enabling pipelining where the accelerator submits multiple collective invocations without waiting for prior invocations to complete. The circuit performing these operations may be implemented as a state machine, a microcontroller, dedicated hardware logic, or a combination thereof.

In various implementations, a switch for an Ultra Accelerator Link (UALink)-based network, comprising: a plurality of UALink-based ports, each port comprising a queue for storing collective operation parameters; and a circuit configured to: receive an invocation request from an accelerator via one of the plurality of UALink-based ports, the invocation request carrying a control block specifying collective parameters and a group identifier identifying a group of destination accelerators; enqueue the control block in the queue; issue read requests to the group of destination accelerators; perform a reduction operation on data received in response to the read requests; issue write requests to write reduced data to the group of destination accelerators; and write a completion status to a status buffer in the accelerator. The switch may receive the invocation request on an ingress port and extract the control block from an originator data channel accompanying the request. The group identifier may index a group table at the switch to determine the set of destination accelerators. The circuit may autonomously generate read requests to input buffer locations at each destination accelerator, collect the response data, perform the specified reduction operation across the collected data, and generate write requests to output buffer locations at the destination accelerators. The read and write requests generated by the circuit may be routed through the switch's route table in the same manner as requests originating from accelerators. The completion status may be written to a pre-designated status buffer location in the requesting accelerator's memory via a write request generated by the switch. The entire autonomous sequence, from the initial read requests through the reduction to the final write requests and status notification, may complete without any further involvement from the requesting accelerator after the initial invocation. The queue may store multiple pending control blocks, enabling the circuit to process collective operations in sequence or, in some implementations, with interleaved memory access requests.

In some implementations of the switch, the control block specifies a collective type, a reduction operation, an input buffer offset, an output buffer offset, and a status buffer offset; and the circuit computes buffer addresses by adding the offsets to a base address carried in the invocation request, the base address being aligned to a 4K boundary. The base address may be carried in the address field of the invocation request, with low-order bits zeroed to achieve alignment. The offsets may be concatenated with zero bits to achieve 256-byte alignment for the buffer addresses. The collective type may specify the communication pattern, such as broadcast, reduce, or all-reduce. The reduction operation may specify the arithmetic or logical operation to perform on the collected data.

In some implementations of the switch, upon receiving the invocation request, the switch returns an acknowledgment response to the accelerator without waiting for the collective operation to complete. The immediate acknowledgment may enable the accelerator to issue subsequent invocation requests without waiting for prior operations to complete, allowing pipelining of multiple collective operations at the switch.

In some implementations of the switch, the collective parameters specify a collective type comprising at least one of: broadcast, reduce, or all-reduce, each available in strided and non-strided variants. In a broadcast collective, the circuit may read data from an input buffer at a single source accelerator and write copies to output buffers at all destination accelerators. In a reduce collective, the circuit may read data from input buffers at all destination accelerators, perform a reduction operation, and write the result to an output buffer at a single destination. In an all-reduce collective, the circuit may read, reduce, and write the result back to all destination accelerators. Strided variants may access non-contiguous memory regions.

In some implementations of the switch, when a read request or a write request issued by the circuit receives a non-okay response, the circuit ceases issuing new requests for the collective operation, waits for outstanding requests to complete, and writes the completion status to the status buffer indicating the failure. The error containment may prevent the switch from issuing additional requests to accelerators that may be in a degraded state. The circuit may wait for all previously issued requests to receive responses before writing the status buffer, so that the status buffer reflects the complete error state of the collective operation.

In some implementations of the switch, tags for the read requests and the write requests issued by the circuit are independent of tags used for unicast requests and collective primitive requests. The independent tag space may allow the switch to generate tags for its autonomous memory access requests without coordinating with the tag spaces used by accelerators for their own requests. The tag values for switch-generated requests and accelerator-generated requests may overlap without conflict.

In some implementations of the switch, the status buffer comprises valid indicators, an invocation status, a read/write error indicator, an error response status, a failing accelerator identifier, and a failing address; and the circuit writes the status buffer to the accelerator via a write request. The valid indicators may include two separate valid bits, a first indicating the invocation status is valid and a second indicating the error detail fields are valid. The invocation status may indicate success, invalid invocation, insufficient resources, or termination. The failing accelerator identifier and failing address may enable the requesting accelerator's software to diagnose which accelerator and which memory address caused the failure.

In some implementations of the switch, the collective parameters further comprise strided memory access parameters specifying a number of contiguous blocks per row, a number of rows, and a skip size between rows, and the circuit generates addresses for the read requests and the write requests according to the strided pattern. The strided memory access pattern may enable the circuit to read and write non-contiguous memory regions that correspond to multi-dimensional data structures in accelerator memory. The circuit may generate addresses by iterating over rows, where each row comprises a contiguous sequence of memory blocks followed by a skip to the start of the next row.

In some implementations of the switch, the number of contiguous blocks per row corresponds to a first dimension of a multi-dimensional tensor stored in accelerator memory, the number of rows corresponds to a second dimension, and the skip size corresponds to a stride between non-contiguous elements of the second dimension. The strided parameters may map directly to the memory layout of multi-dimensional tensors used in AI training, such as weight matrices, activation tensors, or gradient buffers, enabling the switch to process tensor-shaped data without requiring the accelerator to rearrange the data into a contiguous buffer before the collective operation.

In some implementations, the switch further comprises a register configured to constrain addresses of the read requests and the write requests generated by the circuit to a bounded memory region, preventing the circuit from issuing memory access requests to addresses outside the bounded memory region. The register may include bits corresponding to high-order address bits, loaded with a contiguous set of active values starting at the highest-order bit. The effect may be that all addresses generated by the circuit are masked to fall within a bounded region defined by the register contents, providing hardware-enforced memory protection against out-of-bounds memory access by the switch.

In some implementations of the switch, the register is programmed by a centralized controller based on a virtual partition allocated to the accelerator, constraining the collective operation to memory regions allocated to the virtual partition. In a multi-tenant deployment, different virtual partitions may be allocated different memory regions. The centralized controller may program the register to match the memory region of the virtual partition to which the requesting accelerator belongs, preventing the switch from generating memory access requests that cross virtual partition boundaries. In some examples, a virtual partition refers to a virtual pod.

In some implementations of the switch, the collective parameters specify a broadcast collective type, and the circuit distributes model parameters from a source accelerator to the group of destination accelerators for an AI model checkpointing operation. During AI model checkpointing, a primary accelerator may hold the authoritative copy of model parameters. The broadcast block collective may distribute these parameters to backup accelerators, with the strided access pattern matching the tensor layout of the model's weight matrices.

In some implementations of the switch, the collective parameters specify a vendor-defined collective type, and the circuit processes the vendor-defined collective type according to vendor-specific logic. The vendor-defined collective type may enable switch vendors to implement proprietary collective communication patterns beyond the standard broadcast, reduce, and all-reduce types. The vendor-specific logic may be implemented in firmware, hardware, or a combination thereof.

FIG. 7B illustrates a method for offloading a collective operation to a switch in a UALink-based network, comprising receiving a single invocation request from an accelerator, enqueuing the associated control block, and executing the entire collective operation at the switch without further accelerator involvement. The switch may issue read requests to collect data from destination accelerators, perform a reduction operation on the collected data, issue write requests to distribute results, and write a completion status to the accelerator's memory. This method may reduce the number of requests the accelerator manages individually, consolidating what would otherwise require many separate accelerator-initiated read and write transactions into a single invocation.

In various implementations, a method for offloading a collective operation to a switch in an Ultra Accelerator Link (UALink)-based network, comprising: receiving, at the switch via a UALink-based port, an invocation request from an accelerator, the invocation request comprising a control block specifying collective parameters and a group identifier identifying a group of destination accelerators; enqueuing the control block in a queue at the switch; issuing, by the switch, read requests to the group of destination accelerators; receiving data from the group of destination accelerators in response to the read requests; performing a reduction operation on the received data; issuing, by the switch, write requests to write reduced data to the group of destination accelerators; and writing a completion status to a status buffer in the accelerator. The method may be initiated by a single invocation request from the accelerator and may complete without any further involvement from the accelerator. The switch may generate read requests sequentially or in parallel across the group of destination accelerators. The reduction operation may be performed incrementally as responses arrive or after all responses have been collected. The write requests may distribute the reduced data to output buffer locations at each destination accelerator. The completion status may inform the accelerator whether the collective operation completed successfully or encountered an error. The method may be applicable to gradient synchronization during AI training, model parameter broadcast, and other collective communication patterns.

In some implementations of the method, for reduction operations that are not associative, the switch performs the reduction operation in an order that remains the same for every collective instance with the same group of destination accelerators. The deterministic ordering may be based solely on the set of participating accelerators, such as by processing responses in ascending order of physical accelerator identifier. This may enable reproducible results across repeated executions of the same collective operation with the same data.

In some implementations of the method, software on the accelerator clears valid indicators in the status buffer before issuing the invocation request and polls the valid indicators to detect completion of the collective operation. The polling-based completion notification may avoid the overhead of interrupt generation and handling, enabling lower-latency detection of completion for workloads that actively wait for collective results. The valid indicators may include separate bits for invocation status validity and error detail validity.

In some implementations of the method, the completion status comprises a first valid indicator indicating the invocation status is valid, a second valid indicator indicating error detail fields are valid, the invocation status, a read/write error indicator, an error response status, a failing accelerator identifier, and a failing address. The two-stage valid indicator mechanism may allow the switch to write the invocation status first and the error details subsequently, enabling the accelerator to quickly determine whether the operation succeeded before examining detailed error information.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

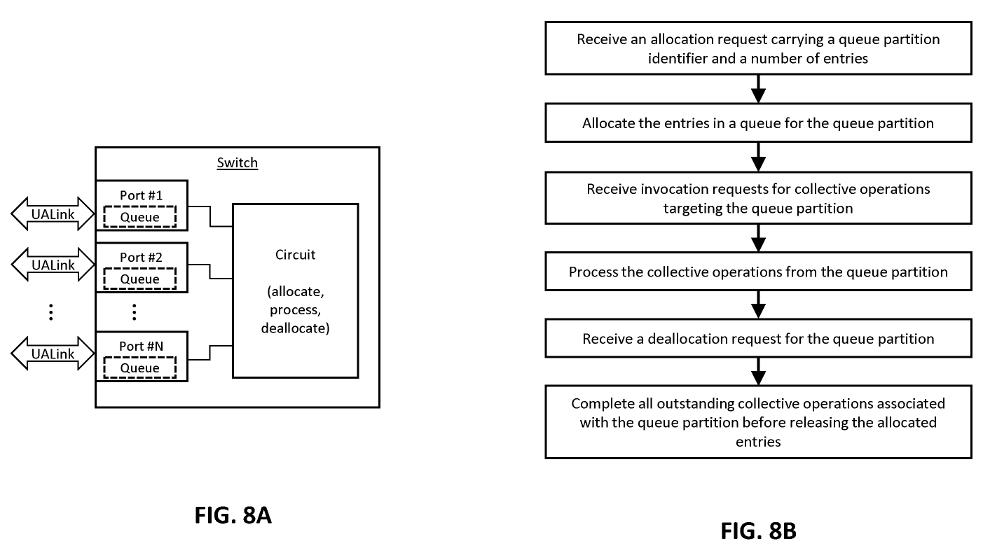

FIG. 8A illustrates a switch for a UALink-based network which may manage queue resources for block collective operations through a lifecycle of allocation, invocation, and deallocation. An accelerator may request allocation of entries in a per-port queue by specifying a queue partition identifier and a number of entries. The switch may allocate the requested entries and subsequently accept invocation requests for collective operations targeting the allocated partition. Multiple queue partitions may be active concurrently, enabling the switch to process collective operations from different partitions in an interleaved fashion. When the accelerator issues a deallocation request, the switch may complete all outstanding collective operations associated with the partition before releasing the allocated entries, providing a clean shutdown sequence that prevents data loss. This queue lifecycle management may enable pipelining of multiple collective operations and concurrent execution across different partitions.

The queue partition may be a submission queue within a per-port control block queue on the switch. The queue may store control blocks for pending collective operations, and the queue partition may be one of a plurality of numbered logical portions of the queue, each dynamically allocated by the accelerator. The queue partition identifier may be a submission queue number identifying the logical portion, and the number of entries may specify the capacity allocated to that logical portion. The queue partition identifier and the number of entries may be encoded in designated bit positions within the address field of the allocation request.

In various implementations, a switch for an Ultra Accelerator Link (UALink)-based network, comprising: a plurality of UALink-based ports, each port comprising a queue for storing collective operation parameters; and a circuit configured to: receive an allocation request from an accelerator via one of the plurality of UALink-based ports, the allocation request carrying a queue partition identifier and a number of entries to allocate, the queue partition identifier and the number of entries encoded in an address field of the allocation request; allocate the entries in the queue for the queue partition; receive invocation requests for collective operations targeting the queue partition, each invocation request carrying a control block specifying collective parameters; process the collective operations from the queue partition; and upon receiving a deallocation request for the queue partition, complete all outstanding collective operations associated with the queue partition before releasing the allocated entries. The queue may be implemented as an on-chip memory structure at each port, partitioned into logical portions identified by the queue partition identifier. The queue partition identifier and the number of entries may be encoded in specific bit positions of the address field of the allocation request, leveraging the existing request format without requiring additional signal fields. The circuit may maintain a set of management registers tracking the allocation state of each queue partition, including which partitions are allocated, how many entries each has, and how many entries are currently in use. The invocation requests may be accepted and their control blocks enqueued as long as the queue partition has available entries. The deallocation sequence may involve the circuit ceasing to accept new invocations for the partition, waiting for all in-progress collective operations to complete their memory access sequences and write their status buffers, and then marking the partition as available for reallocation. This drain-before-release behavior may prevent data loss or incomplete collective operations.

In some implementations of the switch, upon receiving the allocation request, the circuit returns a status indicating one of: successful allocation, invalid allocation, or duplicate allocation; wherein duplicate allocation is returned when the queue partition has already been allocated. The invalid allocation status may be returned when the allocation request specifies an invalid queue partition identifier or an invalid number of entries. The duplicate allocation status may prevent an accelerator from inadvertently overwriting an active queue partition that is already in use.

In some implementations of the switch, when the queue partition has no available entries, the circuit returns an insufficient resources status for invocation requests targeting the queue partition. The insufficient resources status may signal to the accelerator that the queue partition cannot accept additional invocations until one or more pending collective operations complete and free entries. The accelerator may retry the invocation after a delay or after polling for completion of a prior operation.

In some implementations of the switch, the circuit is further configured to process collective operations from different queue partitions concurrently, interleaving memory access requests from different collective operations. The interleaving may allow the switch to overlap the read and write latencies of different collective operations, improving overall throughput. The circuit may use round-robin, priority-based, or fair scheduling across active queue partitions.

In some implementations of the switch, the circuit processes collective operations from different queue partitions according to a priority-based scheduling policy, the priority configurable per queue partition. The priority may be assigned by the centralized controller or by the requesting accelerator as part of the allocation request. Higher-priority collective operations may receive a larger share of the switch's memory access bandwidth, enabling latency-sensitive operations to complete faster.

FIG. 8B illustrates a method for managing collective operation resources at a switch in a UALink-based network, comprising a lifecycle of allocation, invocation, processing, and deallocation. The method may begin with the accelerator requesting allocation of queue entries, proceed through one or more collective operation invocations, and conclude with deallocation where the switch drains all outstanding operations before releasing resources. This lifecycle may enable the accelerator to manage switch-side resources for collective operations in a controlled manner, similar to how software manages submission queues in storage controllers or network interface cards.

In various implementations, a method for managing collective operation resources at a switch in an Ultra Accelerator Link (UALink)-based network, comprising: receiving, at the switch via a UALink-based port, an allocation request from an accelerator, the allocation request carrying a queue partition identifier and a number of entries, the queue partition identifier and the number of entries encoded in an address field of the allocation request; allocating the entries in a queue at the switch for the queue partition; receiving invocation requests for collective operations targeting the queue partition; processing the collective operations from the queue partition; receiving a deallocation request for the queue partition; and completing all outstanding collective operations associated with the queue partition before releasing the allocated entries. The method may be performed independently on each port of the switch, with each port maintaining its own queue and allocation state. The allocation step may involve the circuit reserving a contiguous or non-contiguous set of entries in the queue for the specified partition. The processing step may involve the circuit dequeuing control blocks from the partition and executing the corresponding collective operations, including autonomously generating memory access requests. The deallocation step may involve a drain sequence where the circuit stops accepting new invocations, waits for all in-progress operations to complete their reads, writes, and status buffer updates, and then marks the entries as available. The method may be repeated for multiple allocation-deallocation cycles over the lifetime of the switch.

In some implementations, the method further comprises writing, by the switch, an intermediate progress indicator to the accelerator during processing of a collective operation, the intermediate progress indicator indicating a number of completed memory access requests relative to a total number of memory access requests for the collective operation. The intermediate progress indicator may enable the accelerator's software to monitor the progress of long-running collective operations, such as large all-reduce operations spanning many memory blocks. The progress indicator may be written to a designated location in the status buffer or to a separate progress register in accelerator memory.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In some examples, a switch for a UALink-based network may perform arithmetic reduction operations on data received from multiple accelerators as part of a collective read operation. The switch may receive a collective read request that specifies the reduction operation to perform and the datatype of the data, with both the reduction operation and the datatype encoded in a source identifier field of the request. This encoding may leverage an existing signal field that carries a different meaning for non-collective requests, delivering the arithmetic instruction to the switch without requiring additional signal fields or expanding the packet format. The circuit performing the reduction may support multiple reduction operations including minimum, maximum, addition, and bitwise logical operations across a range of integer and floating-point datatypes. The circuit may also support configurable rounding modes, including stochastic rounding with seed-based reproducibility for AI training workloads. This approach may enable the switch to perform data reduction within the network fabric, reducing the number of data traversals and the compute burden on the accelerators.

In various implementations, a switch for an Ultra Accelerator Link (UALink)-based network, comprising: a plurality of UALink-based ports; and a circuit configured to: receive a collective read request from a requesting accelerator via one of the plurality of UALink-based ports, the collective read request specifying a reduction operation and a datatype, the reduction operation and the datatype encoded in a source identifier field of the collective read request; receive data from a plurality of accelerators in response to replicated read requests; perform the reduction operation on the received data according to the datatype; and return a reduced result to the requesting accelerator. The circuit may decode the source identifier field to extract the reduction operation and the datatype, and may select the appropriate arithmetic logic and data path width based on the decoded values. The replicated read requests may be issued by the switch to each accelerator identified in a group of destination accelerators, and the circuit may accumulate or buffer the data payloads as they arrive. The reduction operation may be performed incrementally as each response arrives or after all responses have been collected, depending on the associativity of the operation. The reduced result may be returned to the requesting accelerator as a single response containing the computed result. The circuit may be implemented as a dedicated arithmetic logic unit within the switch, or as a configurable data path that shares resources with other switch functions. The source identifier field may include a multi-bit field on the request channel, and the encoding may define a mapping between bit patterns and combinations of reduction operations and datatypes.

In some implementations of the switch, the source identifier field carries a physical accelerator identifier for non-collective requests, and for the collective read request, the source identifier field is overloaded to carry the reduction operation and the datatype encoding. The overloading may allow the switch to deliver the arithmetic instruction without additional signal fields or packet format changes. The switch may determine whether to interpret the source identifier field as a physical accelerator identifier or as a reduction operation encoding based on the command type of the request.

In some implementations of the switch, the collective read request further specifies a rounding mode encoded in upper bits of the source identifier field, and the circuit performs the reduction operation using the specified rounding mode. The rounding mode may occupy the upper bits of the source identifier field, with the reduction operation and datatype occupying the lower bits. The rounding mode may specify how the circuit rounds intermediate or final results when the exact result cannot be represented in the target datatype, such as round to nearest even, round toward zero, or stochastic rounding.

In some implementations of the switch, the reduction operation comprises at least one of: minimum, maximum, addition, bitwise AND, bitwise OR, or bitwise XOR. The minimum and maximum operations may compare values from the participating accelerators and return the smallest or largest value, respectively. The addition operation may compute the element-wise sum of data from all participants. The bitwise operations may perform element-wise logical operations on the data regardless of the numerical format.

In some implementations of the switch, the datatype comprises at least one of: unsigned integer or signed integer in 8-bit, 16-bit, 32-bit, or 64-bit widths. The integer datatypes may cover the range of integer precisions commonly used in AI workloads, from 8-bit quantized activations and weights to 64-bit accumulators. The circuit may select the appropriate comparison, addition, or bitwise logic based on the integer width and signedness.

In some implementations of the switch, the datatype comprises at least one of: FP64, FP32, FP16, BF16, E5M2, or E4M3. The E5M2 and E4M3 formats may be 8-bit floating-point representations with 5-bit and 4-bit exponents respectively, providing reduced precision and bandwidth compared to FP16 or BF16. These compressed formats may be used in AI training and inference to reduce interconnect bandwidth consumption.

In some implementations of the switch, the rounding mode comprises stochastic rounding, and the switch comprises a hardware linear feedback shift register to generate pseudo-random values; and wherein the requesting accelerator provides a stochastic seed via a request attribute field of the collective read request, the request attribute field carrying byte enables for non-collective read requests. The hardware linear feedback shift register may produce a sequence of pseudo-random values that, when combined with the stochastic seed provided by the accelerator, determine the rounding direction for each element. The request attribute field may be overloaded to carry the stochastic seed instead of byte enables when the request is a collective read request, leveraging the existing field without additional signal overhead.

In some implementations of the switch, for minimum and maximum operations on floating-point data, the reduction operation encoding further specifies one of: a first NaN handling semantic in which a number is returned when one operand is NaN, or a second NaN handling semantic in which NaN is propagated. The first NaN handling semantic may correspond to IEEE 754-2008 MaxNum and MinNum behavior, where NaN operands are suppressed in favor of numeric operands. The second NaN handling semantic may correspond to IEEE 754-2019 maximum and minimum behavior, where NaN is propagated. An AI framework may select the appropriate semantic based on the model's numerical stability requirements.

In some implementations of the switch, the circuit performs addition of gradient values in FP16 or BF16 from the plurality of accelerators during a data-parallel training step of an AI model, and returns the reduced gradient to the requesting accelerator. During data-parallel training, each accelerator may compute local gradients for its partition of the training data. The collective read-reduce operation with addition may aggregate these gradients across all participating accelerators, producing a sum that may then be averaged and applied to update model parameters on each accelerator.

In some implementations of the switch, the reduction operation and the datatype are also specified in a reduction operation field within a control block carried with a block collective invocation request, using a same encoding as the source identifier field encoding. The shared encoding may allow the same arithmetic unit to process both collective primitive operations and block collective operations without requiring separate decoding logic. The control block may carry the encoding in a dedicated field alongside other collective parameters such as collective type, buffer offsets, and strided access parameters.

In some implementations of the switch, the reduction operation and datatype encoding specifies a vendor-defined reduction operation, and the circuit processes the vendor-defined reduction operation according to vendor-specific logic. The vendor-defined reduction operations may enable switch vendors to implement proprietary arithmetic functions beyond the standard operations, such as specialized activation functions, quantization-aware operations, or domain-specific reductions.

In some implementations, the switch further comprises hardware performance counters configured to track at least one of: a count of reduction operations performed, a latency of reduction operations, or a throughput of the circuit. The hardware performance counters may enable monitoring of the arithmetic unit's utilization and performance characteristics. The counters may be readable via the management interface and may be used by the centralized controller or by training framework software to optimize collective operation scheduling and datatype selection.

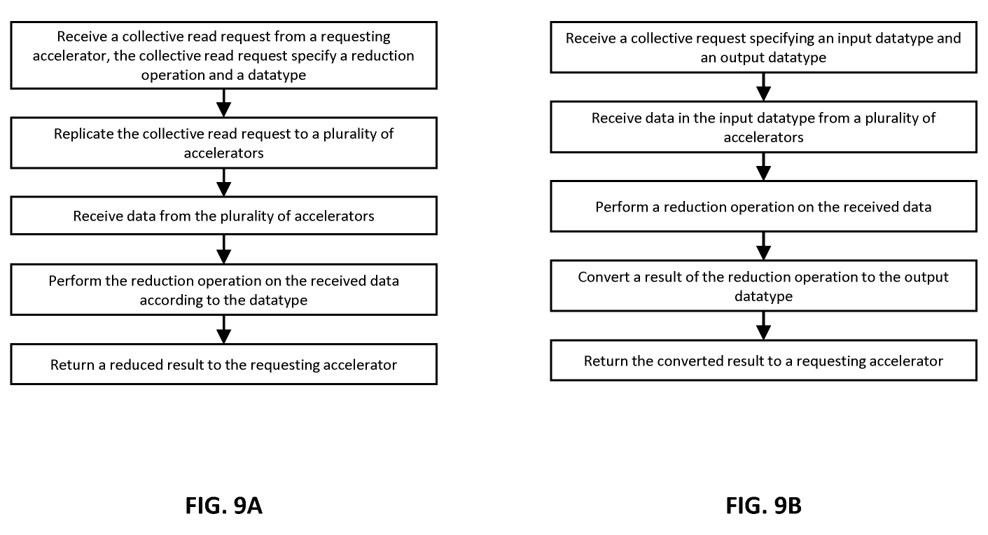

FIG. 9A illustrates a method for performing in-network data reduction in a UALink-based network, comprising receiving a collective read request at a switch, where the request specifies a reduction operation and a datatype encoded in a signal field that serves a different purpose for non-collective requests. The switch may replicate the collective read request to a plurality of accelerators, receive the data payloads, perform the specified reduction operation according to the specified datatype, and return a single reduced result. The method may support configurable rounding modes, including stochastic rounding with deterministic reproducibility when the same seed is used across repeated executions.

In various implementations, a method for performing in-network data reduction in an Ultra Accelerator Link (UALink)-based network, comprising: receiving, at a switch via a UALink-based port, a collective read request from a requesting accelerator, the collective read request specifying a reduction operation and a datatype, the reduction operation and the datatype encoded in a signal field that carries a source identifier for non-collective requests; replicating the collective read request to a plurality of accelerators; receiving data from the plurality of accelerators; performing the reduction operation on the received data according to the datatype; and returning a reduced result to the requesting accelerator. The method may be performed each time a collective read request arrives at the switch. The signal field may be decoded by the switch to extract both the reduction operation and the datatype, which together specify how the data payloads from the plurality of accelerators are to be combined. The replication may involve the switch issuing individual read requests to each accelerator in the collective group. The reduction may be performed element-wise across the data payloads, with the element size and arithmetic rules determined by the decoded datatype. The method may be applicable to collective groups ranging from two accelerators to the full radix of the switch.

In some implementations of the method, the signal field further encodes a rounding mode in upper bits, and performing the reduction operation comprises applying the rounding mode to the result. The rounding mode may determine how intermediate or final results are rounded when the exact result cannot be represented in the target precision. The rounding mode may be applied independently to each element of the reduced result.

In some implementations of the method, the rounding mode is stochastic rounding, and a stochastic seed provided by the requesting accelerator in a request attribute field is used by the switch to generate pseudo-random values; wherein repeated executions of the collective read request with the same data and the same stochastic seed produce identical reduced results. The deterministic reproducibility may be achieved by using the stochastic seed to initialize a pseudo-random number generator in the switch to the same state for each execution. This may enable AI training frameworks to reproduce training runs for debugging or compliance purposes, even when stochastic rounding is used to reduce quantization bias.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In some examples, a switch for a UALink-based network may perform data reduction with format conversion, receive data in one floating-point format, and return the reduced result in a different floating-point format. The input datatype and the output datatype may be independently configurable per collective request, enabling the requesting accelerator to select the optimal precision trade-off for each operation. For example, the switch may receive data in a compressed 8-bit floating-point format, perform reduction at a higher intermediate precision to preserve numerical accuracy, and return the result in either the original compressed format or the higher-precision format depending on the downstream requirements. This per-request format conversion may be particularly useful for AI training workloads that use mixed-precision strategies, where different phases of the training step may require different precision configurations. The circuit performing the format conversion and reduction may include precision conversion stages, an arithmetic unit, and rounding logic, all configurable per request.

In various implementations, a switch for an Ultra Accelerator Link (UALink)-based network, comprising: a plurality of UALink-based ports; and a circuit configured to: receive a collective request specifying an input datatype and an output datatype; receive data in the input datatype from a plurality of accelerators; perform a reduction operation on the received data; convert a result of the reduction operation to the output datatype; and return the converted result to a requesting accelerator; wherein the input datatype and the output datatype are independently configurable per collective request. The circuit may support format conversion between any combination of the supported datatypes, including conversions between different floating-point precisions (such as from E4M3 to FP16), between floating-point and integer formats, or between formats of the same precision but different representations (such as from E5M2 to E4M3). The independent configurability may allow the requesting accelerator to select the input datatype based on the format of the data stored in accelerator memory and the output datatype based on the precision requirements of the downstream computation. When the input and output datatypes are the same, the circuit may perform the reduction without format conversion. The per-request configurability may be achieved through encodings carried in the collective request that specify both the input and output datatype as part of a combined reduction operation and datatype field.

In some implementations of the switch, the circuit comprises a pipeline having: a first stage that converts input data from the input datatype to an intermediate precision having higher precision than the input datatype; a second stage that performs the reduction operation at the intermediate precision; and a third stage that converts the result from the intermediate precision to the output datatype. The three-stage pipeline may prevent precision loss that would occur if the reduction were performed directly in the compressed input format. By upconverting to the intermediate precision before accumulation, the circuit may preserve numerical accuracy across many addition operations. The third stage may apply the specified rounding mode when downconverting from the intermediate precision to the output datatype.

In some implementations of the switch, the input datatype, the intermediate precision, and the output datatype comprise at least one of: E4M3 input with FP16 intermediate and E4M3 output, E5M2 input with FP32 intermediate and E5M2 output, E4M3 input with BF16 intermediate and BF16 output, or FP16 input with FP32 intermediate and FP32 output. Each combination may be selected based on the precision requirements and bandwidth constraints of the AI workload. The E4M3 with FP16 intermediate combination may offer a balance between bandwidth reduction and precision for inference workloads, while the E5M2 with FP32 intermediate combination may provide higher precision for training workloads.

In some implementations of the switch, the input datatype, the output datatype, and the reduction operation are encoded in a combined encoding field, the encoding field carried in a source identifier field of the collective request for collective primitive operations and in a reduction operation field within a control block for block collective operations. The combined encoding may define a mapping where each encoding value specifies the full combination of reduction operation, input datatype, optional intermediate precision, and output datatype. This compact encoding may allow the switch to decode all arithmetic parameters from a single field without requiring multiple separate configuration fields.

In some implementations of the switch, during inference of a quantized AI model, the circuit receives data in the E4M3 or E5M2 input datatype from accelerators executing quantized model layers, performs the reduction operation at the intermediate precision, and returns the result in the output datatype. Quantized AI models may use FP8 representations for weights and activations to reduce memory footprint and bandwidth. The intermediate-precision reduction may allow the switch to combine quantized values with higher arithmetic accuracy than would be possible with direct FP8 arithmetic.

In some implementations of the switch, different collective requests within a same training step of an AI model specify different combinations of input and output datatypes, the combinations selected based on numerical requirements of different phases of the training step. A training step may include multiple phases with different precision requirements. For example, gradient accumulation may use FP16 input with FP32 intermediate computation, while model parameter updates may use BF16. The per-request configurability may allow the training framework to select the optimal precision for each phase without reconfiguring the switch between phases.

In some implementations of the switch, the circuit further comprises built-in self-test logic configured to verify correctness of the reduction operation across a range of datatypes and operations. The built-in self-test logic may execute a predefined set of test vectors covering representative datatypes and operations, and may compare the results against expected values to detect hardware faults in the arithmetic unit. The self-test may be triggered during switch initialization, periodically during operation, or on demand via the management interface.

FIG. 9B illustrates a method for performing data reduction with format conversion in a UALink-based network, comprising the switch receiving data in one datatype and returning the reduced result in a different datatype, with both datatypes specified per collective request. The method may include an optional intermediate precision conversion step where the received data is upconverted to a higher precision before reduction to preserve numerical accuracy. This method may be used in AI training and inference workloads where the data stored in accelerator memory is in a compressed format but the arithmetic computation benefits from higher-precision intermediate representation.

In various implementations, a method for performing data reduction with format conversion in an Ultra Accelerator Link (UALink)-based network, comprising: receiving, at a switch via a UALink-based port, a collective request specifying an input datatype and an output datatype; receiving data in the input datatype from a plurality of accelerators; performing a reduction operation on the received data; converting a result of the reduction operation to the output datatype; and returning the converted result to a requesting accelerator. The method may be performed by the switch each time a collective request specifying different input and output datatypes arrives. The format conversion may involve rounding, truncation, or precision extension depending on the relationship between the input and output datatypes. When the input and output datatypes are the same, the conversion step may be a pass-through operation. The method may be applicable to both collective primitive operations, where the datatype encoding is carried in a signal field of the request, and block collective operations, where the datatype encoding is carried in a control block.

In some implementations, the method further comprises converting the received data from the input datatype to an intermediate precision having higher precision than the input datatype before performing the reduction operation; and performing the reduction operation at the intermediate precision. The intermediate precision conversion may prevent the accumulation of rounding errors that would occur if the reduction were performed directly in the compressed input datatype. The reduction at the intermediate precision may maintain higher numerical accuracy across many accumulation steps, with the final conversion to the output datatype applying the specified rounding mode.

In some implementations of the method, an accelerator coupled to a host via Compute Express Link (CXL) maps tensor data in a first precision format from the host to the collective request specifying a different input datatype, performing implicit precision conversion at a protocol boundary. The protocol boundary between CXL and UALink may serve as a natural point for precision conversion, where tensor data stored in the host's memory in one precision format may be mapped to a different precision for the collective operation. This may enable the host and the accelerators to use different precision strategies without requiring explicit data conversion steps in software.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

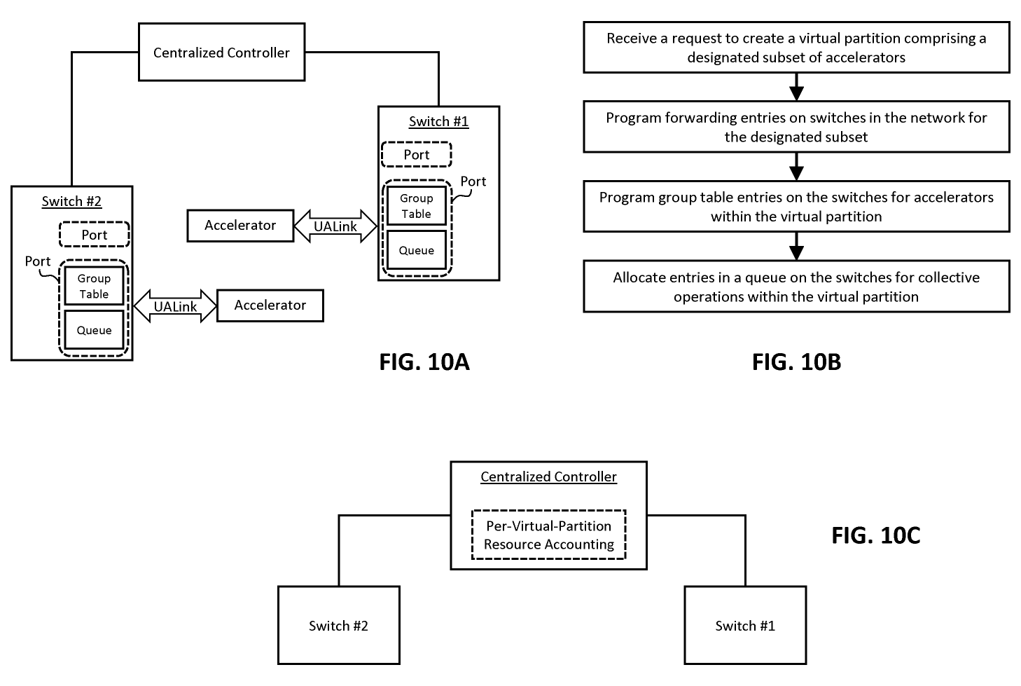

FIG. 10A illustrates a system for a UALink-based network that includes a centralized controller that integrates collective operation resource allocation into the virtual partition lifecycle. When the centralized controller creates a virtual partition for a tenant, it may program forwarding entries on the switches to establish routing paths for the designated accelerators, and then program group table entries and allocate queue entries for collective operations within the virtual partition. The ordering may be significant: group table entries may be programmed after forwarding entries because replicated collective requests generated by the switches need established routes to reach destination accelerators. The virtual partition may be a virtual pod comprising a non-overlapping subset of accelerators within a pod that may communicate amongst themselves but not with accelerators outside the subset. The virtual partition may be assigned to a single tenant, and the switches may enforce traffic isolation between virtual partitions by partitioning switch ports into non-overlapping subsets. The centralized controller may create and tear down virtual partitions independently without affecting other active virtual partitions.

In various implementations, a system for an Ultra Accelerator Link (UALink)-based network, comprising: switches, each switch comprising UALink-based ports, each port comprising a group table and a queue for collective operations; and a centralized controller coupled to the switches via an out-of-band management interface; wherein the centralized controller is configured to, upon creating a virtual partition comprising a designated subset of accelerators: program forwarding entries on the switches for the designated subset; after the forwarding entries are installed, program group table entries on the switches for accelerators within the virtual partition; and allocate entries in the queue on the switches for collective operations within the virtual partition. The centralized controller may receive the virtual partition creation request from a workload orchestrator, an administrator, or an automated provisioning system. The forwarding entries may restrict traffic within the switches to the designated subset of accelerators, establishing routing paths that enable the accelerators to communicate. The group table entries may map group identifiers to bitmasks identifying groups of accelerators within the designated subset, enabling the switches to perform in-network collective operations for the virtual partition. The queue entries may store parameters for offloaded collective operations, enabling the switches to generate memory access requests for collective data reduction. Programming the group table entries after the forwarding entries may prevent a situation where the switch activates a collective group but lacks the route table entries needed to deliver replicated requests to destination accelerators. The centralized controller may program group table entries and allocate queue entries on each port of each switch that serves the virtual partition.

In some implementations of the system, the centralized controller is further configured to, upon tearing down the virtual partition: deactivate the group table entries and deallocate the entries in the queue for the virtual partition; and after the group table entries are deactivated and the queue entries are deallocated, remove the forwarding entries for the virtual partition from the switches. The reverse ordering on teardown may prevent in-flight collective operations from generating replicated requests that have no routes. Deactivating group table entries first may cause any new collective request for the virtual partition to receive a target abort response, halting new collectives. After deactivation and deallocation, the centralized controller may safely remove the forwarding entries without risking orphaned collective traffic.

In some implementations of the system, deactivating the group table entries comprises clearing a valid indicator of each group table entry for the virtual partition on each switch, and the centralized controller waits for outstanding collective operations associated with the virtual partition to complete before removing the forwarding entries. Waiting for outstanding collective operations to complete may prevent loss of in-flight collective data. The centralized controller may poll for completion or may receive completion notifications from the switches before proceeding with forwarding entry removal.

In some implementations of the system, the centralized controller further enables switch ports associated with the designated subset of accelerators to carry transactions after the forwarding entries are installed and the group table entries are programmed and the queue entries are allocated. Enabling the switch ports after all resources are in place may prevent transactions from flowing before the collective operation infrastructure is ready, avoiding failures when an accelerator issues a collective request before the group table entries are active.

In some implementations of the system, the group table entries each comprise a valid indicator and a bitmask identifying a group of accelerators within the designated subset, and the centralized controller programs the group table entries on each port of each switch that serves the virtual partition. The bitmask may have a width equal to the radix of the switch, with each bit position corresponding to a physical accelerator identifier. Programming group table entries on each port may enable collective operations regardless of which port the collective request arrives on.

In some implementations of the system, allocating entries in the queue comprises the centralized controller reserving queue partitions on ports of the switches for the virtual partition, each queue partition identified by a queue partition identifier. The queue partition may be a submission queue within a per-port control block queue on the switch. Each queue partition may be dynamically allocated a number of entries for storing collective operation parameters, and the queue partition identifier may be encoded in an address field of an allocation request.

In some implementations of the system, the centralized controller receives a request from a workload orchestrator to create the virtual partition, the request specifying a number of accelerators and collective operation resource requirements comprising a number of collective groups and a queue capacity, and the centralized controller allocates group table entries and queue entries according to the collective operation resource requirements. The workload orchestrator may specify collective operation resource requirements based on the AI training framework's communication patterns. A data-parallel training workload may require group table entries for gradient all-reduce groups and queue entries for pipelined block collective operations.

In some implementations of the system, upon adding an accelerator to the virtual partition, the centralized controller updates group table bitmasks on the switches to include the added accelerator; and upon removing an accelerator from the virtual partition, the centralized controller updates group table bitmasks to exclude the removed accelerator and verifies that no outstanding collective operations reference the removed accelerator. Updating group table bitmasks when accelerators are added or removed may maintain consistency between the virtual partition membership and the collective group membership, preventing collective operations from targeting accelerators that are no longer part of the virtual partition.

In some implementations of the system, programming group table entries on the switches comprises: programming the group table entries with a valid indicator cleared on each switch; verifying consistency of the programmed entries across the switches; and upon successful verification, setting the valid indicator on each switch to activate the group table entries. Programming with the valid indicator cleared may prevent accelerators from issuing collective requests before all switches have consistent entries. Verifying consistency may detect programming errors or communication failures. Setting the valid indicator after verification may provide a coordinated activation point across all switches.

FIG. 10B illustrates a method for creating a virtual partition with collective operation resources comprising a centralized controller programming forwarding entries, then programming group table entries, and then allocating queue entries for a virtual partition. This sequenced approach may provide that routing paths are established before collective operation resources are activated, and that collective operation resources are deactivated before routing paths are removed during teardown.

In various implementations, a method for creating a virtual partition with collective operation resources in an Ultra Accelerator Link (UALink)-based network, comprising: receiving, at a centralized controller, a request to create a virtual partition comprising a designated subset of accelerators; programming, by the centralized controller, forwarding entries on switches in the network for the designated subset; after the forwarding entries are installed, programming, by the centralized controller, group table entries on the switches for accelerators within the virtual partition; and allocating, by the centralized controller, entries in a queue on the switches for collective operations within the virtual partition. The method may be performed as part of an automated provisioning workflow triggered by a workload orchestrator or administrator. The forwarding entries may establish routing paths between accelerators in the designated subset. The group table entries may enable in-network collective operations for the virtual partition. The queue entries may enable offloaded collective operations where the switch, possibly autonomously, generates memory access requests.

In some implementations, the method further comprises tearing down the virtual partition by: deactivating the group table entries and deallocating the entries in the queue for the virtual partition; and after the group table entries are deactivated and the queue entries are deallocated, removing the forwarding entries for the virtual partition from the switches. The reverse ordering on teardown may mirror the creation ordering: collective operation resources are released before routing paths are removed, preventing orphaned collective traffic from traversing routes that are about to be deleted.

In some implementations of the method, the centralized controller performs concurrent virtual partition operations comprising creating a first virtual partition and tearing down a second virtual partition, and the group table entries and queue entries for the first virtual partition are isolated from the group table entries and queue entries for the second virtual partition. Isolating INC resources between concurrent virtual partition operations may prevent teardown of one virtual partition from affecting collective operations in another virtual partition, even when both virtual partitions share ports on the same switches.

In some implementations of the method, after creating the virtual partition, the centralized controller pre-allocates group table entries for anticipated collective communication patterns comprising at least one of all-reduce, broadcast, or reduce, based on a workload type associated with the virtual partition. Pre-allocating group table entries for anticipated patterns may reduce the latency of the first collective operation issued by the tenant's training framework, because the group table entries are already programmed and activated when the framework issues its first collective request.

In some implementations, the method further comprises periodically auditing, by the centralized controller, group table entries and queue entries on the switches to detect entries not associated with any active virtual partition, and reclaiming the detected entries. Orphaned INC resources may result from incomplete teardown sequences, management communication failures, or software bugs. Periodic auditing may detect and reclaim these resources, preventing gradual resource exhaustion over time. In some implementations of the method, a non-transitory computer-readable medium comprising instructions which, when executed by a processor, cause the processor to perform the method.

FIG. 10C illustrates a system for a UALink-based network that includes a centralized controller that maintains per-virtual-partition resource accounting for in-network collective operation resources and enforces per-virtual-partition quotas. Each switch port may have a finite number of group table entries and queue entries available for collective operations. In a multi-tenant deployment where multiple virtual partitions share the same physical switches, the centralized controller may track how many of these resources each virtual partition consumes and may enforce quotas to prevent one virtual partition from exhausting shared resources. The quotas may be configured based on workload type, tenant priority, or service-level agreements, and may be dynamically adjusted based on observed utilization.

In various implementations, a system for an Ultra Accelerator Link (UALink)-based network, comprising: switches, each switch comprising UALink-based ports, each port comprising a group table and a queue for collective operations; and a centralized controller coupled to the switches via an out-of-band management interface; wherein the centralized controller is configured to: maintain per-virtual-partition resource accounting comprising, for each virtual partition: a count of group table entries allocated to the virtual partition, and a count of queue entries allocated to the virtual partition; and enforce per-virtual-partition quotas by rejecting a request to allocate group table entries or queue entries for a virtual partition when the allocation would cause the count to exceed a configured quota for the virtual partition. The centralized controller may maintain the resource accounting in a database or data structure that tracks the allocation state of each group table entry and queue entry on each port of each switch, associating each allocated entry with the virtual partition that owns it. The quota enforcement may prevent a single tenant from consuming all available INC resources on shared switch ports, which would prevent other tenants from creating collective groups or submitting block collective operations. The rejection may return an error indication to the requesting entity, enabling the tenant's software to adjust its collective operation strategy.

In some implementations of the system, the configured quota is determined based on a workload type associated with the virtual partition, wherein a training workload type receives a higher quota for group table entries and queue entries than an inference workload type. Training workloads may require many concurrent collective groups for gradient synchronization across large numbers of accelerators, while inference workloads may require fewer collective groups. Allocating higher quotas to training workloads may reflect the higher INC resource consumption of training relative to inference.

In some implementations of the system, when the count of group table entries or queue entries for a virtual partition exceeds a configurable threshold below the configured quota, the centralized controller generates a notification to a workload management system indicating approaching resource exhaustion. The notification may enable the workload management system to take proactive action, such as consolidating collective groups, deallocating unused groups, or requesting additional resources, before the quota is reached and further allocations are rejected.

In some implementations of the system, the centralized controller exposes the per-virtual-partition resource accounting and the configured quotas as management data model attributes queryable via the out-of-band management interface. Exposing INC resource accounting and quotas as management data model attributes may enable operators, workload orchestrators, and monitoring systems to query the current allocation state and quota utilization for each virtual partition, supporting capacity planning and troubleshooting.

In some implementations of the system, upon creation of a new virtual partition, the centralized controller rebalances the configured quotas across all active virtual partitions to provide fair access to group table entries and queue entries across the switches. Rebalancing quotas upon new virtual partition creation may prevent a situation where early tenants receive large quotas and later tenants receive minimal allocations because the capacity was already committed. The rebalancing may be weighted by tenant priority or workload type.

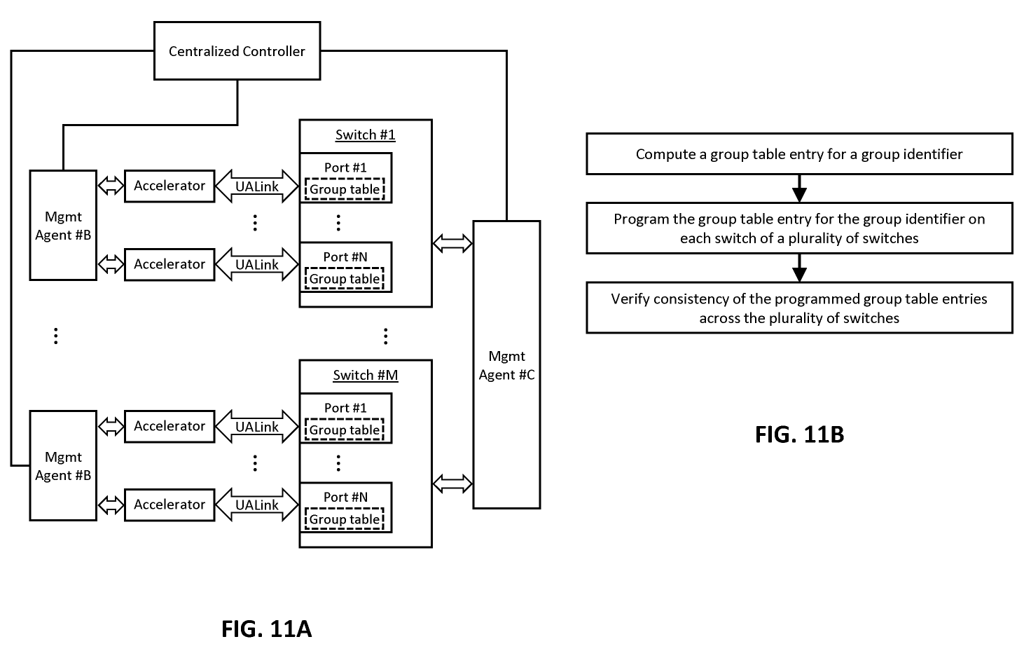

FIG. 11A illustrates a system for a UALink-based network comprising a centralized controller that programs group table entries across a plurality of switches to enable in-network collective operations spanning accelerators coupled to different switches. The centralized controller may compute the group table entry for a collective group, determining which accelerators are members of the group and encoding the membership in a bitmask. The centralized controller may then program the entry on each switch via an out-of-band management interface and verify that all switches have consistent entries before accelerators are permitted to issue collective requests using the group identifier. This multi-switch consistency programming may involve a management agent on each switch that receives the group table entry from the centralized controller and installs it on the switch hardware. The verification may detect programming errors, communication failures, or hardware faults that could result in inconsistent group membership across switches. The consistency programming protocol may be performed as part of the initial network configuration, during workload deployment, or dynamically during operation as collective groups are created, modified, or deleted.

In various implementations, a system for an Ultra Accelerator Link (UALink)-based network, comprising: a plurality of switches, each switch comprising a plurality of UALink-based ports, each port comprising a group table comprising entries, each entry comprising a valid indicator and a bitmask identifying a group of accelerators; and a centralized controller coupled to the plurality of switches via an out-of-band management interface; wherein the centralized controller is configured to: for a collective group comprising accelerators coupled to different switches of the plurality of switches, compute a group table entry for a group identifier, the group table entry comprising a bitmask identifying accelerators in the collective group; program the group table entry for the group identifier on each switch of the plurality of switches; and verify consistency of the programmed group table entries across the plurality of switches. The centralized controller may determine the membership of the collective group based on workload requirements, virtual partition allocation, or external input from a workload orchestrator. The bitmask may have a width equal to the radix of the switch, with each bit position corresponding to a physical accelerator identifier. The centralized controller may program the same bitmask on each switch, since each switch's route table handles the physical routing of replicated requests to destination accelerators regardless of which switch the destination accelerator is coupled to. The verification may include one or more mechanisms, such as read-back comparison, checksum verification, or acknowledgment-based confirmation. The system may support up to 1024 group identifiers per port and up to 1024 accelerators in the collective group. The centralized controller may be implemented as software executing on a dedicated server, a process on a management controller, or firmware on a baseboard management controller.

In some implementations of the system, the centralized controller is configured to: program the group table entry on each switch with the valid indicator cleared; upon successful verification, set the valid indicator on each switch to activate the group identifier for collective operations. Programming the entry with the valid indicator cleared may prevent accelerators from issuing collective requests with the group identifier before all switches have been consistently programmed. Setting the valid indicator after verification may gate the activation of the group, providing a coordination point between the management plane and the data plane.

In some implementations of the system, the centralized controller verifies consistency by reading back the programmed group table entry from each switch via the out-of-band management interface and comparing the read-back bitmask against the expected bitmask for the collective group. The read-back verification may detect programming errors caused by communication failures, hardware faults, or firmware bugs on the switch. The centralized controller may maintain a reference copy of each group table entry and compare the read-back values against this reference.

In some implementations of the system, the centralized controller programs forwarding entries on each switch before programming the group table entries, such that replicated requests generated from the group table entries are routable via the forwarding entries. Programming forwarding entries before group table entries may prevent a situation where the switch activates a group identifier but lacks the route table entries needed to deliver replicated requests to destination accelerators. The centralized controller may perform group table programming as a final step after route table programming and verification.

In some implementations of the system, upon detecting an inconsistency during verification, the centralized controller reprograms the affected switch and re-verifies; and upon failure to resolve the inconsistency, the centralized controller clears the valid indicator on all switches for the group identifier. Clearing the valid indicator on all switches upon unresolvable failure may prevent accelerators from issuing collective requests that would produce incorrect results due to inconsistent group membership across switches. The centralized controller may log the failure for diagnostic purposes and notify an operator.

In some implementations of the system, the centralized controller programs the group table entries per virtual partition, verifying that the bitmask for the collective group references accelerators allocated to the virtual partition associated with the collective group. The virtual partition scoping may prevent the centralized controller from inadvertently programming a group table entry that references accelerators belonging to a different tenant, which could cause data leakage or interference between tenants' collective operations. In some examples, a virtual partition refers to a virtual pod.

In some implementations of the system, the centralized controller programs the group table entry on each switch via a management agent associated with the switch, the management agent installing the group table entry on the switch via a hardware abstraction interface. The management agent may receive the group table entry from the centralized controller via a management protocol and translate it into hardware-specific commands for the switch via a hardware abstraction interface. This may enable the centralized controller to program group tables on switches from different vendors using a uniform interface.

In some implementations of the system, the centralized controller programs group table entries for a plurality of group identifiers on each switch in a single programming transaction. Batch programming may reduce the number of management protocol transactions between the centralized controller and each switch, lowering the overall latency for configuring multiple collective groups. The centralized controller may verify consistency for all group identifiers in the batch before activating any of them.

In some implementations of the system, the collective group comprises accelerators executing a data-parallel training workload of an AI model, and the centralized controller programs group table entries for a gradient all-reduce collective operation across the plurality of switches. In data-parallel training, all participating accelerators may need to synchronize gradients via an all-reduce collective operation. The centralized controller may program group table entries that include all accelerators in the data-parallel training group, enabling the switches to perform in-network gradient reduction.

In some implementations of the system, the centralized controller periodically reads group table entries from each switch and verifies consistency against a reference copy maintained by the centralized controller, and upon detecting a discrepancy, reprograms the affected switch. Periodic auditing may detect silent corruption of group table entries caused by hardware faults such as memory bit flips, or configuration drift caused by firmware bugs. The audit interval may be configurable by an operator.

FIG. 11B illustrates a method for programming consistent group table entries across switches in a UALink-based network, comprising the centralized controller computing the correct bitmask for each collective group, programming the entry on each switch, and verifying that all switches have consistent entries. The method may include a three-phase activation protocol that uses the valid indicator as a gating mechanism, group modification with deactivation and reactivation, group deletion, and pre-provisioning of backup entries for fast failover. The method may be performed as part of the initial network bring-up, during workload deployment, or dynamically during operation.

In various implementations, a method for programming consistent group table entries across switches in an Ultra Accelerator Link (UALink)-based network, comprising: for a collective group comprising accelerators coupled to different switches of a plurality of switches, computing, by a centralized controller, a group table entry for a group identifier, the group table entry comprising a bitmask identifying accelerators in the collective group; programming, by the centralized controller via an out-of-band management interface, the group table entry for the group identifier on each switch of the plurality of switches; and verifying, by the centralized controller, consistency of the programmed group table entries across the plurality of switches. The method may be triggered by a workload orchestrator requesting the creation of a collective group, by a training framework initiating a new collective communication pattern, or by the centralized controller as part of an automated network configuration process. The computing step may involve determining group membership from virtual partition assignments, workload requirements, or explicit group definitions. The programming step may involve transmitting the group table entry to each switch's management agent and waiting for acknowledgment. The verification step may involve reading back entries, comparing checksums, or other consistency checks.

In some implementations of the method, programming comprises programming the group table entry on each switch with a valid indicator of the group table entry cleared; and further comprising, upon successful verification, setting the valid indicator on each switch to activate the group identifier for collective operations. The three-phase activation protocol may coordinate the transition from an inactive group (valid indicator cleared) to an active group (valid indicator set) across all switches, providing a consistent activation point that prevents accelerators from using the group identifier before all switches are ready.

In some implementations, the method further comprises modifying the collective group by: clearing the valid indicator for the group identifier on each switch; reprogramming the bitmask on each switch to reflect modified group membership; verifying the reprogrammed bitmask on each switch; and setting the valid indicator on each switch to reactivate the group identifier. The modification protocol may be used to add or remove accelerators from an active collective group, such as when scaling an AI training workload up or down. Clearing the valid indicator before reprogramming may cause any in-flight collective request for that group identifier to receive a target abort response, while collective operations for other group identifiers remain unaffected.

In some implementations, the method further comprises pre-provisioning, by the centralized controller, a backup group table entry for the group identifier on each switch, the backup entry comprising a bitmask with a replacement accelerator substituted for an accelerator in the collective group; and upon detecting failure of the accelerator, activating the backup entry on each switch. Pre-provisioning backup entries may enable fast failover when an accelerator fails, avoiding the latency of computing a new bitmask, programming all switches, and verifying consistency. The centralized controller may maintain backup entries for accelerators identified as high-risk based on health telemetry.

In some implementations, the method further comprises deleting the collective group by: clearing the valid indicator for the group identifier on each switch; clearing the bitmask on each switch; and releasing the group identifier for reuse. The deletion protocol may free group table entries for reuse by new collective groups. Clearing the bitmask after deactivation may prevent stale group membership from being inadvertently reactivated if the group identifier is later reassigned to a different collective group.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

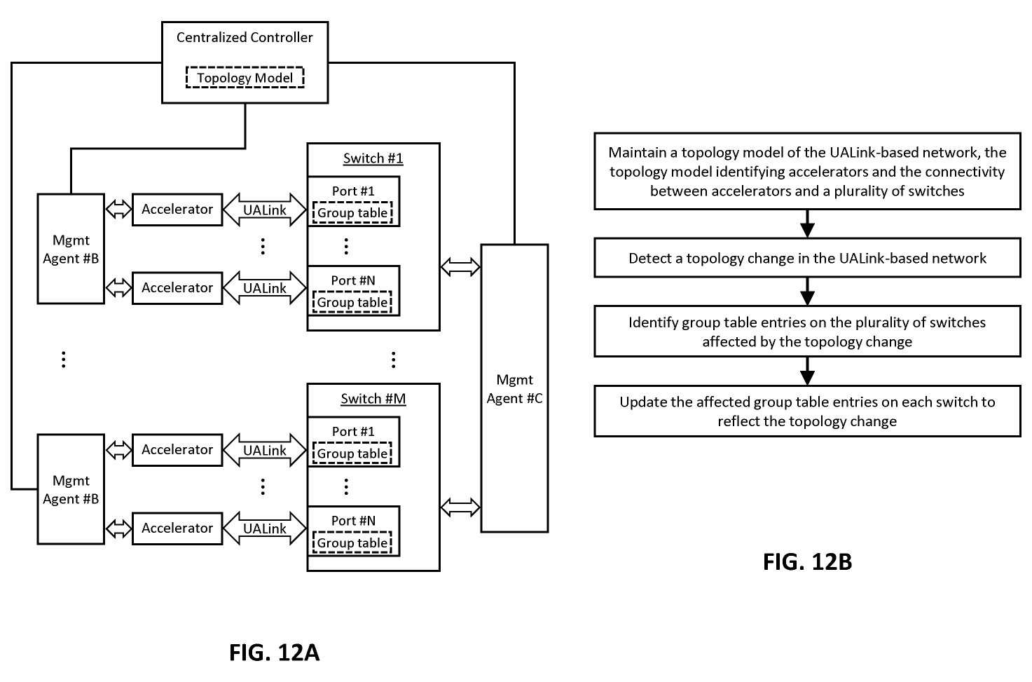

FIG. 12A illustrates a system for a UALink-based network comprising a centralized controller that automatically maintains group table entries in response to topology changes in the network. The centralized controller may maintain a topology model representing the current connectivity between accelerators and switches, and may update this model when events such as link failures, accelerator failures, or administrative port state changes occur. When the topology model changes, the centralized controller may identify which group table entries are affected by the change and update those entries on each switch to reflect the new topology. This automatic maintenance may prevent collective operations from failing due to stale group table entries that reference accelerators that are no longer reachable, and may enable the network to adapt to failures without manual intervention.

In various implementations, a system for an Ultra Accelerator Link (UALink)-based network, comprising: a plurality of switches, each switch comprising a plurality of UALink-based ports, each port comprising a group table comprising entries, each entry comprising a valid indicator and a bitmask; and a centralized controller coupled to the plurality of switches via an out-of-band management interface; wherein the centralized controller is configured to: maintain a topology model of the UALink-based network, the topology model identifying accelerators and the connectivity between accelerators and the plurality of switches; upon detecting a topology change in the UALink-based network, identify group table entries affected by the topology change; and update the affected group table entries on each switch of the plurality of switches to reflect the topology change. The topology model may represent the physical connectivity between accelerators and switch ports, the link state of each connection, and the reachability of each accelerator from each switch. The centralized controller may build the topology model during initial network bring-up and maintain it by processing state change notifications from management agents. The identification of affected group table entries may involve searching all active group table entries for those whose bitmask includes an accelerator affected by the topology change. The update may involve modifying the bitmask, clearing the valid indicator, or deleting the entry depending on the nature and severity of the topology change.

In some implementations of the system, the topology change comprises at least one of: a link failure between an accelerator and a switch, an accelerator failure, or an administrative change to a port state on one of the plurality of switches. A link failure may render an accelerator unreachable from one or more switches. An accelerator failure may remove an accelerator from all collective groups. An administrative port state change may intentionally take a port offline for maintenance, requiring affected group table entries to be updated.

In some implementations of the system, the centralized controller is configured to: upon detecting the topology change, clear the valid indicator of the affected group table entries on each switch; update the bitmask of the affected entries to remove an accelerator that is no longer reachable; verify the updated entries; and set the valid indicator on each switch to reactivate the affected group identifiers. Clearing the valid indicator before updating the bitmask may cause any in-flight collective request for the affected group to receive a target abort response, which the requesting accelerator's software may handle as a retriable error. Reactivating after verification may allow collective operations to resume with the corrected group membership.

In some implementations of the system, upon detecting failure of an accelerator, the centralized controller identifies all group table entries across the plurality of switches that include the failed accelerator in their bitmask, and removes the failed accelerator from all identified entries. An accelerator may be a member of multiple collective groups simultaneously, such as a gradient all-reduce group and a model broadcast group. Removing the failed accelerator from all groups may prevent multiple concurrent collective operations from timing out on the failed accelerator.

In some implementations of the system, upon detecting the topology change, the centralized controller updates forwarding entries on the plurality of switches to reflect the changed topology, and further verifies that replicated requests generated from the affected group table entries remain routable via the updated forwarding entries. The coordinated update may prevent a situation where the forwarding entries are updated to remove a path but the group table still directs replicated requests along that path. The centralized controller may perform route table updates first and group table updates second, consistent with the ordering dependency for initial programming.

In some implementations of the system, upon detecting the topology change, the centralized controller further notifies a workload management system that a collective group has been modified, enabling the workload management system to reconfigure an AI training workload to operate with the modified group membership. The workload management system may reconfigure a data-parallel training workload to redistribute data partitions across the remaining accelerators, or may pause training and checkpoint the model state before reconfiguration.

In some implementations of the system, a management agent on each switch transmits asynchronous notifications to the centralized controller upon detecting a port state change, and the centralized controller processes the notifications to update the topology model and trigger group table updates. The asynchronous notifications may enable the centralized controller to respond to topology changes in near real-time without polling. The management agent may generate notifications for link-up, link-down, and administrative state change events.

In some implementations of the system, the topology change affects accelerators in a plurality of virtual partitions, and the centralized controller updates group table entries in each affected virtual partition independently while maintaining isolation between virtual partitions. A single link failure may affect accelerators assigned to different tenants. The centralized controller may update group table entries for each affected virtual partition without exposing group membership information across virtual partition boundaries.

FIG. 12B illustrates a method for maintaining group table consistency in response to topology changes in a UALink-based network, comprising a centralized controller detecting topology events, identifying affected group table entries, and updating the entries to maintain consistency between group membership and network reachability. The method may include pre-activation topology validation to prevent activation of groups with unreachable members, and event logging for diagnostic and compliance purposes.

In various implementations, a method for maintaining group table consistency in response to topology changes in an Ultra Accelerator Link (UALink)-based network, comprising: maintaining, by a centralized controller, a topology model of the UALink-based network, the topology model identifying accelerators and the connectivity between accelerators and a plurality of switches; detecting a topology change in the UALink-based network; identifying group table entries on the plurality of switches affected by the topology change; and updating the affected group table entries on each switch to reflect the topology change. The method may be event-driven, triggered by notifications from management agents on the switches, or may be discovery-driven, triggered by the centralized controller detecting connectivity changes during periodic polling. The identification step may involve scanning a database of active group table entries maintained by the centralized controller, comparing each entry's bitmask against the affected accelerators or links. The updating step may involve modifying bitmasks, deactivating and reactivating entries, or deleting entries that no longer have viable membership.

In some implementations, the method further comprises before activating a group identifier for collective operations, validating that all accelerators identified in the bitmask of the group table entry are reachable from each switch based on the topology model. The pre-activation validation may detect situations where an accelerator is included in a collective group but is not reachable from one or more switches due to a topology condition that occurred between group programming and activation. This may prevent collective operations from failing immediately upon activation.

In some implementations, the method further comprises logging, by the centralized controller, each update to the group table entries with a timestamp, the group identifier, the topology change that triggered the update, and the updated bitmask. The event log may provide an audit trail for diagnostic purposes, enabling operators to trace the history of group table changes and correlate them with topology events. The log may also serve compliance requirements for systems that maintain records of configuration changes.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

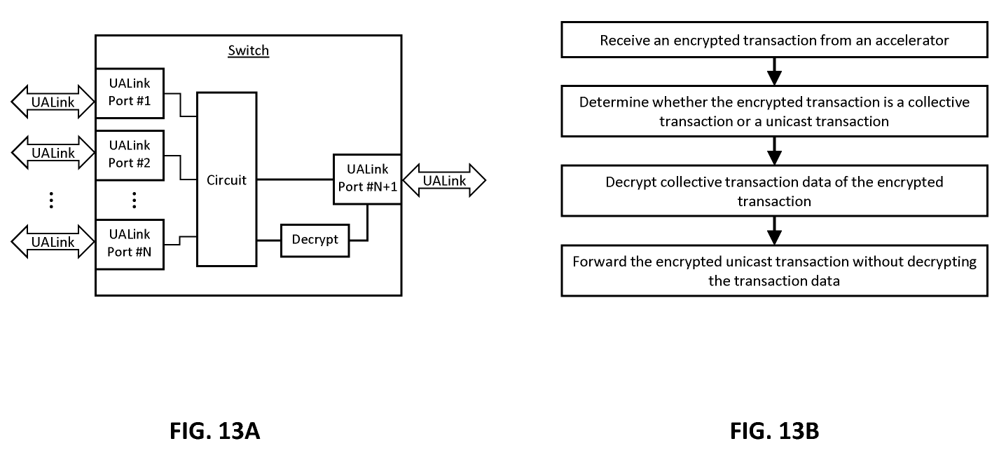

FIG. 13A illustrates a switch supporting both collective operations and unicast operations. Collective operations, such as reduction, multicast, and broadcast, involve data from multiple accelerators and may require the switch to inspect, process, or combine the data payloads. Unicast operations involve communication between a pair of accelerators and do not require the switch to access the data payload. When encryption is enabled on the links between accelerators and the switch, the switch may need to selectively decrypt collective transaction data to perform operations such as arithmetic reduction, while bypassing decryption for unicast transactions so that the data remains encrypted end-to-end between the source and destination accelerators. A circuit at the switch may determine whether each incoming encrypted transaction is a collective transaction or a unicast transaction by inspecting a command type field for incoming requests or a response type information field for incoming responses. The command type field may identify specific collective commands, such as ReadReduce, WriteMulticast, WriteFullMulticast, AtomicNRMulticast, BlockCollectiveInvoke, BlockCollectiveAllocate, or BlockCollectiveDeallocate. The response type information field may indicate whether the response corresponds to a collective primitive, a block collective, or a unicast transaction. When the transaction is identified as collective, the circuit may decrypt the data for processing. When the transaction is identified as unicast, the circuit may bypass the decryption path and forward the encrypted transaction to the destination port, preserving end-to-end encryption between accelerators. This selective approach enables the switch to participate in collective computations while maintaining data confidentiality for unicast traffic, supporting confidential computing in multi-tenant accelerator deployments.

In various implementations, a switch for an Ultra Accelerator Link (UALink)-based network, comprising: a plurality of ports, each port coupled to an accelerator via a UALink-based link; and a circuit configured to: determine, for an encrypted transaction received on a port of the plurality of ports, whether the encrypted transaction is a collective transaction or a unicast transaction, based on at least one of: a command type field of the encrypted transaction, or a response type information field of the encrypted transaction; decrypt transaction data of the encrypted transaction when the encrypted transaction is the collective transaction; and bypass decryption of the transaction data when the encrypted transaction is the unicast transaction, wherein the transaction data remains encrypted as the encrypted transaction is forwarded through the switch to a destination port of the plurality of ports. The circuit may operate on each incoming transaction independently, evaluating the command type field or the response type information field to make a per-transaction decision on whether to decrypt or bypass. For incoming requests from an accelerator, the circuit may inspect the command type field to identify collective commands that carry data requiring in-network processing. For incoming responses from an accelerator, the circuit may inspect the response type information field to identify responses to collective operations that carry data requiring reduction or aggregation at the switch. When decryption is bypassed, the encrypted transaction may traverse the switch core through the forwarding path without the circuit performing any cryptographic operations on the transaction data, and the transaction may be forwarded to the destination port determined by a destination accelerator identifier carried in the transaction. The circuit may utilize AES-GCM with 256-bit encryption keys and may support authentication tag verification when authentication is enabled. The circuit may be implemented in hardware as dedicated cryptographic logic, a programmable state machine, or a combination thereof. The method may be implemented in hardware, firmware, software, or combinations thereof, and may be performed by various types of devices including a switch, a processor, or a semiconductor device.

In some implementations of the switch, for incoming requests from an accelerator, the circuit is configured to determine that the encrypted transaction is the collective transaction based on the command type field indicating at least one of: a ReadReduce command, a WriteMulticast command, a WriteFullMulticast command, an AtomicNRMulticast command, a BlockCollectiveInvoke command, a BlockCollectiveAllocate command, or a BlockCollectiveDeallocate command. The ReadReduce command may perform a reduction operation across multiple accelerators, the WriteMulticast and WriteFullMulticast commands may distribute data to multiple accelerators, the AtomicNRMulticast command may perform atomic operations across multiple accelerators, and the BlockCollectiveInvoke, BlockCollectiveAllocate, and BlockCollectiveDeallocate commands may manage block collective operations at the switch.

In some implementations of the switch, for incoming responses from an accelerator, the circuit is configured to determine that the encrypted transaction is the collective transaction based on the response type information field of the incoming response indicating a collective primitive type or a block collective type. The response type information field may be a multi-bit field carried in the response header. The destination accelerator that generated the response may retain the type of the original request and set the response type information field accordingly, enabling the switch to classify the response without maintaining state tracking the original request.

In some implementations of the switch, the response type information field indicates the collective primitive type when the incoming response corresponds to a ReadReduce command, a WriteMulticast command, a WriteFullMulticast command, or an AtomicNRMulticast command, and indicates the block collective type when the incoming response corresponds to a BlockRead command or a BlockWriteFull command. The collective primitive type may correspond to responses generated by destination accelerators in reply to collective primitive commands that the switch replicated to each participating accelerator. The block collective type may correspond to responses generated in reply to commands issued by the switch on behalf of a block collective operation.

In some implementations, the switch further comprises a second circuit configured to perform a reduction operation on decrypted transaction data from the collective transaction; wherein after the reduction operation, the circuit is configured to re-encrypt reduced data using encryption keys for a switch-to-accelerator direction before sending the reduced data to a requesting accelerator. The second circuit may perform arithmetic or logical reduction operations, such as summation, maximum, minimum, or bitwise operations, on data received from multiple accelerators. The encryption keys for the switch-to-accelerator direction may be derived from master keys programmed by trusted software and may be different from the encryption keys for the accelerator-to-switch direction on the same link. The requesting accelerator may identify the response as switch-originated based on a command type field or a response type information field, and may select the appropriate switch-to-accelerator decryption keys.

In some implementations of the switch, the switch simultaneously serves a plurality of virtual partitions, a first virtual partition of the plurality of virtual partitions having collective security enabled wherein the switch is within a trusted computing base of the first virtual partition, and a second virtual partition of the plurality of virtual partitions not having collective security enabled wherein the switch is outside a trusted computing base of the second virtual partition, with cryptographic isolation between the first virtual partition and the second virtual partition. The cryptographic isolation may be provided by separate sets of encryption keys for each virtual partition, derived from different master keys programmed by different tenants. Traffic belonging to one virtual partition may not be decryptable using the keys of another virtual partition. The switch may maintain per-virtual-partition configuration indicating whether collective security is enabled, and may apply the appropriate cryptographic processing policy for each incoming transaction based on the virtual partition membership of the source accelerator. In some examples, a virtual partition refers to a virtual pod.

In some implementations of the switch, the circuit comprises at least one port encryption engine, each port encryption engine comprising at least one key association and encryption and decryption capability. The port encryption engine may maintain key associations that bind an encryption key, an initialization vector or counter, and other cryptographic parameters to a specific link direction and stream. The encryption and decryption capability may support AES-GCM at line rate.

In some implementations of the switch, after decrypting the collective transaction data and performing the reduction operation, the second circuit is configured to recalculate a data integrity check on the reduced data before the circuit re-encrypts the reduced data. The data integrity check may include a cyclic redundancy check or other error detection code computed over the reduced data payload. Recalculating the data integrity check may provide end-to-end data integrity protection across the decrypt-reduce-re-encrypt pipeline, allowing the requesting accelerator to verify that the reduced data was not corrupted during processing at the switch.

In some implementations of the switch, the circuit is configured to, for the collective transaction, verify an authentication tag accompanying the encrypted transaction, and to drop the encrypted transaction and signal an integrity failure when verification of the authentication tag fails. The authentication tag may be carried in a dedicated portion of a transaction layer flit accompanying the encrypted transaction data. Verification of the authentication tag may confirm both the integrity and authenticity of the encrypted transaction data using the same AES-GCM computation that produces the decrypted output. Signaling the integrity failure may include notifying a security manager on the switch, which may take corrective action such as transitioning the affected virtual partition to a stop state.

In some implementations of the switch, the circuit is further configured to determine whether the encrypted transaction is the collective transaction or the unicast transaction based on a virtual channel identifier of the encrypted transaction, wherein collective transactions are assigned to a first virtual channel and unicast transactions are assigned to a second virtual channel. When virtual channel-based traffic classification is deployed at the switch, the virtual channel identifier may provide a rapid classification signal for the circuit to determine the cryptographic processing mode. The virtual channel identifier may be inspected without decoding the full command type field, potentially reducing the classification latency. The virtual channel assignment may be determined by the source accelerator or by a traffic classification function at the switch ingress.

FIG. 13B illustrates a method for selectively processing encrypted transactions at a switch in an accelerator network, comprising classifying each incoming encrypted transaction as a collective transaction or a unicast transaction, and applying different cryptographic processing accordingly. The method may decrypt collective transaction data to enable in-network processing such as arithmetic reduction, while forwarding unicast transactions through the switch without decryption to maintain end-to-end encryption between the source and destination accelerators. By performing this per-transaction classification and selective decryption at the switch ingress, the method may enable the switch to participate in collective computations while preserving data confidentiality for unicast traffic.

In various implementations, a method comprising: receiving, at a switch in an Ultra Accelerator Link (UALink)-based network, an encrypted transaction from an accelerator via a UALink-based link; determining whether the encrypted transaction is a collective transaction or a unicast transaction, based on at least one of: a command type field of the encrypted transaction, or a response type information field of the encrypted transaction; when the encrypted transaction is the collective transaction, decrypting transaction data of the encrypted transaction; and when the encrypted transaction is the unicast transaction, forwarding the encrypted transaction through the switch without decrypting the transaction data. The determining may be performed at an ingress port of the switch upon receiving the encrypted transaction. For incoming requests from an accelerator, the command type field may identify collective commands such as ReadReduce, WriteMulticast, or BlockCollectiveInvoke, which carry data payloads that the switch may need to inspect or process. For incoming responses from an accelerator, the response type information field may indicate whether the response corresponds to a collective primitive or a block collective operation. When the encrypted transaction is the unicast transaction, the encrypted transaction may be forwarded based on a destination accelerator identifier carried in the transaction, and the transaction data may remain encrypted with accelerator-to-accelerator encryption keys that the switch does not possess. The method may be performed by a circuit at the switch that handles both the classification and the cryptographic operations.

In some implementations, the method further comprises performing a reduction operation on the decrypted transaction data; and re-encrypting reduced data using encryption keys for a switch-to-accelerator direction before sending the reduced data to a requesting accelerator. The reduction operation may combine data from multiple accelerators using arithmetic or logical operations. The encryption keys for the switch-to-accelerator direction may be different from the keys used for the accelerator-to-switch direction, providing directional key isolation on each link.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

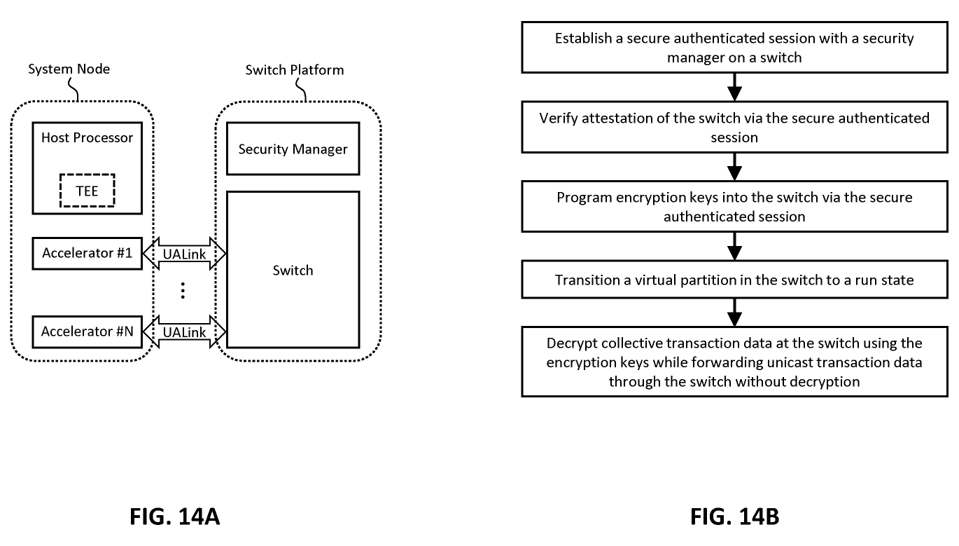

In accelerator network deployments where accelerators perform distributed workloads using collective operations, a switch may participate in collective computations by processing data as it traverses the switch. When encryption is enabled on the links between accelerators and the switch, the switch may need to decrypt collective data to perform operations such as arithmetic reduction. This requires the switch to be trusted with encryption keys and to be capable of handling unencrypted data, which may conflict with the security architecture if the switch is not within the trusted computing base. FIG. 14A illustrates a system that may provide a mechanism for trusted software on a host processor to selectively elevate the switch into the trusted computing base for collective operations of a specific virtual partition. The trusted software may establish a secure authenticated session with a security manager on the switch, verify the switch's attestation to confirm its identity and integrity, program collective encryption keys into the switch, and transition a virtual partition in the switch to a run state. During the run state, the switch may decrypt collective transaction data using the programmed encryption keys while forwarding unicast transaction data without decryption, maintaining end-to-end encryption for non-collective traffic. The security manager may manage the security lifecycle of the virtual partition through a state machine, and may respond to security events such as integrity failures by transitioning the virtual partition to a stop state. This approach may enable the switch to participate in collective computations for tenants that require in-network collective operations, while remaining outside the trusted computing base for tenants that do not, within the same physical switch hardware.

In various implementations, a system comprising: a plurality of accelerators; a switch for an Ultra Accelerator Link (UALink)-based network, the switch coupled to the plurality of accelerators via UALink-based links, the switch comprising a security manager; a host processor configured to execute trusted software; wherein the trusted software is configured to: establish a secure authenticated session with the security manager of the switch; verify attestation of the switch via the secure authenticated session; program encryption keys into the switch via the secure authenticated session; and transition a virtual partition in the switch to a run state; wherein during the run state, the switch is configured to decrypt collective transaction data using the encryption keys and forward unicast transaction data without decryption. The trusted software may be a trusted virtual machine (TVM) executing within a trusted execution environment (TEE) on the host processor, or may be other software executing in a secure context with access to cryptographic credentials. The security manager on the switch may be a firmware component that manages security policies for the switch and exposes an interface for trusted software to establish sessions, verify attestation, program keys, and control the security state of virtual partitions. The secure authenticated session may utilize cryptographic protocols to protect the confidentiality and integrity of communications between the trusted software and the security manager, preventing eavesdropping or tampering by the infrastructure provider or other untrusted entities. The secure authenticated session between the trusted software and the security manager may be established over a network connection between the system node hosting the host processor and the switch platform hosting the switch, such as a front end network used by operating system domains to establish tenant trusted computing bases, or a management network interface on the switch platform. The network connection for the secure authenticated session may be separate from the UALink-based links that carry collective and unicast transaction data between the accelerators and the switch. The attestation verification may confirm that the switch hardware and firmware have not been tampered with and are running authorized code, providing assurance that the switch is trustworthy before programming it with encryption keys. The encryption keys programmed into the switch may be collective master keys from which stream keys are derived for encrypting and decrypting collective traffic on each link. During the run state, the switch may utilize a circuit to determine whether each incoming transaction is a collective transaction or a unicast transaction, decrypting collective transaction data for in-network processing such as reduction, and forwarding unicast transaction data in encrypted form to preserve end-to-end confidentiality between accelerators. The system may support multiple virtual partitions simultaneously, with independent security configurations for each virtual partition.

In some implementations of the system, the secure authenticated session utilizes Security Protocol and Data Model (SPDM), and wherein the trusted software is configured to verify an attestation report from the switch via the SPDM session. The SPDM session may provide mutual authentication between the trusted software and the security manager, and may establish a secure channel for subsequent key programming and state transition operations. The attestation report may include measurements of the switch firmware and hardware configuration.

In some implementations of the system, the security manager is configured to manage the virtual partition according to a state machine comprising a locked state, the run state, and a stop state; wherein the trusted software is configured to transition the virtual partition from the locked state to the run state after verifying configuration of the switch; and wherein the security manager is configured to transition the virtual partition to the stop state upon detecting an integrity failure. In the locked state, the security manager may prevent traffic processing for the virtual partition while allowing the trusted software to read and verify the switch configuration, including routing table entries, security settings, and port assignments. In the stop state, the security manager may halt all incoming and outgoing traffic for members of the affected virtual partition and may report the security event to a centralized controller via the management network.

In some implementations of the system, both end-to-end link protection between accelerators and link protection between each accelerator and the switch are configured before the plurality of accelerators enter a workload execution state, and wherein link protection between an accelerator and the switch is not enabled after the accelerator is in the workload execution state. This ordering constraint may prevent a condition where workload data flows on unprotected accelerator-to-switch links before encryption is established. The trusted software may program both accelerator-to-accelerator and accelerator-to-switch encryption keys and may verify that all links are protected before transitioning the accelerators and the virtual partition to the workload execution state.

In some implementations of the system, before transitioning the virtual partition to the run state, the trusted software is configured to verify that switch identifiers and port numbers associated with the virtual partition are unique, that forwarding entries in the switch match an expected neighbor topology, and that security settings of the switch are correctly configured. The topology verification may detect scenarios where a compromised switch presents incorrect identifiers or routing entries, which could misdirect collective traffic to unauthorized accelerators. The trusted software may compare the switch-reported topology information against an expected topology provided by a centralized controller or by the tenant's workload configuration.

In some implementations of the system, the security manager is further configured to lock a group table of the switch during transition of the virtual partition to the run state, the group table comprising entries that map collective group identifiers to participating accelerators; and wherein the group table is not modifiable during the run state without re-authorization by the trusted software. The group table may associate each collective group identifier with a list of participating accelerator identifiers and routing information used to replicate collective commands to the participating accelerators. Locking the group table may prevent modifications to collective group membership that could compromise the integrity of in-network collective operations during a secure workload.

In some implementations of the system, a requesting accelerator of the plurality of accelerators that receives a response from the switch is configured to determine, based on a command type field of the response, whether the response was encrypted using switch-to-accelerator encryption keys, and to select corresponding decryption keys for authenticating and decrypting the response. The command type field of the response may indicate switch-originated collective commands, such as block read or block write commands issued by the switch on behalf of a block collective operation. The requesting accelerator may maintain both accelerator-to-accelerator decryption keys and switch-to-accelerator decryption keys, and may select the appropriate key set based on the command type field of each incoming response.

In some implementations of the system, the security manager is a UALink-based switch security manager. The UALink-based switch security manager may be a firmware component specifically designed for UALink switch platforms, providing security management functions for virtual partitions within the UALink-based network.

In some implementations of the system, collective security is enabled on a per-virtual-partition basis, and wherein a first virtual partition of the switch has collective security enabled and a second virtual partition of the switch does not have collective security enabled. Per-virtual-partition enablement may allow tenants that use collective operations to opt into the elevated trust model for the switch, while tenants that only use unicast operations may operate with the switch outside the trusted computing base. The security configuration for each virtual partition may be independent of other virtual partitions.

In some implementations of the system, upon detection of an integrity failure on a link between an accelerator and the switch, the detecting device is configured to drop a failing transaction, stop processing new transactions from a source of the failing transaction, and stop sending transactions to a neighbor on the link, without affecting other links of the switch. The per-link isolation may contain the impact of a compromised or faulty link to the affected accelerator-switch pair, allowing other links to continue operating normally. The detecting device may notify the security manager, which may in turn notify a centralized controller via the management network for further action.

In some implementations of the system, each accelerator of the plurality of accelerators comprises a device security manager, and wherein the trusted software is further configured to establish a security session with each device security manager to program accelerator-side encryption keys. The device security manager on each accelerator may manage the accelerator's encryption keys, attestation state, and security policies. The trusted software may program both the accelerator-to-accelerator encryption keys and the accelerator-to-switch encryption keys via the device security manager on each accelerator.

In some implementations of the system, the trusted software is further configured to establish a security session with each accelerator of the plurality of accelerators via a device interface security protocol of a second interconnect protocol, wherein the secure authenticated session with the security manager of the switch and the security sessions with the plurality of accelerators collectively establish a trusted computing base for collective operations spanning both the UALink-based network and an interface based on the second interconnect protocol. The second interconnect protocol may be based on Compute Express Link (CXL) or Peripheral Component Interconnect Express (PCIe), and the device interface security protocol may provide session establishment, attestation, and key programming functions for the accelerators on the host-side interface. The trusted software may coordinate the timing of key programming and state transitions across both the UALink-based and the second interconnect protocol interfaces to provide a unified security lifecycle for the workload.

FIG. 14B illustrates a method for selectively elevating a switch into a trusted computing base that may enable trusted software to establish a secure session with a security manager on the switch, verify the switch's attestation, program encryption keys, and transition a virtual partition to a run state in which the switch decrypts collective transaction data while forwarding unicast transaction data without decryption. This method may enable per-workload, per-tenant trust elevation of specific switches in the accelerator network, without requiring all switches in the network to be trusted for all tenants.

In various implementations, a method comprising: establishing, by trusted software on a host processor, a secure authenticated session with a security manager on a switch in an Ultra Accelerator Link (UALink)-based network, the switch coupled to a plurality of accelerators via UALink-based links; verifying attestation of the switch via the secure authenticated session; programming encryption keys into the switch via the secure authenticated session; transitioning a virtual partition in the switch to a run state; and during the run state, decrypting collective transaction data at the switch using the encryption keys while forwarding unicast transaction data through the switch without decryption. The trusted software may be a lead trusted virtual machine that orchestrates the trust elevation across all switches participating in a virtual partition. In some examples, the virtual partition refers to a virtual pod. The method may be performed sequentially for each switch in the virtual partition, with the trusted software establishing independent SPDM sessions with each switch, distributing identical collective master keys to all switches, and coordinating the transition to the run state. The attestation verification may confirm the identity and integrity of each switch before the trusted software programs encryption keys, assuring that the verified switches receive the collective master keys. The encryption keys may be collective master keys from which stream keys are derived using a key derivation function. The decrypting of collective transaction data may enable the switch to perform in-network processing such as arithmetic reduction on the collective data. The forwarding of unicast transaction data without decryption may preserve end-to-end encryption between accelerators for non-collective traffic.

In some implementations, the method further comprises upon detecting an integrity failure at a port of the switch, transitioning the virtual partition to a stop state, and stopping processing of incoming and outgoing transactions for members of the virtual partition. The integrity failure may be detected by verifying an authentication tag on an incoming encrypted transaction. Transitioning to the stop state may halt all collective and unicast traffic processing for the affected virtual partition, containing the security event. The security manager may report the integrity failure to the trusted software or to a centralized controller for further action. In some implementations of the method, a non-transitory computer-readable medium comprising instructions which, when executed by a processor, cause the processor to perform the method.

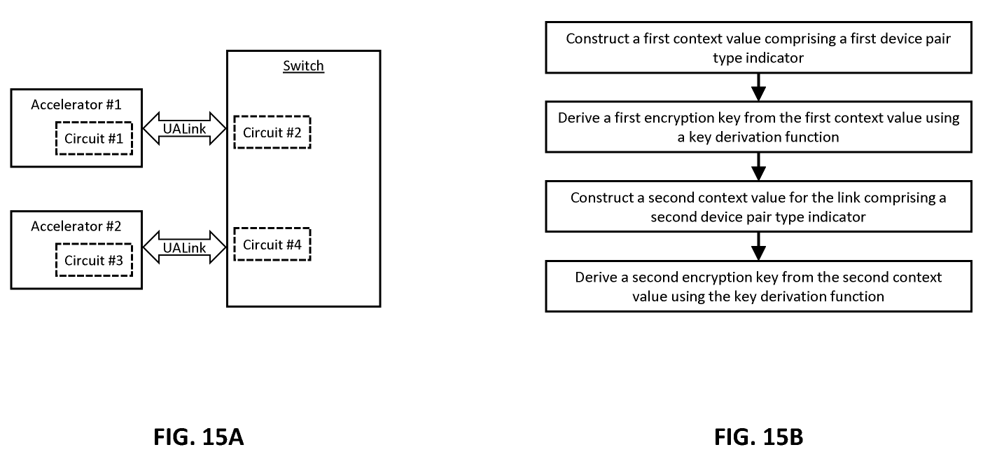

FIG. 15A illustrates an accelerator network architecture where accelerators are coupled to switches via encrypted links, and encryption keys may be derived from master keys using a key derivation function (KDF) that takes a context value as input. The context value may bind the derived keys to specific link parameters, producing unique keys for each link. When a link connects an accelerator to a switch, the two directions of traffic on the link (accelerator-to-switch and switch-to-accelerator) may use different encryption keys to provide directional key isolation. A device pair type field in the context value may differentiate the two directions, with a first value assigned to the accelerator-to-switch direction and a second, different value assigned to the switch-to-accelerator direction. Because the context values for the two directions differ in at least the device pair type field, the derived keys are mathematically distinct, preventing a compromised key for one direction from being used to decrypt or forge traffic in the opposite direction. The context value may further comprise device identifiers, port numbers, virtual channel identifiers, and epoch counters to bind the derived keys to specific link segments and to support periodic key rotation. Initialization vectors (IVs) for authenticated encryption may embed the device pair type field in a fixed portion, producing disjoint IV spaces for the two directions and preventing IV collisions even when monotonic counter values overlap across directions.

In various implementations, a system comprising: a plurality of accelerators coupled to a switch via an Ultra Accelerator Link (UALink)-based links in a UALink network; a circuit configured to derive encryption keys using a key derivation function with a context value as input; wherein the context value for a link between an accelerator of the plurality of accelerators and the switch comprises a device pair type field; wherein the device pair type field has a first value for an accelerator-to-switch direction and a second value different from the first value for a switch-to-accelerator direction; and wherein encryption keys derived for the accelerator-to-switch direction and encryption keys derived for the switch-to-accelerator direction on the same link are different. The circuit may be implemented at both endpoints of the link: the accelerator may include a circuit instance that derives encryption keys for the accelerator-to-switch direction (transmit keys) and for the switch-to-accelerator direction (receive keys), and the switch may include a circuit instance that derives the corresponding keys for its own transmit and receive directions. Both endpoints derive the same keys from the same context values and master keys, ensuring that the transmit key at one endpoint matches the receive key at the other endpoint. The key derivation function may be a pseudorandom function such as KMAC256, and the master keys may be programmed by trusted software via secure sessions. The device pair type field may be a multi-bit field whose values are assigned by convention, with distinct values for the accelerator-to-switch and switch-to-accelerator directions. For links between two accelerators (as opposed to links between an accelerator and a switch), the context value may not include the device pair type field, as both endpoints are of the same device type and no directional differentiation based on device type is needed. The system may be implemented in hardware, firmware, software, or combinations thereof.

In some implementations of the system, the context value further comprises a source device identifier, a destination device identifier, a source port number, a virtual channel identifier, and an epoch counter. The source device identifier and destination device identifier may be accelerator identifiers or switch identifiers, depending on the direction. The source port number may identify the port of the transmitting device. The virtual channel identifier may associate the derived key with a specific virtual channel on the link. The epoch counter may be incremented with each key derivation to produce a unique key for each epoch.

In some implementations of the system, the context value for the accelerator-to-switch direction comprises the accelerator's port number as the source port number and the switch's identifier as the destination device identifier, and the context value for the switch-to-accelerator direction comprises the switch's port number as the source port number and the accelerator's identifier as the destination device identifier. The asymmetric source port arrangement may provide an additional dimension of key differentiation beyond the device pair type field. Even when the device pair type values are the same, the swapped source port numbers and device identifiers may produce different KDF inputs, further isolating the keys for each direction.

In some implementations, the system further comprises an initialization vector for each direction of the link, the initialization vector comprising a fixed field embedding the device pair type field, a source device identifier, a destination device identifier, and a source port number; wherein initialization vectors for the accelerator-to-switch direction and initialization vectors for the switch-to-accelerator direction on the same link are disjoint. The initialization vector may include a fixed field and an invocation field. The fixed field may embed the device pair type, source identifier, destination identifier, source port, stream identifier, and virtual channel identifier. The invocation field may include a monotonic counter that increments with each encrypted transaction. Because the fixed fields differ between the two directions (due to the device pair type and the swapped identifiers and port numbers), the IV spaces are disjoint regardless of the counter values.

In some implementations of the system, each port of the switch has a single receive key because each port of the switch is coupled to a single accelerator port via a single UALink-based link. The single receive key per switch port may simplify the key selection logic at the switch ingress, as the switch does not need to look up which key to use for decryption. The receive key may be derived from the context value for the accelerator-to-switch direction on the connected link.

In some implementations of the system, derived encryption keys for different links between the switch and different accelerators of the plurality of accelerators are different, wherein the source port number, the source device identifier, and the destination device identifier in the context value for each link are different. The per-link key uniqueness may prevent a compromised key on one link from being used to decrypt traffic on another link, even when the same switch is an endpoint of both links. The different port numbers and device identifiers in the context values may produce mathematically independent derived keys.

In some implementations of the system, the epoch counter is incremented with each key derivation; and wherein when a cumulative count of key derivations across streams on the link reaches a threshold, a master key swap is performed using an alternate master key. The two-level key hierarchy may provide forward secrecy by limiting the number of transactions protected by any single set of derived keys. The alternate master key may be pre-programmed by trusted software alongside the primary master key, enabling the master key swap to occur without additional communication with the trusted software.

In some implementations of the system, the key derivation function comprises KMAC256 as specified in NIST SP 800-108, with the context value provided as a customization input. KMAC256 may provide a keyed hash function that derives pseudorandom output from a master key and a customization input. The context value may serve as the customization input, binding the derived key to the specific link parameters encoded in the context value.

In some implementations of the system, the first value of the device pair type field is binary 01 for the accelerator-to-switch direction, and the second value is binary 10 for the switch-to-accelerator direction; and wherein a context value for a link between two accelerators of the plurality of accelerators does not include the device pair type field. The binary encodings may provide a compact two-bit representation that fits within the context value format. For links between two accelerators, the absence of the device pair type field may result in a shorter context value, as both endpoints are of the same device type and directional differentiation based on device type is not applicable.

In some implementations of the system, the circuit is configured to derive encryption keys independently for each stream on the link, wherein the streams comprise at least a request stream and a response stream. In an ordered mode, the streams may include a request stream carrying requests and associated data, a read response stream carrying read responses and associated data, and a write response stream carrying write responses. In an unordered mode, the streams may include a request stream and a response stream. Each stream may have its own epoch counter and derived key, and key derivation for each stream may be triggered independently.

In some implementations of the system, the switch maintains, for each virtual partition served by the switch, an independent set of derived encryption keys for links between the switch and accelerators in the virtual partition, with cryptographic isolation between virtual partitions. The independent key sets may be derived from different master keys programmed by different tenants via independent secure sessions. The switch may index the key sets by virtual partition membership of the connected accelerator, selecting the appropriate key material for each incoming and outgoing transaction. In some examples, a virtual partition refers to a virtual pod.

FIG. 15B illustrates a method for deriving directionally unique encryption keys, which may construct separate context values for each direction of a link between an accelerator and a switch, with a device pair type indicator distinguishing the two directions. By deriving encryption keys independently for each direction using different context values, the method may produce mathematically distinct keys that provide directional key isolation on the link.

In various implementations, a method comprising: constructing, for a link between an accelerator and a switch in an Ultra Accelerator Link (UALink)-based network coupled via a UALink-based link, a first context value comprising a first device pair type indicator; deriving a first encryption key from the first context value using a key derivation function, the first encryption key for encrypting traffic from the accelerator to the switch; constructing a second context value for the link comprising a second device pair type indicator different from the first device pair type indicator; and deriving a second encryption key from the second context value using the key derivation function, the second encryption key for encrypting traffic from the switch to the accelerator. The constructing of the first context value may further comprise including the accelerator's identifier as the source device identifier, the switch's identifier as the destination device identifier, and the accelerator's port number as the source port number. The constructing of the second context value may further comprise including the switch's identifier as the source device identifier, the accelerator's identifier as the destination device identifier, and the switch's port number as the source port number. The method may be performed by a key management component at either endpoint, or by trusted software that programs both endpoints with the derived keys. Both endpoints may independently derive the same keys from the same master keys and context values, and may begin using the new keys from the first transaction of a new epoch.

In some implementations, the method further comprises constructing a first initialization vector for the accelerator-to-switch direction and a second initialization vector for the switch-to-accelerator direction, each initialization vector embedding the respective device pair type indicator in a fixed field; wherein the first initialization vector and the second initialization vector on the same link are disjoint. The fixed field of each initialization vector may further embed the source identifier, destination identifier, source port number, stream identifier, and virtual channel identifier for the respective direction. The invocation field of each initialization vector may include a monotonic counter.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

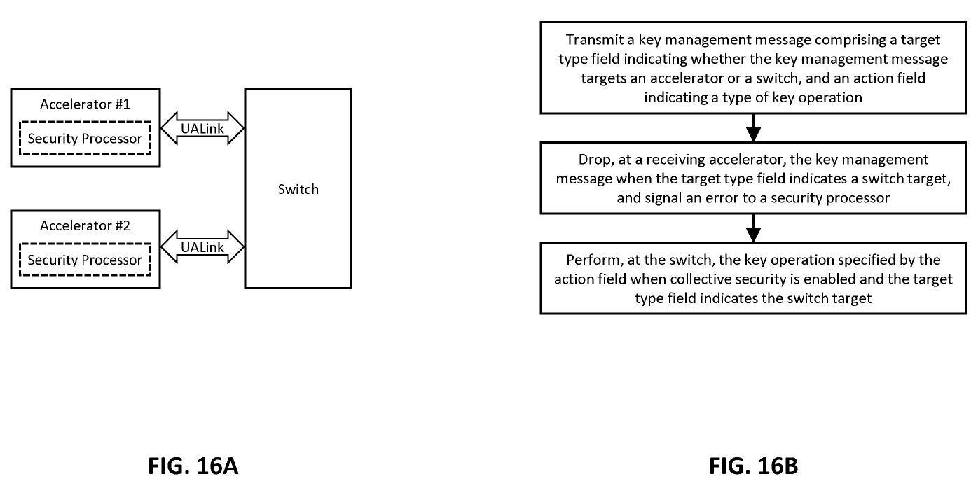

FIG. 16A illustrates a system wherein both accelerator-to-accelerator and accelerator-to-switch links are encrypted, and key management operations may need to target specific device types. A key management message transmitted across the network may carry a target type field indicating whether the key operation is intended for an accelerator endpoint or a switch endpoint, and an action field indicating the type of key operation (such as key derivation or key derivation followed by key swap). When an accelerator receives a key management message with the target type field indicating a switch target, the accelerator may treat this as a misrouted or potentially malicious message, drop it, and signal an error to a security processor. This hardware enforcement may prevent an attacker from using switch-targeted key management messages to disrupt the cryptographic state of an accelerator. Conversely, when a switch with collective security enabled receives a key management message with the target type field indicating a switch target, the switch may perform the specified key operation. A switch that does not support collective operations or does not have collective security enabled may forward the message without processing the key operation. The key management message may be a specific type of protocol-level write message, and the target type and action fields may occupy designated bits within the message's attribute field. The key lifecycle for accelerator-to-accelerator encryption may operate independently of the key lifecycle for accelerator-to-switch encryption, allowing different rotation frequencies for unicast and collective traffic.

In various implementations, a system comprising: a plurality of accelerators coupled to a switch via Ultra Accelerator Link (UALink)-based links in a UALink-based network; a key management message format comprising a target type field indicating whether a key operation targets an accelerator or the switch, and an action field indicating a type of key operation; wherein each accelerator of the plurality of accelerators is configured to, upon receiving a key management message with the target type field indicating a switch target, drop the key management message and signal an error to a security processor; and wherein the switch, when collective security is enabled, is configured to, upon receiving the key management message with the target type field indicating the switch target, perform the key operation specified by the action field. The key management message format may define the target type field and the action field as subfields within a request attribute field of the message. The target type field may indicate whether the intended recipient is an accelerator endpoint or a switch endpoint that participates in collective operations with encryption enabled. The action field may specify whether the key operation is a key derivation only (deriving a new stream key from the current master key) or a key derivation followed by a key swap (deriving a new stream key and then transitioning to the alternate master key). When an accelerator receives a key management message whose target type field indicates a switch target, the accelerator may treat this as a security-relevant event because switch-targeted messages should not reach accelerator endpoints under normal operation. Dropping the message and signaling an error to a security processor may enable security monitoring software to detect potential key management attacks. When the switch processes the key management message, the switch may derive a new stream key from the current or alternate master key according to the action field, and may begin using the new key from the first transaction of a new epoch. The system may be implemented in hardware, firmware, software, or combinations thereof.

In some implementations of the system, the target type field occupies a first bit of a request attribute field of the key management message, and the action field occupies a second bit of the request attribute field; wherein the second bit equal to a first value indicates key derivation only, and the second bit equal to a second value indicates key derivation followed by key swap. The first bit and the second bit may occupy the two least significant bits of the request attribute field. The request attribute field may be a multi-bit field carried in the message header alongside other request attributes.

In some implementations of the system, the switch, when collective security is not enabled or when the switch does not support collective operations, is configured to forward the key management message to a destination identified in a destination identifier field of the key management message without performing the key operation. The forwarding behavior may enable backward compatibility with switches that do not support in-network collective operations. The switch may route the key management message to the destination accelerator based on the destination accelerator identifier, treating the message as any other transaction to be forwarded.

In some implementations of the system, a key lifecycle for accelerator-to-accelerator encryption is independent of a key lifecycle for accelerator-to-switch encryption, wherein the key management message with the target type field indicating an accelerator target manages the key lifecycle for accelerator-to-accelerator encryption, and the key management message with the target type field indicating the switch target manages the key lifecycle for accelerator-to-switch encryption. The independent key lifecycles may allow different key rotation frequencies for unicast and collective traffic. Collective traffic processed at the switch may warrant more frequent key rotation due to the higher volume of data decrypted at the switch, while unicast traffic encrypted end-to-end between accelerators may use a different rotation schedule.

In some implementations of the system, the key management message comprises a UPLI Write Message carrying one beat of data, and wherein a request metadata field of the UPLI Write Message identifies the key management message. The UPLI Write Message may be a predefined message type within the protocol level interface. The one beat of data may carry null data, as the key management information is encoded in the message header fields rather than in the data payload. The request metadata field may distinguish key management messages from other types of protocol-level write messages.

In some implementations of the system, the request metadata field has a first value for key management of a request stream, a second value for key management of a read response stream, and a third value for key management of a write response stream. The per-stream key management may enable independent key rotation schedules for each stream. The request metadata field values may correspond to predefined protocol-level write message types, each triggering key derivation for the associated encryption stream on the link.

In some implementations of the system, trusted software on a host processor is configured to generate collective master keys and distribute the collective master keys to each accelerator and the switch in a virtual partition via independent secure sessions, wherein all devices in the virtual partition derive identical stream keys from the collective master keys. The independent secure sessions may utilize Security Protocol and Data Model (SPDM) or equivalent protocols. The trusted software may distribute the same collective master keys to all devices in the virtual partition, enabling any device to derive the same stream keys from the same context values. The independent sessions may prevent a compromised device from intercepting master keys intended for other devices.

In some implementations of the system, each accelerator and the switch are configured to pre-compute derived keys from an alternate master key before a master key swap threshold is reached, enabling instantaneous key transition upon triggering the master key swap. The pre-computation may be performed in the background during normal traffic processing, using spare cycles in the key derivation circuit. The alternate master key may be programmed by trusted software alongside the primary master key during initial key provisioning.

In some implementations of the system, key derivation for an accelerator-to-switch stream on a link is triggered before key derivation for a switch-to-accelerator stream on the same link, and wherein both an accelerator endpoint and a switch endpoint on the link switch to a new derived key starting from a first transaction of a new epoch. The ordering may provide a deterministic key transition sequence that both endpoints can follow independently. The transmitting endpoint may send the key derivation message as the first transaction of epoch zero in a new phase, and both endpoints may switch to the new derived key from the first transaction of epoch zero of the subsequent phase.

In some implementations of the system, the switch maintains independent key material for each virtual partition served by the switch, and wherein the key management message affects the key material associated with a virtual partition of the accelerator that transmitted the key management message. The per-virtual-partition key isolation may prevent a key management message from one tenant from affecting the encryption keys of another tenant's traffic. The switch may determine the virtual partition association of a key management message based on the source accelerator identifier or the ingress port on which the message was received.

In some implementations of the system, trusted software on a host processor is configured to coordinate key programming for both the UALink-based network via the key management message and for a second interconnect protocol via a device interface security protocol, establishing a unified key management domain across both the UALink-based network and an interface based on the second interconnect protocol. The second interconnect protocol may be based on Compute Express Link (CXL) or Peripheral Component Interconnect Express (PCIe), and the device interface security protocol may provide key programming and session establishment functions for the accelerators on the host-side interface. The trusted software may coordinate the timing of key provisioning across both protocols to provide a consistent security posture for the workload.

FIG. 16B illustrates a method for managing encryption keys in an accelerator network, which may transmit key management messages with a target type field that directs each message to the appropriate device type. The method may provide hardware enforcement at the receiving accelerator, which drops and signals an error for messages targeting a switch, and at the switch, which performs the key operation when collective security is enabled and the message targets the switch. This targeted approach may enable independent key lifecycle management for accelerator-to-accelerator and accelerator-to-switch encryption.

In various implementations, a method comprising: transmitting, via an Ultra Accelerator Link (UALink)-based link in a UALink-based network, a key management message comprising a target type field indicating whether the key management message targets an accelerator or a switch, and an action field indicating a type of key operation; at a receiving accelerator, when the target type field indicates a switch target, dropping the key management message and signaling an error to a security processor; and at the switch, when collective security is enabled and the target type field indicates the switch target, performing the key operation specified by the action field. The transmitting may be performed by an accelerator or by the switch, depending on which endpoint initiates the key roll operation. The key management message may traverse the network like any other transaction, using the destination identifier for routing. At the receiving accelerator, the hardware may inspect the target type field before any key processing occurs, and may drop the message and raise an error event if the target type indicates a switch target. At the switch, the hardware may first verify that collective security is enabled for the virtual partition associated with the source accelerator before processing the key operation. The key operation may include deriving a new stream key from the current master key, or deriving a new stream key and transitioning to the alternate master key, depending on the action field.

In some implementations, the method further comprises managing a key lifecycle for accelerator-to-accelerator encryption independently of a key lifecycle for accelerator-to-switch encryption, wherein the key management message with the target type field indicating an accelerator target manages the key lifecycle for accelerator-to-accelerator encryption, and the key management message with the target type field indicating the switch target manages the key lifecycle for accelerator-to-switch encryption. The independent management may allow the key rotation frequency for collective traffic to differ from the key rotation frequency for unicast traffic, adapting to the different security requirements and traffic volumes of each domain. In some implementations of the method, a non-transitory computer-readable medium comprising instructions which, when executed by a processor, cause the processor to perform the method.

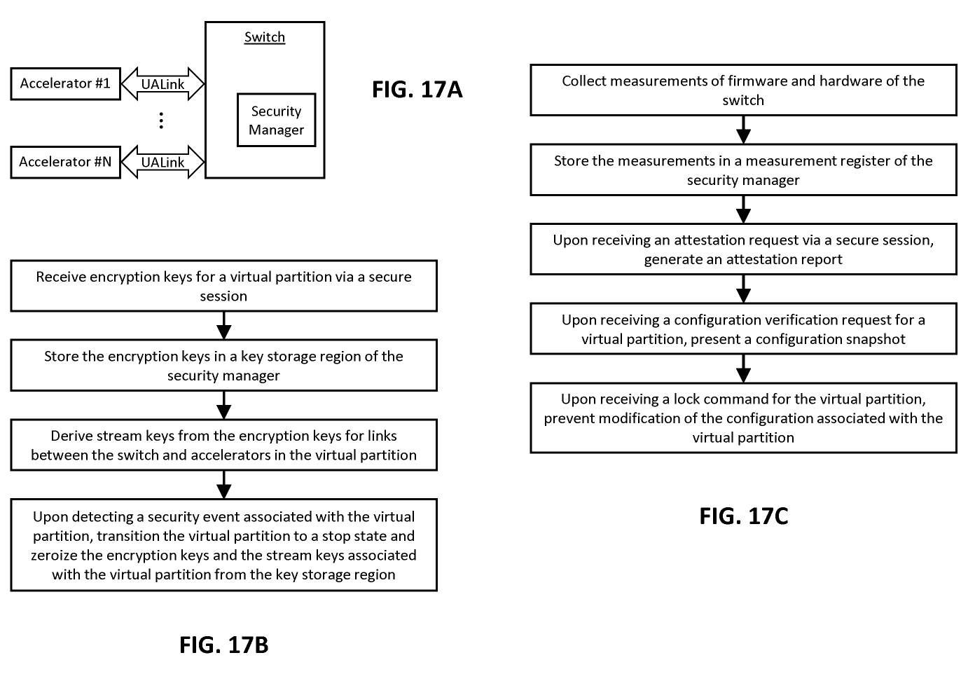

FIG. 17A illustrates a switch that participates in encrypted collective operations for multiple tenants. The switch comprises a security manager that may store encryption keys for each virtual partition it serves. The keys may include master keys programmed by trusted software and derived stream keys computed locally by the security manager. To prevent the infrastructure provider's firmware from accessing tenant keys, and to prevent one tenant's keys from being exposed to another tenant, the key storage region within the security manager may be isolated from firmware executing elsewhere on the switch and may enforce per-partition access boundaries. When a virtual partition transitions to a stop state, whether due to a security event such as an integrity failure or due to a graceful teardown initiated by trusted software, the security manager may automatically zeroize all key material associated with that partition from the key storage region, preventing key recovery after the partition is no longer active. The key storage region may be implemented using hardware-isolated memory, volatile-only storage, or a combination of isolation mechanisms that prevent unauthorized access. The security manager may further support pre-computed alternate keys for fast key rotation, per-port key associations for directing port encryption engines to the correct partition keys, and audit logging of key management operations.

In various implementations, a switch for an Ultra Accelerator Link (UALink)-based network, comprising: a plurality of ports, each port coupled to an accelerator via a UALink-based link; a security manager comprising a key storage region isolated from firmware executing on the switch outside the security manager; wherein the key storage region stores, for each virtual partition of a plurality of virtual partitions managed by the security manager, a set of encryption keys associated with the virtual partition; wherein encryption keys associated with a first virtual partition of the plurality of virtual partitions are not accessible to a second virtual partition of the plurality of virtual partitions; and wherein upon transition of a virtual partition to a stop state, the security manager zeroizes the set of encryption keys associated with the virtual partition from the key storage region. The key storage region may be a dedicated memory area within the security manager that is architecturally separated from the general-purpose memory used by switch management firmware. The isolation may be enforced by hardware access control mechanisms, by executing the security manager in a trusted execution environment, or by firmware privilege separation that restricts access to the key storage region to security manager code. The set of encryption keys may include master keys received from trusted software via a secure session, and derived stream keys computed from the master keys by the security manager using a key derivation function. Each virtual partition may have its own set of key slots within the key storage region, and the security manager may enforce that key operations (read, write, derive, zeroize) for one virtual partition cannot access key slots belonging to another virtual partition. In some examples, a virtual partition refers to a virtual pod. The zeroization may overwrite the key material with zeros or random values, and may be performed immediately upon the transition to the stop state. The stop state transition may be triggered by a security event detected at a port, by a command from trusted software, or by the security manager detecting a configuration integrity violation.

In some implementations of the switch, the key storage region is hardware-isolated from the firmware executing on the switch outside the security manager, wherein the hardware isolation prevents read or write access to the key storage region by any processor or circuit outside the security manager. The hardware isolation may be implemented using dedicated silicon, a physically separate memory region with hardware access control logic, or a memory protection unit that restricts access based on the executing security domain. The hardware isolation may provide stronger security guarantees than firmware-based isolation because it cannot be bypassed by compromised firmware.

In some implementations of the switch, for each virtual partition, the set of encryption keys comprises master keys programmed via a secure session with trusted software, and derived stream keys computed by the security manager from the master keys using a key derivation function; and wherein the master keys and the derived stream keys are stored in separate sub-regions of the key storage region for each virtual partition. The separation of master keys and derived stream keys may limit the impact of a side-channel or fault injection attack targeting the stream key sub-region, preventing the attack from reaching the master keys. The master key sub-region may have additional access restrictions, such as write-once semantics after initial programming.

In some implementations of the switch, the key storage region comprises volatile memory, and wherein the set of encryption keys is not persisted to non-volatile storage and is lost upon power loss of the switch. Volatile-only key storage may provide an inherent security boundary against physical attacks that attempt to extract keys from powered-off hardware. Upon power restoration, the security manager may require re-provisioning of master keys via new secure sessions with trusted software before any virtual partition can transition to a run state.

In some implementations of the switch, the security manager is further configured to, upon detecting a physical tamper event, zeroize all encryption keys across all virtual partitions in the key storage region. The physical tamper event may be detected by tamper sensors integrated into the switch platform, such as enclosure intrusion sensors, voltage glitch detectors, or temperature anomaly detectors. The emergency zeroization may be performed by dedicated hardware circuitry that operates independently of the security manager firmware, providing zeroization even if the firmware is compromised.

In some implementations of the switch, the key storage region further stores, for each virtual partition, a pre-computed alternate set of derived stream keys derived from an alternate master key, enabling instantaneous key transition upon a master key swap. The pre-computed alternate keys may be derived in the background during normal traffic processing, using spare cycles in the key derivation circuit. Upon triggering the master key swap, the security manager may atomically switch from the current key set to the alternate key set without computational delay.

In some implementations of the switch, the security manager maintains, for each port of the plurality of ports, an association between the port and the set of encryption keys of the virtual partition to which the port belongs, enabling a port encryption engine at the port to select encryption keys based on the association. The per-port association may be configured by the security manager when the virtual partition is created or when ports are assigned to the virtual partition. The association may be stored in a lookup table indexed by port number, providing constant-time key selection for each incoming or outgoing transaction.

In some implementations of the switch, the security manager supports a graceful teardown mode in which, upon receiving a stop command from trusted software for the virtual partition, the security manager is configured to drain in-flight transactions on ports associated with the virtual partition before zeroizing the set of encryption keys associated with the virtual partition. The graceful teardown mode may allow partially processed collective operations to complete before the keys are zeroized, preventing data corruption or lost results. The security manager may wait for in-flight transactions to drain for a configurable timeout period, after which remaining transactions are dropped and zeroization proceeds.

In some implementations of the switch, the security manager is configured to log key management operations comprising at least key programming, key derivation, key swap, and key zeroization events, each log entry comprising a timestamp and a virtual partition identifier. The audit log may be stored in a protected region of the security manager that is append-only and not modifiable by firmware outside the security manager. The audit log may be retrievable by trusted software or by a centralized controller via the management network for compliance and forensic purposes.

In some implementations of the switch, the security manager is configured to maintain concurrent secure sessions with trusted software of different tenants for different virtual partitions, with session isolation preventing a secure session for the first virtual partition from accessing the set of encryption keys or configuration of the second virtual partition. Each secure session may be bound to a specific virtual partition upon establishment. The security manager may enforce that key programming, key derivation, configuration verification, and lock commands received via a session are applied to the virtual partition associated with that session, preventing cross-partition operations.

FIG. 17B illustrates a method for managing encryption keys at a security manager of a switch, comprising receiving master keys via secure sessions, storing them in an isolated key storage region with per-partition boundaries, deriving stream keys for each link, and zeroizing all key material for a partition upon detecting a security event or receiving a teardown command. This method may provide the key lifecycle management that enables the switch to participate in encrypted collective operations for multiple tenants with cryptographic isolation and secure cleanup.

In various implementations, a method comprising: receiving, at a security manager of a switch in an Ultra Accelerator Link (UALink)-based network, encryption keys for a virtual partition via a secure session, the switch comprising a plurality of ports coupled to accelerators via UALink-based links; storing the encryption keys in a key storage region of the security manager, the key storage region isolated from firmware executing on the switch outside the security manager; deriving stream keys from the encryption keys for links between the switch and accelerators in the virtual partition; and upon detecting a security event associated with the virtual partition, transitioning the virtual partition to a stop state and zeroizing the encryption keys and the stream keys associated with the virtual partition from the key storage region. The receiving may occur via an SPDM session or equivalent secure session established between trusted software and the security manager. The storing may place the encryption keys in per-partition key slots within the key storage region, with access control preventing cross-partition access. The deriving may use a key derivation function such as KMAC256 with context values comprising device identifiers, port numbers, and epoch counters. The security event may include an integrity failure detected at a port, a configuration integrity violation, or an authentication failure on the secure session. The zeroizing may overwrite both the master keys and all derived stream keys for the affected partition. In some examples, the virtual partition refers to a virtual pod.

In some implementations, the method further comprises upon detecting a physical tamper event at the switch, zeroizing all encryption keys across all virtual partitions from the key storage region. The physical tamper event may be detected by hardware sensors integrated into the switch platform. The emergency zeroization may be prioritized over normal processing and may be performed by dedicated hardware to complete within a bounded time.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In accelerator network deployments where trusted software verifies the identity and integrity of the switch before elevating it into the trusted computing base, a security manager on the switch may generate attestation evidence and present configuration state for verification. The security manager may collect measurements of switch firmware and hardware during boot and runtime, storing these measurements in a tamper-evident measurement register. Upon receiving an attestation request via a secure session, the security manager may generate an attestation report comprising the stored measurements and a cryptographic signature produced using a device identity key. For configuration verification, the security manager may present a snapshot of the routing, collective group, and security configuration associated with a specific virtual partition, enabling trusted software to verify that the switch is correctly configured before locking the configuration. Once locked, the configuration associated with the virtual partition may not be modified through normal management interfaces, and the security manager may monitor the locked configuration for unauthorized modifications at runtime.

In various implementations, a switch for an Ultra Accelerator Link (UALink)-based network, comprising: a plurality of ports, each port coupled to an accelerator via a UALink-based link; a security manager configured to: collect measurements of firmware and hardware of the switch and store the measurements in a measurement register; upon receiving an attestation request via a secure session, generate an attestation report comprising the measurements and a signature generated using a device identity key; upon receiving a configuration verification request for a virtual partition of a plurality of virtual partitions, present a configuration snapshot comprising forwarding entries, group table entries, and security settings associated with the virtual partition; and upon receiving a lock command for the virtual partition, prevent modification of the configuration associated with the virtual partition. The security manager may collect measurements during a secure boot process, extending each firmware component measurement into the measurement register before executing that component. The measurements may include hashes of firmware images, hardware configuration registers, and security parameter settings. The device identity key may be an asymmetric private key stored in a protected region of the security manager, with a corresponding public key certificate that chains to a root of trust. The attestation report may conform to an attestation evidence format that enables the trusted software to verify the report using the public key certificate. The configuration snapshot may include the forwarding entries (mapping destination accelerator identifiers to egress ports), group table entries (mapping collective group identifiers to participating accelerators), port assignments (which ports belong to which virtual partition), and security settings (encryption mode, authentication mode, key rotation parameters) for the specified virtual partition. The lock command may set a write-protect flag for each configuration element associated with the virtual partition, causing the security manager to reject subsequent modification attempts from management interfaces. The lock may be released by a subsequent unlock command from the same secure session or by transitioning the virtual partition to a stop state.

In some implementations of the switch, the measurement register stores the measurements as a hash chain, wherein each new measurement is combined with a current value of the measurement register using a hash function to produce an updated value, and wherein the hash chain prevents modification of a previously recorded measurement without detection. The hash function may be a cryptographic hash such as SHA-256 or SHA-384. The extend operation may compute the new register value as hash(current_value || new_measurement), producing a cumulative hash that represents the entire measurement history. The initial value of the measurement register may be a known constant, such as all zeros.

In some implementations of the switch, the configuration snapshot further comprises a cryptographic hash of the forwarding entries and a cryptographic hash of the group table entries, enabling a verifier to compare the hashes against expected values without transferring the entire entries. The cryptographic hashes may be computed over the ordered set of entries, providing a compact representation that the trusted software can compare against a locally computed hash of the intended configuration. This may reduce the amount of data transferred during configuration verification for switches with many ports and many collective groups.

In some implementations of the switch, the security manager executes firmware validated by a secure boot chain anchored in a root of trust on the switch, and wherein the secure boot chain verifies a firmware signature before execution and extends firmware measurements into the measurement register. The root of trust may be a hardware component such as an embedded Root of Trust (eRoT) or an integrated Root of Trust (iRoT) on the switch platform. The secure boot chain may validate each firmware component in sequence, extending the measurement of each component into the measurement register before transferring execution to that component.

In some implementations of the switch, after receiving the lock command, the security manager is further configured to monitor the configuration associated with the virtual partition for unauthorized modifications, and upon detecting that the configuration has been modified from the configuration snapshot, transition the virtual partition to a stop state and report the unauthorized modification. The monitoring may be performed periodically by recomputing a hash of the current configuration and comparing it against the hash recorded at lock time. Unauthorized modifications may result from firmware bugs, hardware faults, or malicious firmware that bypasses the normal configuration interface. Reporting the unauthorized modification may include notifying trusted software via the secure session and notifying a centralized controller via the management network.

In some implementations of the switch, the security manager is configured to, upon a firmware update of the switch, extend new firmware measurements into the measurement register and notify active secure sessions that updated attestation evidence is available. The notification may prompt trusted software to request a new attestation report and re-verify the switch's integrity before continuing workload execution. If the updated measurements do not match the trusted software's policy, the trusted software may transition the virtual partition to a stop state.

In some implementations of the switch, the device identity key is provisioned during manufacturing of the switch and is stored in a hardware-protected region of the security manager that is not readable by firmware executing on the switch outside the security manager. The hardware-protected region may be a one-time programmable (OTP) fuse array, a physically unclonable function (PUF), or a dedicated key storage element within the security manager silicon. The device identity key may be accompanied by a certificate chain linking the key to the switch manufacturer's root certificate authority.

In some implementations of the switch, the security manager classifies security events into categories comprising at least integrity failures, key exhaustion events, and configuration tampering events; and wherein the security manager is configured to apply different response actions based on the category, wherein an integrity failure triggers transition of the affected virtual partition to the stop state, and a key exhaustion event triggers notification to trusted software without transitioning the virtual partition to the stop state. The differentiated response actions may enable the system to handle non-catastrophic security events without disrupting workload execution. A key exhaustion event may indicate that the epoch counter is approaching the master key swap threshold, prompting trusted software to initiate key rotation. A configuration tampering event may trigger the stop state if the tampering affects security-relevant configuration, or a notification if the tampering affects non-security configuration.

In some implementations of the switch, the security manager is a UALink-based switch security manager coupled to a centralized controller via an out-of-band management network, and wherein the security manager is configured to report security events and attestation status to the centralized controller. The centralized controller may aggregate security events from all switches in the pod and may coordinate responses such as workload migration, partition teardown, or firmware updates. The out-of-band management network may be separate from the UALink data-plane links, providing a secure reporting path that is independent of the encrypted data traffic.

In some implementations of the switch, the security manager is configured to manage, for each virtual partition of the plurality of virtual partitions, an independent security state comprising one of a locked state, a run state, or a stop state; and wherein a security event affecting a first virtual partition causes the security manager to transition the first virtual partition to the stop state without modifying the security state of any other virtual partition. The independent security states may enable the switch to continue serving workloads for unaffected tenants while containing the security event to the affected partition. The security manager may maintain per-partition state registers and may process security events in the context of the affected partition without acquiring locks or accessing state belonging to other partitions.

FIG. 17C illustrates a method for attestation and configuration verification at a security manager of a switch, comprising collecting firmware and hardware measurements, storing them in a tamper-evident measurement register, generating signed attestation reports upon request, presenting configuration snapshots for virtual partitions, and locking configuration to prevent unauthorized modification. The method may enable trusted software to verify the switch's identity, integrity, and configuration before elevating it into the trusted computing base for collective operations.

In various implementations, a method comprising: collecting, at a security manager of a switch in an Ultra Accelerator Link (UALink)-based network, measurements of firmware and hardware of the switch, the switch comprising a plurality of ports coupled to accelerators via UALink-based links; storing the measurements in a measurement register of the security manager; upon receiving an attestation request via a secure session, generating an attestation report comprising the measurements and a signature generated using a device identity key; upon receiving a configuration verification request for a virtual partition, presenting a configuration snapshot comprising forwarding entries, group table entries, and security settings associated with the virtual partition; and upon receiving a lock command for the virtual partition, preventing modification of the configuration associated with the virtual partition. The collecting may occur during a secure boot sequence and may continue during runtime as firmware components are loaded or updated. The storing may use a hash chain extend operation that combines each new measurement with the current register value. The generating may include signing the measurements with a device identity key using an asymmetric signature algorithm, producing a report that a verifier can validate using the corresponding public key. The presenting may include computing cryptographic hashes of the forwarding entries and group table entries for efficient verification. The preventing may set write-protect flags that cause the security manager to reject modification attempts from management interfaces during the locked state.

In some implementations, the method further comprises after preventing modification of the configuration, monitoring the configuration associated with the virtual partition for unauthorized modifications, and upon detecting an unauthorized modification, transitioning the virtual partition to a stop state. The monitoring may be performed by periodically recomputing and comparing configuration hashes. Detecting an unauthorized modification may trigger zeroization of key material associated with the affected virtual partition.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

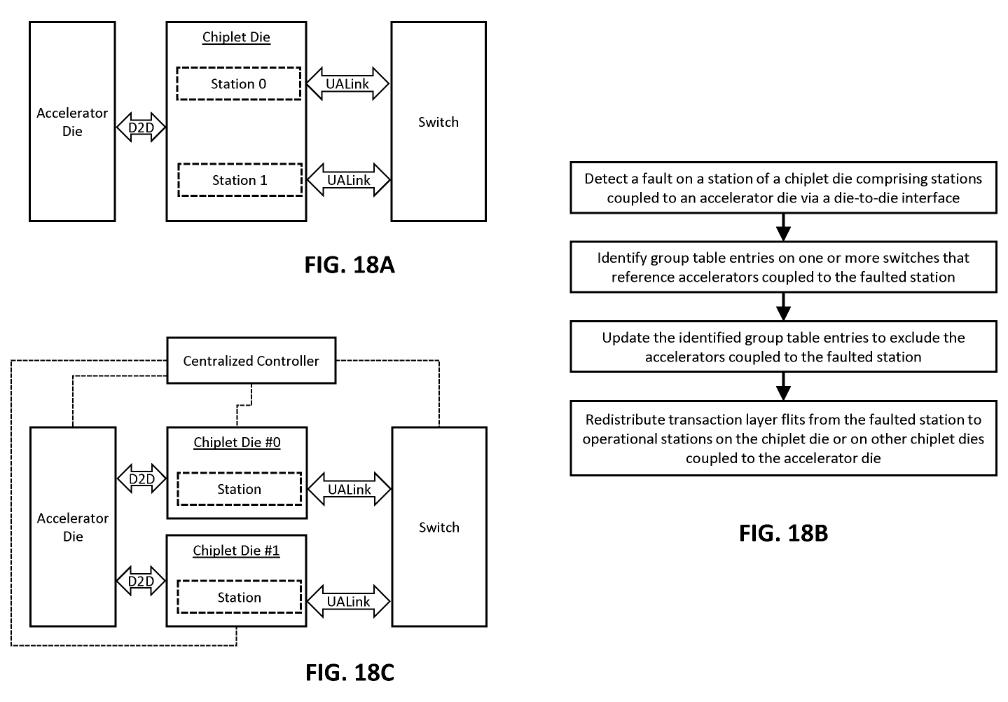

FIG. 18A illustrates a system for a UALink-based network comprising chiplet-based accelerators performing in-network collective operations via switches with group tables. When a station on a chiplet die experiences a fault, the accelerators coupled to that station may become unreachable from the network, but the group table entries on the switches may still reference those accelerators. If the group tables are not updated, collective operations involving the faulted station's accelerators may timeout waiting for responses that will never arrive, potentially triggering isolation mode on the affected switch ports. A centralized controller may detect the station fault through the management hierarchy and automatically identify and update the affected group table entries across the switches, enabling remaining accelerators in the collective group to continue collective operations with the reduced membership. This automatic propagation of chiplet-level faults to network-level group table state may prevent cascading failures in AI training workloads that rely on collective communication patterns.

In various implementations, a system for an Ultra Accelerator Link (UALink)-based network, comprising: a chiplet die comprising stations, each station comprising one or more UALink-based ports with a data link layer and a physical layer, the chiplet die coupled to an accelerator die via a die-to-die interface; one or more switches, each switch comprising a group table comprising entries, each entry comprising a valid indicator and a bitmask identifying a group of accelerators for collective operations; and a centralized controller coupled to the one or more switches and to the accelerator die via an out-of-band management interface; wherein upon detection of a fault on a station of the chiplet die, the centralized controller is configured to: identify group table entries on the one or more switches that reference accelerators coupled to the faulted station; and update the identified group table entries on the one or more switches to exclude the accelerators coupled to the faulted station. The centralized controller may maintain a mapping between stations on each chiplet die and the accelerator identifiers associated with the ports on those stations. When a station fault is reported, the centralized controller may search all active group table entries across all switches for bitmask bits corresponding to the faulted station's accelerator identifiers. The update may involve modifying the bitmask to clear the bits corresponding to the faulted accelerators, verifying consistency across switches, and reactivating the entries with the reduced membership. The system may support chiplet dies with one or more stations, each station operating independently. The centralized controller may be implemented as software executing on a dedicated management server or as firmware on a management controller.

In some implementations of the system, the fault causes the faulted station to enter a traffic drop mode, and a circuit on the chiplet die resets the data link layer and the physical layer of the faulted station without resetting other stations or the die-to-die interface. The traffic drop mode may cause the faulted station to discard all incoming and outgoing traffic, preventing corrupted data from propagating. The station reset may re-initialize the data link and physical layers of the faulted station while other stations continue processing traffic through the shared die-to-die interface.

In some implementations of the system, the centralized controller updates the identified group table entries by: clearing the valid indicator of the identified entries on each switch; modifying the bitmask to remove the accelerators coupled to the faulted station; verifying consistency of the modified entries across the one or more switches; and setting the valid indicator on each switch to reactivate the collective groups with modified membership. Clearing the valid indicator before modifying the bitmask may cause any in-flight collective request for the affected group to receive a target abort response, preventing the collective from waiting for the unreachable accelerators. Verifying consistency before reactivation may prevent switches from having different group memberships for the same group identifier.

In some implementations of the system, the chiplet die transmits a fault notification to the accelerator die via the die-to-die interface, and a management agent on the accelerator die reports the fault to the centralized controller via the out-of-band management interface, triggering the centralized controller to identify and update the group table entries. The fault notification may be delivered as a management event comprising an event identifier, a timestamp, and a severity indicator. The management agent may enrich the notification with the accelerator identifier and station identifier before reporting to the centralized controller.

In some implementations of the system, after the update, remaining accelerators in the collective group continue collective operations with the reduced membership, and the centralized controller notifies a workload management system of the modified group membership, enabling the workload management system to adjust an AI training workload. The workload management system may redistribute data partitions across the remaining accelerators or adjust the data-parallel training configuration to account for the reduced number of participants in the collective group.

In some implementations of the system, after the faulted station is reset and recovers, the centralized controller adds the accelerators coupled to the recovered station back into the group table entries on the one or more switches and verifies consistency before reactivating the modified entries. Re-admitting the recovered station's accelerators may restore the collective group to its original membership, enabling AI training to resume at full parallelism. The centralized controller may verify that the recovered station's data link and physical layers are operational before re-admission.

In some implementations of the system, the centralized controller further updates forwarding entries on the one or more switches to remove routes to the accelerators coupled to the faulted station, and verifies that remaining group table entries reference accelerators that remain routable via the updated forwarding entries. Coordinating forwarding entry and group table updates may prevent a situation where a group table entry references an accelerator for which no forwarding path exists, which would cause replicated requests to be dropped at the switch.

In some implementations of the system, when the one or more switches have outstanding block collective operations targeting accelerators coupled to the faulted station, the centralized controller triggers the switches to terminate the outstanding block collective operations and write completion status indicating failure to the requesting accelerators. Terminating outstanding block collective operations may free switch-side queue resources and notify the requesting accelerators of the failure via the completion status buffer, enabling the accelerators' software to take corrective action such as resubmitting the collective with the updated group membership.

FIG. 18B illustrates a method for recovering from a chiplet station fault, comprising detecting the fault, updating group table entries on switches to exclude the faulted station's accelerators, and redistributing traffic from the faulted station to operational stations. The method may combine network-level recovery (group table and forwarding entry updates) with device-level recovery (traffic redistribution across chiplet dies), addressing the full scope of recovery needed when a chiplet station faults in a system performing in-network collective operations.

In various implementations, a method for recovering from a chiplet station fault in an Ultra Accelerator Link (UALink)-based network, comprising: detecting a fault on a station of a chiplet die, the chiplet die comprising stations coupled to an accelerator die via a die-to-die interface; identifying, by a centralized controller, group table entries on one or more switches that reference accelerators coupled to the faulted station; updating, by the centralized controller, the identified group table entries to exclude the accelerators coupled to the faulted station; and redistributing, by the accelerator die, transaction layer flits from the faulted station to operational stations on the chiplet die or on other chiplet dies coupled to the accelerator die. The method may be triggered automatically when a management agent on the accelerator die reports the station fault to the centralized controller. The identifying step may involve the centralized controller searching a database of active group table entries for bitmask bits corresponding to the faulted station's accelerator identifiers. The updating step may use the three-phase consistency protocol (deactivate, modify, verify, reactivate). The redistributing step may involve the accelerator die updating its destination-to-chiplet mapping and routing transaction layer flits through alternative chiplet dies that have connectivity to the same destination accelerators via the switch network.

In some implementations of the method, the centralized controller pre-computes alternative group table entries for each station of the chiplet die, and upon detection of the fault, activates the pre-computed entries on the one or more switches without runtime bitmask computation. Pre-computing alternative entries may reduce the failover time from the combined latency of computation, programming, and verification to the latency of activation, which may be a single register write per switch.

In some implementations of the method, when a die-to-die interface retrain event occurs during an active collective operation, a data link layer on the chiplet die remains in an operational state during the retrain, drops incoming flits from an external link, and after retrain completion replays previously-transmitted flits from a replay buffer, maintaining collective operation continuity without external link re-establishment. The data link layer remaining operational during die-to-die retrain may make the retrain invisible to external link partners and to the collective operation in progress. The replay mechanism may recover all dropped flits within the data link replay timeout window.

In some implementations, the method further comprises invalidating security session keys associated with the faulted station upon reset, while maintaining security sessions for the other stations. Selective key invalidation may prevent use of potentially compromised keys on the faulted station while allowing other stations to continue secure communication without renegotiating their sessions.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

FIG. 18C illustrates a system for a UALink-based network, comprising an accelerator die coupled to a plurality of chiplet dies, each providing connectivity to a subset of the UALink network. When one chiplet die or a station on a chiplet die experiences a fault, the system may redistribute traffic from the affected stations to operational stations on other chiplet dies, and the centralized controller may update forwarding entries on switches to reflect the changed connectivity. This coordinated local and network-level recovery may maintain as much network connectivity as possible during a chiplet fault, limiting the impact to the accelerators directly coupled to the faulted stations rather than taking the entire device offline.

In various implementations, a system for an Ultra Accelerator Link (UALink)-based network, comprising: an accelerator die coupled to a plurality of chiplet dies, each chiplet die coupled to the accelerator die via a separate die-to-die interface, each chiplet die comprising one or more stations with UALink-based ports; and a centralized controller coupled via an out-of-band management interface; wherein upon a fault affecting a first chiplet die or a station on the first chiplet die: the accelerator die redistributes transaction layer flits from the affected stations on the first chiplet die to operational stations on one or more other chiplet dies of the plurality of chiplet dies; and the centralized controller updates forwarding entries on switches in the network to reflect the changed connectivity, routing traffic destined for accelerators previously reachable via the first chiplet die through alternative paths via the other chiplet dies. The accelerator die may maintain a destination-to-chiplet mapping that associates each destination accelerator identifier with the chiplet die that provides connectivity to that destination. Upon fault, the accelerator die may update this mapping to redirect traffic to alternative chiplet dies that have paths to the same destinations via the switch network. The centralized controller may simultaneously update forwarding entries on switches so that traffic from other accelerators in the network is also routed through the alternative paths. The coordinated update may involve the centralized controller first verifying that the alternative paths exist, then updating the forwarding entries, and finally confirming to the accelerator die that network-level rerouting is complete.

In some implementations of the system, the accelerator die maintains a mapping of destination accelerator identifiers to chiplet dies, and upon the fault, updates the mapping to redirect transaction layer flits for destinations previously reachable via the first chiplet die to chiplet dies that have alternative connectivity to those destinations. The mapping may be implemented as a lookup table indexed by destination accelerator identifier, with each entry pointing to the chiplet die and station that provides the most direct path. Updating the mapping may redirect traffic within nanoseconds at the accelerator die level.

In some implementations of the system, the accelerator die redistributes traffic before triggering a warm reset of the first chiplet die, the warm reset preserving diagnostic state in a retention memory; and after warm reset completion, the accelerator die redistributes traffic back to the recovered chiplet die. Redistributing traffic before warm reset may allow the reset to proceed without affecting ongoing transactions. The preserved diagnostic state may enable post-mortem analysis of the fault. Redistributing traffic back after successful recovery may restore the system to full bandwidth.

In some implementations of the system, the centralized controller further updates group table entries on switches to reflect the changed connectivity, redirecting collective operation group membership from accelerators reachable via the first chiplet die to alternative paths via the other chiplet dies. Updating group table entries alongside forwarding entries may maintain collective operation functionality during chiplet recovery, enabling in-network collective operations to continue using alternative paths.

In some implementations of the system, after the redistribution, the centralized controller rebalances forwarding entries across the remaining chiplet dies to distribute traffic load proportionally to the available bandwidth on each chiplet die. Rebalancing may prevent the chiplet dies that absorb the redirected traffic from becoming overloaded, which could degrade performance for all stations on those chiplet dies.

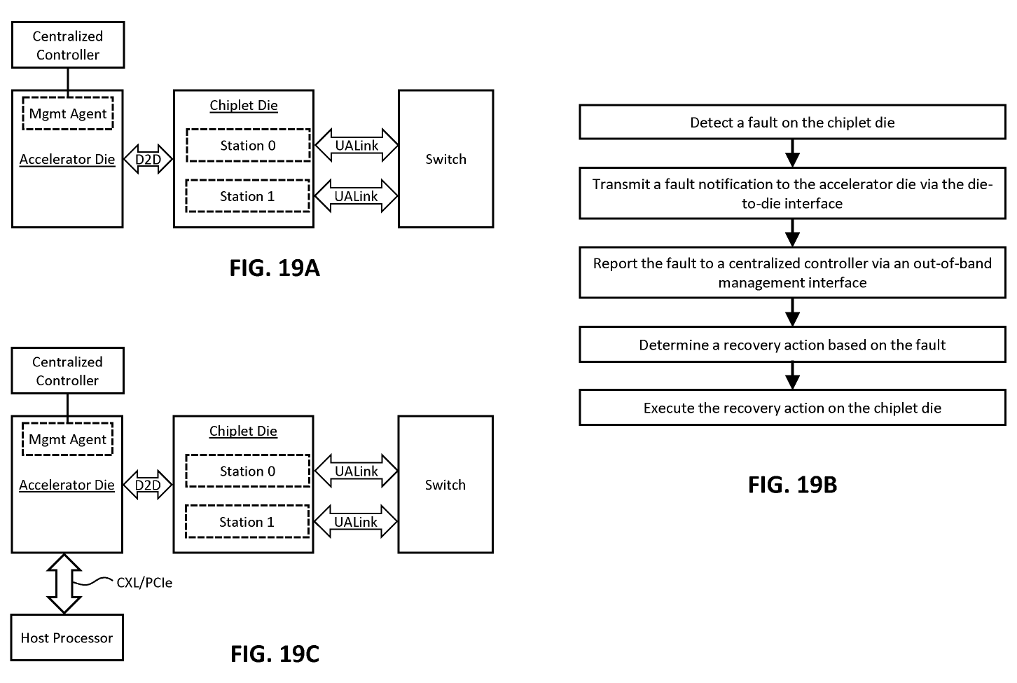

FIG. 19A illustrates a system for a UALink-based network, comprising a chiplet die that detects faults and transmits fault notifications to an accelerator die via a die-to-die interface. A management agent on the accelerator die may receive the fault notification and report it to a centralized controller via an out-of-band management interface separate from the data-plane links. The centralized controller may determine a recovery action based on the fault type and severity, and may transmit the recovery action back through the management hierarchy for execution. This end-to-end fault notification and recovery chain may bridge the gap between chiplet-level fault detection and network-level recovery coordination, enabling the centralized controller to maintain comprehensive visibility of all fault events in the network, including those originating within chiplet dies that are not directly accessible on the management network.

In various implementations, a system for an Ultra Accelerator Link (UALink)-based network, comprising: a chiplet die coupled to an accelerator die via a die-to-die interface, the chiplet die comprising one or more stations with UALink-based ports; a management agent on the accelerator die; and a centralized controller coupled to the management agent via an out-of-band management interface; wherein upon the chiplet die detecting a fault: the chiplet die transmits a fault notification to the accelerator die via the die-to-die interface, the fault notification comprising a fault identifier and a severity; the management agent on the accelerator die receives the fault notification and reports the fault to the centralized controller via the out-of-band management interface; and the centralized controller determines a recovery action based on the fault identifier and the severity. The fault may include a station-level fault (affecting one station's data link or physical layer), a chiplet-level fault (affecting the entire chiplet), or an internal device fault (such as a firmware panic or watchdog timeout). The fault notification may traverse the die-to-die interface as a management event message delivered to a defined memory location on the accelerator die. The management agent may translate the chiplet-specific fault notification into a format compatible with the management protocol used to communicate with the centralized controller. The centralized controller may maintain a fault history per chiplet and may use the fault history in combination with the current fault identifier and severity to determine the appropriate recovery action.

In some implementations of the system, the fault notification comprises an event identifier, a timestamp, a severity indicator, and a sequence number for ordering and deduplication. The sequence number may enable the management agent and the centralized controller to detect duplicate notifications caused by retransmission, and to process notifications in the correct order when multiple faults occur in rapid succession.

In some implementations of the system, the recovery action comprises at least one of: a station reset targeting the faulted station, a warm reset of the chiplet die, a cold reset of the chiplet die, or removal of the accelerator from a virtual partition. Station reset may be selected for non-fatal faults localized to a single station. Warm reset may be selected for faults that affect multiple stations or chiplet-wide logic but where diagnostic state should be preserved. Cold reset may be selected for fatal faults that require full reinitialization. Removal from a virtual partition may be selected for persistent faults that recur after multiple reset attempts. In some examples, a virtual partition refers to a virtual pod.

In some implementations of the system, the centralized controller transmits the selected recovery action to the management agent, and the management agent instructs the accelerator die to execute the recovery action on the chiplet die. The bidirectional use of the management hierarchy may enable centralized recovery decisions while leveraging the local management agent for execution, ensuring that recovery actions are consistent with the centralized controller's view of the network state.

In some implementations of the system, the centralized controller correlates the fault from the chiplet die with faults reported by other devices in the network to determine whether the fault is isolated to the chiplet die or indicates a systemic issue. Systemic issues, such as a power supply fault affecting multiple devices or a thermal event in a chassis, may produce correlated faults across multiple chiplets and devices. Identifying these correlations may enable the centralized controller to address the root cause rather than treating each fault independently.

In some implementations of the system, the management agent enriches the fault notification with an accelerator identifier, a virtual partition identifier, a station identifier, and a port identifier before reporting to the centralized controller. The chiplet-originated fault notification may contain chiplet-local identifiers. The management agent may add network-level identifiers that enable the centralized controller to immediately locate the fault in the network topology without additional queries.

In some implementations of the system, after a warm reset of the chiplet die, the management agent retrieves preserved diagnostic state from the chiplet die via the die-to-die interface and transmits the diagnostic state to the centralized controller for root-cause analysis. The preserved diagnostic state may include error logs, reliability counters, and retention memory content that survived the warm reset. Exporting this state to the centralized controller may enable correlation with fault patterns observed across the network.

In some implementations of the system, the centralized controller tracks a frequency of faults per chiplet die, and escalates the recovery action when the frequency exceeds a configurable threshold. Escalation may progress from station reset to warm reset to cold reset to virtual partition removal as the fault frequency increases, reflecting increasing likelihood that the chiplet has a persistent hardware defect that cannot be recovered by lesser actions.

In some implementations of the system, the management agent exposes chiplet-specific attributes comprising station fault status, reset cause, and retrain event count as management data model attributes queryable by the centralized controller. Exposing chiplet-specific attributes in the management data model may enable the centralized controller to query chiplet health proactively, without waiting for fault notifications. The retrain event count may indicate degrading die-to-die link quality before a fault occurs.

In some implementations of the system, the chiplet die tracks a frequency and a duration of retrain events on the die-to-die interface and reports the frequency and the duration to the management agent, which reports to the centralized controller as telemetry data for proactive detection of degrading die-to-die link quality. Increasing retrain frequency or duration may indicate degrading die-to-die link quality due to aging, thermal stress, or packaging defects. Reporting this telemetry through the management hierarchy may enable the centralized controller to schedule preventive maintenance before a fault occurs.

FIG. 19B illustrates a method for managing chiplet faults in a UALink-based network, comprising detecting a fault on a chiplet die, transmitting a fault notification through the die-to-die interface to the accelerator die, reporting through the management hierarchy to the centralized controller, determining a recovery action, and executing the recovery action on the chiplet die. This method may bridge chiplet-level fault detection with network-level recovery coordination, enabling automated fault management without operator intervention for common fault scenarios.

In various implementations, a method for managing a chiplet fault in an Ultra Accelerator Link (UALink)-based network, comprising: detecting, by a chiplet die coupled to an accelerator die via a die-to-die interface, a fault on the chiplet die; transmitting, by the chiplet die, a fault notification to the accelerator die via the die-to-die interface; reporting, by a management agent on the accelerator die, the fault to a centralized controller via an out-of-band management interface; determining, by the centralized controller, a recovery action based on the fault; and executing the recovery action on the chiplet die. The method may be performed automatically without operator intervention for fault types with predefined recovery policies. The recovery action execution may involve the centralized controller transmitting the action to the management agent, which instructs the accelerator die to assert the appropriate reset signal or take other corrective action on the chiplet die. The method may also involve the centralized controller updating network state (forwarding entries, group tables, virtual partition assignments) to reflect the impact of the fault and the recovery action.

In some implementations, the method further comprises after a warm reset of the chiplet die, reading preserved diagnostic state from the chiplet die; exporting the diagnostic state to a host processor coupled to the accelerator die via CXL or PCIe for local logging; and exporting the diagnostic state to the centralized controller for correlation with faults from other devices. Dual-path export may provide both local visibility (host processor for workload-level diagnosis) and network-wide visibility (centralized controller for cross-device fault correlation). The preserved diagnostic state may include error logs and reliability counters that survived the warm reset.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

FIG. 19C illustrates a system for a UALink-based network, comprising an accelerator die that is coupled to both a chiplet die (via a die-to-die interface) and a host processor (via CXL or PCIe). When the chiplet die experiences a fault, the accelerator die may report the fault through both paths: to the host processor via the CXL or PCIe error reporting mechanism, and to the centralized controller via the management agent and the out-of-band management interface. The host processor may be responsible for workload-level recovery (pausing training, checkpointing model state), while the centralized controller may be responsible for network-level recovery (updating forwarding entries, group tables, virtual partition state). The two entities may coordinate to determine a recovery action that addresses both workload and network concerns.

In various implementations, a system for an Ultra Accelerator Link (UALink)-based network, comprising: an accelerator die coupled to a chiplet die via a die-to-die interface, the chiplet die comprising one or more stations with UALink-based ports; the accelerator die further coupled to a host processor via Compute Express Link (CXL) or PCI Express (PCIe); and a centralized controller coupled to a management agent on the accelerator die via an out-of-band management interface; wherein upon a fault on the chiplet die: the accelerator die reports the fault to the host processor via a CXL or PCIe error reporting mechanism; the accelerator die further reports the fault to the centralized controller via the management agent and the out-of-band management interface; and the host processor and the centralized controller coordinate to determine a recovery action for the fault. The dual-path reporting may provide complementary fault visibility: the host processor may see the fault in the context of its workloads and operating system domain, while the centralized controller may see the fault in the context of the UALink network. The coordination may involve the host processor and the centralized controller exchanging recovery intent via a management interface, or may involve a predefined recovery policy that both entities follow independently based on the fault type and severity.

In some implementations of the system, the host processor manages workload-level recovery comprising at least one of pausing a training workload or checkpointing model state, and the centralized controller manages network-level recovery comprising at least one of updating forwarding entries, updating group table entries, or modifying virtual partition assignments. The division of responsibility may reflect the different domains of authority: the host processor controls the workloads and operating system on the system node, while the centralized controller controls the UALink network infrastructure shared across system nodes.

In some implementations of the system, the accelerator die maps chiplet-specific fault information comprising a station identifier and a fault type to a CXL or PCIe error report format, enabling the host processor to identify the fault scope. The mapping may translate chiplet-internal identifiers into a format that the host processor's error handling software can interpret, such as a PCIe Advanced Error Reporting (AER) extended capability register or a CXL error message.

In some implementations of the system, the recovery action comprises a warm reset of the chiplet die, and the host processor quiesces workloads prior to the warm reset, the centralized controller pre-computes updated forwarding entries, and after the warm reset, the centralized controller installs the updated forwarding entries and the host processor resumes workloads. The sequenced coordination may prevent data loss by ensuring workloads are quiesced before the chiplet is reset, and may minimize recovery time by pre-computing updated forwarding entries so they can be installed immediately after the reset completes.

In some implementations of the system, when both the die-to-die interface and the CXL or PCIe interface experience faults simultaneously, the accelerator die coordinates recovery across both interfaces to prevent deadlock, prioritizing one interface's recovery based on a configurable policy. Simultaneous faults on both interfaces may create a situation where backpressure from both sides converges on the accelerator die. The configurable priority policy may specify which interface to recover first based on the relative importance of host connectivity versus network connectivity for the current workload.

The term "Ultra Accelerator Link" (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term "PCI Express" (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

Various implementations described herein involve circuits. The term "circuit" refers to a device, an integrated circuit (IC), a die, a chiplet, or a system that includes at least a processing element configured to perform a function. This definition encompasses a wide range of implementations, including but not limited to: combinational logic, sequential logic, discrete logic circuits, programmable logic devices, embedded controllers, computers, accelerators, GPUs, FPGAs, ASICs, DSPs, System-on-Chip (SoC) designs, chiplet dies, accelerator dies, System-in-Package (SiP) devices, switch devices, and ICs incorporating processing capabilities. The processing element may be of any type, including combinational logic gates, a state machine, a lookup table, a microcontroller, a microprocessor, a single-core or multi-core processor, a firmware-controlled engine, or any combination thereof. The circuit may optionally include memory, which may include registers, buffers, volatile or non-volatile storage media, or retention memory that preserves state across reset events. The circuit may optionally include a communication interface allowing the processing element to send and/or receive data, signals, or instructions, which may include die-to-die interfaces, UALink-based ports, data link layers, physical layers, out-of-band management interfaces, or other arrangements facilitating data exchange. References to a "circuit" include any collection of one or more circuits that individually or jointly perform a function, meaning that the singular term "circuit" is intended to imply one or more circuits, which jointly perform the functions attributed to "the circuit."

The terms "port" and "interface" may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context.

Herein, terms such as send/ sending, receive/ receiving, communicate/ communicating, or exchange/ exchanging when used to describe elements (e.g., circuit, processor, computer, host, semiconductor device, switch, port, interface) involved in data, message, packet, or other information exchanges, may refer to direct or indirect operation(s) that facilitate information transfer to/ from/ between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of "a port/interface configured to communicate with an entity" refer to direct or indirect coupling between the port/interface and the entity.

References to a protocol "based on" a specific standard or an industry standard (such as a protocol based on UALink, a UALink-based protocol, a protocol based on CXL, or a CXL-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a UALink-based protocol may encompass implementations that add vendor-defined fields, packets, or commands while preserving the essential accelerator-to-accelerator communication model.

References to a protocol-based port (such as a CXL-based port or a UALink-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a UALink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, "non-transitory computer-readable medium" refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The "computer-implemented methods" described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as "an implementation”, "various implementations”, "some implementations”, "one or more implementations”, "an embodiment”, "some embodiments”, "one embodiment”, "an aspect”, "a configuration”, "an example”, and similar phrases are used herein for convenience and do not imply that a disclosure relating to such phrase(s) is essential to the subject technology or that such disclosure applies to all implementations of the subject technology. Phrases such as "an implementation", "some implementations", or “various implementations” may refer to one or more implementations and vice versa, and this applies similarly to other foregoing phrases. Distinct references, including terms such as "one implementation”, "another implementation”, "various implementations”, or "some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of "X is indicative of Y" mean that X includes information correlated with Y and/or describing Y, up to the case wherein X equals Y. Sentences in the form of "provide/receive an indication (of whether X happened)" may refer to any indication method. The word "most" of something is defined as above 51% of the something (including 100% of the something). The words "portion", "subset", "region", and "area" of something refer to a value between a non-zero fraction of the something and 100% of the something, inclusive; they indicate an open-ended claim language, thus, for example, sentences in the form of "a portion of the memory" or "a subset of the memory" encompass anything from just a small part of the memory to the entire memory, optionally together with additional memory region(s). Sentences in the form of "access the memory" encompass accessing at least a portion of the memory, where the portion may range from a minimal addressable unit to the entire memory capacity, indicating an open-ended claim language. "Coupled" indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of "a" or "an" refers to one or more things. The phrase "based on" indicates an open-ended claim language, and encompasses "based, at least in part, on". Additionally, stating that a value is calculated "based on X" and following that, in a certain implementation, that the value is calculated "also based on Y", means that in the certain implementation, the value is calculated based on X and Y. Variations of the terms "utilize" and "use" indicate an open-ended claim language, such that sentences in the form of "detecting X utilizing Y" are intended to mean "detecting X utilizing at least Y", and sentences in the form of "use X to calculate Y" are intended to mean "calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction 'and' or 'or'. A predetermined, predefined, or preselected value is a fixed value and/or a value determined before performing a calculation that utilizes the predetermined value. When appropriate, the word "value" may indicate a predetermined value. The word "threshold" indicates a threshold whose value, and/or the logic used to determine whether the threshold is reached, is established prior to performing the computation that utilizes the threshold, whether the threshold value is fixed, predefined, or dynamically determined.

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of "One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages" are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of "An active cable comprising first and second pluggable modules coupled by a physical medium; wherein the active cable further comprises hardware circuitry, integrated into the active cable, configured to perform the method of claim X" are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of "An apparatus configured to operate as a switch, wherein the apparatus comprises switching circuitry and is configured to perform the method of claim X" are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

1. A system for an Ultra Accelerator Link (UALink)-based network, comprising:
a chiplet die comprising stations, each station comprising one or more UALink-based ports with a data link layer and a physical layer, the chiplet die coupled to an accelerator die via a die-to-die interface;
one or more switches, each switch comprising a group table comprising entries, each entry comprising a valid indicator and a bitmask identifying a group of accelerators for collective operations; and
a centralized controller coupled to the one or more switches and to the accelerator die via an out-of-band management interface;
wherein upon detection of a fault on a station of the chiplet die, the centralized controller is configured to:
identify group table entries on the one or more switches that reference accelerators coupled to the faulted station; and
update the identified group table entries on the one or more switches to exclude the accelerators coupled to the faulted station.

2. The system of claim 1, wherein the fault causes the faulted station to enter a traffic drop mode, and a circuit on the chiplet die resets the data link layer and the physical layer of the faulted station without resetting other stations or the die-to-die interface.

3. The system of claim 1, wherein the centralized controller updates the identified group table entries by: clearing the valid indicator of the identified entries on each switch; modifying the bitmask to remove the accelerators coupled to the faulted station; verifying consistency of the modified entries across the one or more switches; and setting the valid indicator on each switch to reactivate the collective groups with modified membership.

4. The system of claim 1, wherein the chiplet die transmits a fault notification to the accelerator die via the die-to-die interface, and a management agent on the accelerator die reports the fault to the centralized controller via the out-of-band management interface, triggering the centralized controller to identify and update the group table entries.

5. The system of claim 1, wherein after the update, remaining accelerators in the collective group continue collective operations with the reduced membership, and the centralized controller notifies a workload management system of the modified group membership, enabling the workload management system to adjust an AI training workload.

6. The system of claim 1, wherein after the faulted station is reset and recovers, the centralized controller adds the accelerators coupled to the recovered station back into the group table entries on the one or more switches and verifies consistency before reactivating the modified entries.

7. The system of claim 1, wherein the centralized controller further updates forwarding entries on the one or more switches to remove routes to the accelerators coupled to the faulted station, and verifies that remaining group table entries reference accelerators that remain routable via the updated forwarding entries.

8. The system of claim 1, wherein when the one or more switches have outstanding block collective operations targeting accelerators coupled to the faulted station, the centralized controller triggers the switches to terminate the outstanding block collective operations and write completion status indicating failure to the requesting accelerators.

9. A method for recovering from a chiplet station fault in an Ultra Accelerator Link (UALink)-based network, comprising:
detecting a fault on a station of a chiplet die, the chiplet die comprising stations coupled to an accelerator die via a die-to-die interface;
identifying, by a centralized controller, group table entries on one or more switches that reference accelerators coupled to the faulted station;
updating, by the centralized controller, the identified group table entries to exclude the accelerators coupled to the faulted station; and
redistributing, by the accelerator die, transaction layer flits from the faulted station to operational stations on the chiplet die or on other chiplet dies coupled to the accelerator die.

10. The method of claim 9, wherein the centralized controller pre-computes alternative group table entries for each station of the chiplet die, and upon detection of the fault, activates the pre-computed entries on the one or more switches without runtime bitmask computation.

11. The method of claim 9, wherein when a die-to-die interface retrain event occurs during an active collective operation, a data link layer on the chiplet die remains in an operational state during the retrain, drops incoming flits from an external link, and after retrain completion replays previously-transmitted flits from a replay buffer, maintaining collective operation continuity without external link re-establishment.

12. The method of claim 9, further comprising invalidating security session keys associated with the faulted station upon reset, while maintaining security sessions for the other stations.

13. A non-transitory computer-readable medium comprising instructions which, when executed by a processor, cause the processor to perform the method of claim 9.

14. One or more integrated circuits configured to perform the method of claim 9, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

15. An apparatus configured to operate as a switch, wherein the apparatus comprises switching circuitry and is configured to perform the method of claim 9.

16. A system for an Ultra Accelerator Link (UALink)-based network, comprising:
an accelerator die coupled to a plurality of chiplet dies, each chiplet die coupled to the accelerator die via a separate die-to-die interface, each chiplet die comprising one or more stations with UALink-based ports; and
a centralized controller coupled via an out-of-band management interface;
wherein upon a fault affecting a first chiplet die or a station on the first chiplet die:
the accelerator die redistributes transaction layer flits from the affected stations on the first chiplet die to operational stations on one or more other chiplet dies of the plurality of chiplet dies; and
the centralized controller updates forwarding entries on switches in the network to reflect the changed connectivity, routing traffic destined for accelerators previously reachable via the first chiplet die through alternative paths via the other chiplet dies.

17. The system of claim 16, wherein the accelerator die maintains a mapping of destination accelerator identifiers to chiplet dies, and upon the fault, updates the mapping to redirect transaction layer flits for destinations previously reachable via the first chiplet die to chiplet dies that have alternative connectivity to those destinations.

18. The system of claim 16, wherein the accelerator die redistributes traffic before triggering a warm reset of the first chiplet die, the warm reset preserving diagnostic state in a retention memory; and after warm reset completion, the accelerator die redistributes traffic back to the recovered chiplet die.

19. The system of claim 16, wherein the centralized controller further updates group table entries on switches to reflect the changed connectivity, redirecting collective operation group membership from accelerators reachable via the first chiplet die to alternative paths via the other chiplet dies.

20. The system of claim 16, wherein after the redistribution, the centralized controller rebalances forwarding entries across the remaining chiplet dies to distribute traffic load proportionally to the available bandwidth on each chiplet die.
